(19) United States
(12) Patent Application Publication
(10) Pub. No.: US 2017/0272491 A1
(43) Pub. Date: Sep. 21, 2017

(54) SELF-CONTAINED AND PORTABLE SYNCHRONIZED DATA COMMUNICATION SYSTEM AND METHOD FOR FACILITATING THE WIRELESS TRANSMISSION OF VIDEO AND DATA FROM VENUES TO CLIENT DEVICES

(71) Applicant: Mesa Digital, LLC, Albuquerque, NM (US)

(72) Inventors: Luis M. Ortiz, Albuquerque, NM (US); Kermit D. Lopez, Albuquerque, NM (US)

(73) Assignee: Mesa Digital, LLC.

(21) Appl. No.: 15/362,995

(22) Filed: Nov. 29, 2016

Related U.S. Application Data
(60) Provisional application No. 62/308,943, filed on Mar. 16, 2016.

(51) Int. Cl. H04L 29/06; H04L 29/08

(52) U.S. Cl. CPC H04L 65/607; H04L 67/1095; H04L 67/18

(57) ABSTRACT

Self-contained pods for use at venues can include wireless communications electronics, one or more telescoping masts, and one or more cameras mounted on the mast(s). Pods can provide extended data communications for mobile device users at the venue and can also capture video from the perspective of the pod. A synchronized data server can assure that data is synchronized with a control server and/or with other pods containing synchronized servers at the venue. A telescoping mast can also serve as an antenna and lift cameras to various heights where cameras provide different perspectives to spectators based on pod location and mast height. A rechargeable power source with the pod can be recharged by a solar panel. A second camera can capture security footage of activity around the pod and prevent/deter tampering. Optional sensors can provide environmental and/or security data for the pod.

### CROSS-REFERENCE TO PROVISIONAL APPLICATION

This nonprovisional patent application claims the benefit under 35 U.S.C. §119(e) to U.S. Provisional Patent Application Ser. No. 62/308,943 filed on Mar. 16, 2016, which is hereby incorporated by reference in its entirety.

### TECHNICAL FIELD

Embodiments are generally related to data communications and in particular to wireless communications networks. Embodiments are also related to wireless data communications systems having nodes established to facilitate a data communications network with respect to a venue. Embodiments are also related to wireless data communications systems composed of communications nodes including any of cameras, wireless data communications, and synchronized data servers deployed throughout a venue and supporting access to video and data by hand held devices located at the venue or remote from the venue.

### BACKGROUND

Wireless data communications technology has now found its place in sports and entertainment venues over the past decade. Video and data related to an event at sports venues is now widely available on portable hand held devices such as mobile phones and proprietary devices that can be rented at the sports venues. New sports and entertainment venues are now being designed and built to incorporate wireless data communications infrastructure in order to enable enhanced spectator experiences and increase bandwidth to meet the demand for data access.

Although new stadiums are being built with wireless capabilities, still many venues are older and/or lack the “built-in” wireless data communications infrastructure necessary to support large scale hand held device access to live video recorded by cameras at entertainment venues and associated entertainment data. Furthermore, some venues may only require temporary installations of wireless video and data communications capabilities for a special event. Such is the case in occasional track and field events, outdoor fairs, outdoor concerts, off-track car racing, marathons, etc. Also, bandwidth limitations have been experienced where video content is being accessed from a data server over a data network simultaneously by several hand held devices as clients operating within a venue.

Several hundred to several thousand clients (e.g., smartphones with cellular, Wi-Fi and video capabilities) can be attempting simultaneous access to data from a server or servers that are located in the same centralized location (e.g., production room) over a public venue's wireless data network. This very large amount of simultaneous data requests locally can result in choppy distribution, server failure, or other data distribution issues, particularly when distributing video of venue activity to client devices located remote from the venue (e.g., in other geographical locations). Another problem in widely dispersed venues is that fewer perspectives are available to interested spectators and fans given the lack of cameras placements where vast areas are involved.

What is needed are systems and methods enabling more access to live venue data including video by spectators and fans using mobile devices at venues as well as away or remote from the venues.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is one aspect of the disclosed embodiments to provide a pod that includes wireless communications electronics, a telescoping mast, and at least one camera mounted on the mast.

It is another aspect of the disclosed embodiments to provide a pod that includes wireless communications electronics, a telescoping mast, at least one camera mounted on the mast, and a synchronized data server.

It is yet another aspect of the disclosed embodiments to provide for a telescoping mast that can also serve as an antenna and a rechargeable power source with the pod.

It is yet another aspect of the disclosed embodiments to provide an optional solar power panel to charge the rechargeable power source.

It is yet another aspect of the disclosed embodiments to provide more than one camera providing different perspectives captured from the perspective of the pods based on the pods location and the masts height.

It is yet another aspect of the disclosed embodiments to provide more than one camera wherein one camera can also be utilized to capture images beneath the mast to capture security footage of activity around the pod and prevent/deter tampering by spectators or pedestrians, while the second camera is capturing images of entertainment at the venue.

It is yet another aspect of the disclosed embodiments to provide optional sensors that can provide environmental and/or security data for the pod. For example, sensors can provide any of the following functionality for the pod: tamper, proximity, movement, temperature, light, moisture, acoustic, as well as others. Sensors can also include, for example, RFID tags to detect nearby devices. Any of these sensors features can be useful in various pod deployments where diverse environmental factors as well as crowds are involved.

It is yet another aspect of the disclosed embodiments to provide in some example embodiments a self-contained pod in the form of a movable, weatherproof container that can be placed at strategic locations throughout a venue while remaining protected from weather and vandalism. Optional wheels can facilitate movement of such pods.

The aforementioned aspects and other objectives and advantages can now be achieved as described herein. In one example embodiment, a system for delivering video and data to wireless client devices can be provided, which includes one or more self-contained pods deployed at a venue. Such self-contained pods can include wireless communications electronics, one or more optional telescoping masts, and one or more cameras mounted on a mast. Such a system can provide extended data communications for mobile device users at and/or remote from the venue, and capture video from the perspective of the self-contained pod(s). In some embodiments, a self-contained pod can be associated with a synchronized data server, which assures that data is synchronized with a control server and/or with other self-contained pods containing synchronized servers at the venue.

In another example embodiment, the telescoping mast can serve as an antenna and can lift the camera(s) to various heights so that the camera(s) provides different perspectives to spectators based on a location of the self-contained pod and a height of the telescoping mast, wherein the different perspectives are provided as wireless video as streaming data to the viewers through one or more hand held devices that wirelessly receive the wireless video as streaming data. Such hand held devices can be located at or remote from the venue.

In some example embodiments, a self-contained pod can include a rechargeable power source that is rechargeable by a solar panel. In some example embodiments, at least one other camera can be deployed on or near a self-contained pod to capture security video footage of activity around the self-contained pod to prevent/deter tampering with respect to the self-contained pod. Additionally, in some example embodiments, one or more sensors can provide environmental data and/or security data for the one or more self-contained pods deployed in the venue.

In another example embodiment, a method for receiving venue-based data at a hand held device can be provided. Such a method can include steps or operations such as wirelessly receiving data at a hand held device wherein the data includes video streaming simultaneously from more than one visual perspective within a venue and wherein the data is transmitted from at least one venue-based data source at the venue, wherein the at least one venue-based data source comprises at least one high definition video camera associated with the at least one self-contained pod; processing the data for display on a display screen associated with the hand held device; and displaying video of only one visual perspective within the venue selected from more than one visual perspective simultaneously streaming as video on the display screen in response to a user selection of the only one visual perspective from the more than one visual perspective a user input at a user interface associated with the hand held device, wherein the at least one video camera is adapted to provide high-resolution wide-angle video data. In some example embodiments, such data can include environmental data collected by at least one sensor associated with the at least one self-contained pod. In some example embodiments, such data can include location data collected by at least one sensor associated with the at least one self-contained pod. In some example embodiments, the at least one high definition video camera can be mounted on at least one telescoping mast on the at least one self-contained pod. In some example embodiments, the at least one self-contained pod can be associated with a synchronized data server, which assures that data is synchronized with a control server and/or with other self-contained pods containing synchronized servers at the venue. It can be appreciated that the hand held device(s) may be located at the venue and/or geographically remote from the venue such as, for example, at home, in a vehicle, etc.

In another example embodiment, a method for receiving venue-based data at a hand held device can be provided. Such a method can include steps or logical operations such as, for example, wirelessly receiving, via a bidirectional packet based data network, the packet based data network selectable by the user from the group of a wireless LAN and at least one cellular communications network, digital data at the hand held device wherein the digital data includes video streaming simultaneously from more than one visual perspective within a venue and wherein the digital data is transmitted from at least one venue-based data source at the venue, wherein the at least one venue-based data source comprises at least one self-contained pod; processing the digital data for display on a display screen associated with the hand held device; and displaying video of only one visual perspective within the venue selected from more than one visual perspective simultaneously streaming as video on the display screen in response to a user selection of the only one visual perspective from the more than one visual perspective a user input at a user interface associated with the hand held device. The at least one self-contained pod can include at least one video camera. The at least one hand held device can be located at the venue and/or remote from the venue.

In some example embodiments, the step of receiving at a hand held device data transmitted from at least one venue-based data source can further include a step or operation of receiving through at least one wireless receiver at the hand held device data transmitted from the at least one venue-based data source. In another example embodiment, a step or operation can be provided for broadcasting the data to the hand held device through wireless communications. Data can be transmitted from the at least one venue-based data source to the hand held device through a wireless network. In some example embodiments, a step or operation can be provided for processing the data for display on the display screen utilizing at least one image-processing module. In some example embodiments, the data can include venue-based data comprising real-time video data of the more than one video stream from more than one video camera located within the venue. In some example embodiments, the data can include instant replay video from more than one video perspective. Such data can also include, for example, promotional information and advertising information.

In another example embodiment, a method can be provided for receiving at least one visual perspective of a venue-based activity at a hand held device. Such an example method can include steps or operations such as providing a software module represented by a graphical icon on a touch-sensitive color display screen associated with the hand held device, when the software module is activated by a user touching an area of the touch-sensitive display screen associated with the graphical icon, the software module causes the hand held device to perform a method of: simultaneously receiving at a hand held device more than one visual perspective of a venue-based activity in the form of more than one digital video signal transmitted from at least one venue-based data source at a venue, the at least one venue-based data source comprising a self-contained pod, wherein the hand held device is in bidirectional wireless communication with a packet based wireless network, the packet based wireless network selectable by the user from the group of a wireless LAN and at least one cellular communications network; processing the at least one visual perspective for simultaneous display as more than one video signal on the touch-sensitive display screen associated with the hand held device; simultaneously displaying the more than one visual perspective on the touch-sensitive display screen, thereby enabling a user of the hand held device to simultaneously view more than one venue-based visual perspectives through the hand held device in the form of video; and displaying a single visual perspective on the display screen in response to a user's selection of the single visual perspective from among the more than one visual perspective being simultaneously displayed on the touch-sensitive display screen after the user touches the touch-sensitive display screen at a point where the touch-sensitive display screen overlays the single visual perspective.

In yet another example embodiment, a hand held device can be adapted for simultaneously receiving more than one video perspective captured by more than one video camera located within a venue. Such a hand held device can include at least one receiver adapted for simultaneously receiving over a bidirectional wireless packet based network more than one video perspective provided by at least one digital camera associated with at least one self-contained pod located as the venue, the packet based network selectable by the user from the group of a wireless LAN and at least one cellular communications network; a processor adapted for processing the more than one video perspective for simultaneous display of at least two video perspectives of the entertainment venue on a display screen associated with the hand held device; and a display screen adapted for simultaneously displaying the at least two video perspectives originating from the at least one self-contained pod located at the venue. The hand held device can be adapted to implement such operations (and/or other operations described herein) via, for example, a software application such as a mobile “app” downloadable to the hand held device over the Internet.

In another example embodiment, a hand held device can be implemented for simultaneously receiving more than one video perspective captured by more than one high definition video camera located within a venue, comprising: at least one receiver adapted for simultaneously receiving more than one high definition video perspective of a venue-based activity provided by at least one video camera associated with at least one self-contained pod; a processor adapted for processing the more than one high definition video perspective for simultaneous display of at least two high definition video perspectives on a display screen associated with the hand held device; and a display screen adapted for simultaneously displaying the at least two high definition video perspectives, wherein the at least one video camera is adapted to provide high-resolution wide-angle video data. In some example embodiments, the at least one video camera can be a wireless video camera. In some example embodiments, the at least one video camera can be mounted on the at least one self-contained pod. Video is displayable on the display screen in response to user input through a user interface associated with the hand held device. In some example embodiments, a display routine can be adapted for displaying a particular perspective among the at least two high definition video perspectives of the venue-based activity on the display screen in response to a user selection of the particular perspective of the venue-based activity. A processor can also be adapted for processing the at least two video perspectives for simultaneous display on the display screen associated with the hand held device utilizing at least one image-processing module.

In yet another example embodiment, a system can be provided for receiving more than one video perspective of a venue-based activity at a hand held device, the system comprising a hand held device including: at least one receiver for simultaneously receiving over a wireless bidirectional network more than one live streaming video perspective of a venue-based activity simultaneously transmitted from more than one venue-based video data source, the venue-based video data source including at least one self-contained pod; the wireless bidirectional network selected by the user from the group comprised of a wireless LAN and at least one cellular communications network; and a processor adapted to process the more than one video perspective for display on a display screen associated with the hand held device. The hand held device can be located in at least one of in the venue and out of the venue (e.g., at home, in a different geographical location, etc.).

In still another example embodiment, a system for displaying a particular video perspective of a venue-based activity at a hand held device can be implemented. Such a system can include at least one receiver at a hand held device simultaneously receiving from a bidirectional wireless network a plurality of high definition streaming video perspectives of a venue-based activity simultaneously transmitted from more than one venue-based data source located at an entertainment venue, the more than one venue-based data source comprising at least one self-contained pod, the bidirectional wireless network comprised from the group of a wireless LAN and at least one cellular communications network; a processor processing the plurality of perspectives for display on a display screen associated with the hand held device; and a display screen displaying a particular video perspective on the display screen in response to a user selection of the particular video perspective from among the plurality of video perspectives.

### BRIEF DESCRIPTION OF DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1A illustrates a block diagram of a self-contained pod with wireless communications and server components thereof for establishing a data communications network, in accordance with an example embodiment;

FIG. 1B illustrates a block diagram of a self-contained pod with wireless communications and server components thereof for establishing a data communications network, in accordance with another example embodiment;

FIG. 1C illustrates a block diagram of a self-contained pod with wireless communications and server components thereof for establishing a data communications network, in accordance with yet another example embodiment;

FIG. 1D illustrates a block diagram of a self-contained pod with wireless communications and server components thereof for establishing a data communications network, in accordance with still another example embodiment;

FIG. 2 illustrates a top perspective view of a venue that includes wireless data communications system nodes distributed throughout the venue for establishing a wireless communication network in communication with hand held devices used by spectators within the venue, in accordance with an example embodiment;

FIG. 3 illustrates a perspective view of a floor and wall including a core hole plug assembly incorporating wireless communications electronics therein and embedded in the floor and wall of a venue, in accordance with an example embodiment;

FIG. 4 illustrates a perspective view of a core hole plug assembly of the subject invention sealing a hole passing through a paving layer;

FIG. 5 illustrates a side view of the core hole plug assembly of FIG. 4 sealing a hole passing through a paving layer;

FIG. 6 illustrates a vertical cross-section of the core hole plug of FIGS. 4 and 5;

FIG. 7 illustrates a bottom view of the core hole plug assembly of FIGS. 4 to 6;

FIG. 8 illustrates a side view of the core hole plug assembly like that shown in FIGS. 4-6, however, including wireless communications electronics to operate as a wireless data communications system nodes that can be distributed throughout the venue for establishing a wireless communication network in communication with hand held devices used by spectators within the venue, in accordance with an example embodiment;

FIG. 9 illustrates a block diagram of network resources operable within a venue to provide wireless data communications system nodes distributed throughout the venue for establishing a wireless communication network in communication with hand held devices used by spectators at the venue and/or by hand held devices located remote from the venue, in accordance with an example embodiment;

FIG. 10 illustrates just one pod housing design that can be used to carry out features of an example embodiment;

FIG. 11 illustrates a schematic diagram depicting an example embodiment of a system composed of one or more networks;

FIG. 12 illustrates a schematic diagram depicting one example embodiment of a client device, which may be used as, for example, one or more of the client devices depicted in FIG. 11;

FIG. 13 illustrates a block diagram illustrating components of a wireless hand held device, in accordance with another example embodiment;

FIG. 14 illustrates a pictorial representation of a hand held device, which may be utilized to implement an example embodiment;

FIG. 15 illustrates a pictorial representation of a hand held device adapted for receiving a module, in accordance with example alternative embodiment;

FIG. 16 illustrates a system for providing multiple perspectives through a hand held device of activities at a venue, in accordance with an example embodiment;

FIG. 17 illustrates a system that provides multiple perspectives of a venue activity through a hand held device adapted to receive and process real time video data, in accordance with an example embodiment;

FIG. 18 illustrates a system for providing multiple perspectives of activity at a venue through a hand held device adapted to receive and process real time video data, in accordance with an example embodiment;

FIG. 19 illustrates a system for providing multiple perspectives for activity at a venue at a first time/perspective and a second time/perspective, in accordance with an example embodiment;

FIG. 20 illustrates a system for providing multiple perspectives through a hand held device of an activity at a venue, including the use of a wireless gateway, in accordance with an example embodiment;

FIG. 21 illustrates a system for providing multiple perspectives through a hand held device of a venue activity, in association with a wireless network, in accordance an example embodiment;

FIG. 22 illustrates a diagram depicting network attributes of a wireless network that may be utilized in accordance with an example embodiment;

FIG. 23 illustrates an overview display and a detail window, in accordance with an example embodiment;

FIG. 24 illustrates a spherical image space divided into a series of w rows and q columns, with the rows and columns representing individual frames as photographed from a video camera, in accordance with an example embodiment;

FIG. 25 illustrates the two-dimensional representation of the spherical image space of FIG. 24 into rows and columns of image frames, in accordance with an example embodiment;

FIG. 26 illustrates an overview display, a detail window, and a corresponding area indicia (geometric figure outline), in accordance with an example embodiment;

FIG. 27 illustrates a series of saved geometric figure outlines corresponding to user selections in tracing through an overview image display for subsequent playback, which may be utilized in accordance with an example embodiment;

FIG. 28 illustrates a flowchart providing a logical process for building an overview image, which may be utilized in accordance with an example embodiment;

FIG. 29 illustrates a flowchart illustrative of a logical process for playback interaction, which may be utilized in accordance with an example embodiment;

FIG. 30 illustrates a pictorial representation illustrative of a Venue Positioning System (VPS), which can be implemented in accordance with an example embodiment;

FIG. 31 illustrates in greater detail the Venue Positioning System (VPS) of FIG. 30, in accordance with an example embodiment;

FIG. 32 illustrates a flowchart of operations illustrative of a method for providing multiple venue activities through a hand held device, in accordance with an example embodiment;

FIG. 33 illustrates a flowchart of operations illustrative of a method for providing multiple venue activities through a hand held device from one or more digital video cameras, in accordance with an example embodiment;

FIG. 34 illustrates a flowchart of operations depicting logical operational steps of a method for providing multiple venue activities through a hand held device, in accordance with an example embodiment;

FIG. 35 illustrates a flow chart of operations depicting logical operational steps of a method for receiving venue-based data at a hand held device, in accordance with another example embodiment;

FIG. 36 illustrates a flow chart of operations depicting logical operational steps of a method for wirelessly receiving venue-based data at a hand held device, in accordance with another example embodiment;

FIG. 37 illustrates a flow chart of operations depicting logical operational steps of a method for receiving at least one visual perspective of a venue-based activity at a hand held device;

FIG. 38 illustrates a flow chart of operations depicting logical operational steps of a method for selectively presenting a portion of a venue-based event to a user, in accordance with an alternative embodiment;

FIG. 39 illustrates a flow chart depicting logical operational steps of a method for sending a portion of an event to a first device;

FIG. 40 illustrates a flow chart depicting logical operational steps of a method for viewing live-streaming video of a venue-based activity on a hand held device at locations within or remote to the venue;

FIG. 41 illustrates a flow chart depicting logical operational steps of a method viewing live-streaming video of a venue-based activity on a hand held device at locations within or remote to the venue, in accordance with another example embodiment;

FIG. 42 illustrates flow chart depicting logical operational steps of a method enabling a user of a hand held device to view live-streaming video of a venue-based activity at locations within or remote to the venue, in accordance with another example embodiment;

FIG. 43 illustrates a flow chart depicting logical operational steps of a method for enabling a user of a hand held device to view live-streaming video of a venue-based activity at locations within or remote to the venue, in accordance with another example embodiment;

FIG. 44 illustrates a flow chart depicting logical operations of a method for receiving venue-based data at a hand held device, in accordance with another example embodiment;

FIG. 45 illustrated a flow chart depicting logical operations of a method for wirelessly receiving venue-based data at a hand held device, in accordance with another example embodiment;

FIG. 46 illustrates a flow chart of operations depicting logical operational steps of a method for receiving one or more visual perspectives of a venue-based activity at a hand held device;

FIG. 47 illustrates a block diagram of a system for displaying a particular video perspective of a venue-based activity at a hand held device located at a venue or remote from a venue and providing venue-based data to such a hand held device, in accordance with an example embodiment;

FIG. 48 illustrates a block diagram of a system for wirelessly streaming venue-based data to hand held devices including the user of machine learning and anomaly detection techniques, in accordance with an example embodiment; and

FIG. 49 illustrates a schematic diagram of a system for transmitting venue-based data to a wireless hand held device, in accordance with an example embodiment.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units, and/or circuits have not been described in detail so as not to obscure the discussion.

Discussions herein utilizing terms such as, for example, “processing,” “computing,” “calculating,” “determining,” “establishing,” “analyzing,” “checking,” or the like may refer to operation(s) and/or process(es) of a computer, a computing platform, a computing system, or other electronic computing device that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an example embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object, merely indicate that different instances of like objects are being referred to and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, a Smartphone device, a smartwatch, wearable computing devices, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a cellular network, a cellular node, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, vending machines, sell terminals, and the like.

Note that the term “server” as utilized herein refers generally to a computer that provides data to other computers. Such a server can serve data to systems on, for example, a LAN (Local Area Network) or a wide area network (WAN) over the Internet. Many types of servers exist, including web servers, mail servers, and files servers. Each type can run software specific to the purpose of the server. For example, a Web server may run Apache HTTP Server or Microsoft IIS, which both provide access to websites over the Internet. A mail server may run a program such as, for example, Exim or iMail, which can provide SMPT services for sending and receiving email. A file server might utilize, for example, Samba or the operating system's built-in file sharing services to share files over a network. A server is thus a computer or device on a network that manages resources.

Other examples of servers include print servers, database servers, and so on. A server may be dedicated, meaning that it performs no other tasks besides their server tasks. On multiprocessing operating systems, however, a single computer can execute several programs at once. A server in this case may refer to the program that is managing resources rather than the entire computer.

Some embodiments may be used in conjunction with devices and/or networks operating in accordance with existing Long Term Evolution (LTE) specifications, e.g., “3GPP TS 36.304 3rd Generation Partnership Project; Technical Specification Group Radio Access Network; Evolved Universal Terrestrial Radio Access (E-UTRA); User Equipment (UE) procedures in idle mode”; “3GPP TS 36.331 3rd Generation Partnership Project; Technical Specification Group Radio Access Network; Evolved Universal Terrestrial Radio Access (E-UTRA); Radio Resource Control (RRC); Protocol specification”; “3GPP 24.312 3rd Generation Partnership Project; Technical Specification Group Core Network and Terminals; Access Network Discovery and Selection Function (ANDSF) Management Object (MO)”; and/or future versions and/or derivatives thereof, units and/or devices which are part of the above networks, and the like.

Some embodiments may be used in conjunction with one or more types of wireless communication signals and/or systems, for example, Radio Frequency (RF), Frequency-Division Multiplexing (FDM), Orthogonal FDM (OFDM), Single Carrier Frequency Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wireless Fidelity (Wi-Fi), Wi-Max, ZigBee®, Ultra-Wideband (UWB), Global System for Mobile communication (GSM), second generation (2G), 2.5G, 3G, 3.5G, 4G, 5G, Long Term Evolution (LTE) cellular system, LTE advance cellular system, High-Speed Downlink Packet Access (HSDPA), High-Speed Uplink Packet Access (HSUPA), High-Speed Packet Access (HSPA), HSPA+, Single Carrier Radio Transmission Technology (1.times.RTT), Evolution-Data Optimized (EV-DO), Enhanced Data rates for GSM Evolution (EDGE), and the like. Other embodiments may be used in various other devices, systems, and/or networks.

The phrase “hand held device” and/or “wireless device” and/or “mobile device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer or a peripheral that is attached to a computer. In some demonstrative embodiments, the phrase “hand held device” and/or “wireless device” and/or “mobile device” may optionally include a wireless service and may also refer to wearable computing devices such as smartwatches and eyeglass computing devices (e.g., Google Glass, etc.).

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments are described herein with respect to a LTE cellular system. However, other embodiments may be implemented in any other suitable cellular network, e.g., a 3G cellular network, a 4G cellular network, a 5G cellular network, a WiMax cellular network, and the like.

The term “antenna,” as used herein, may include any suitable configuration, structure, and/or arrangement of one or more antenna elements, components, units, assemblies, and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a dipole antenna, a set of switched beam antennas, and/or the like.

The terms “cell” or “cellular” as used herein, may include a combination of network resources, for example, downlink and optionally uplink resources. The resources may be controlled and/or allocated, for example, by a cellular node (also referred to as a “base station”) or the like. The linking between a carrier frequency of the downlink resources and a carrier frequency of the uplink resources may be indicated, for example, in system information transmitted on the downlink resources.

Access points, which are often interconnected by cabling, generally play a dominant role in providing radio frequency (RF) coverage in most wireless LAN (WLAN) deployments. Wireless repeaters, though, are an alternative way to extend the range of an existing WLAN instead of adding more access points. There are very few stand-alone 802.11 wireless repeaters on the market, but some access points have a built-in repeater mode. The wireless communications electronics representing access points and wireless repeaters will be referred to herein as communications system nodes or simply as communications nodes.

In general, a repeater simply regenerates a network signal in order to extend the range of the existing network infrastructure. A WLAN repeater does not physically connect by wire to any part of the network. Instead, it receives radio signals (802.11 frames) from an access point, end user device, or another repeater and retransmits the frames. This makes it possible for a repeater located in between an access point and distant user to act as a relay for frames traveling back and forth between the user and the access point.

As a result, wireless repeaters are an effective solution to overcome signal impairments such as RF attenuation. For example, repeaters provide connectivity to remote areas that normally would not have wireless network access. In venue deployments, temporary placement and large areas requiring coverage can result in access points that don't quite cover areas where spectators using hand held devices desire connectivity. The placement of a repeater between the covered and uncovered areas, however, can provide connectivity throughout most of the venue space. The wireless repeater fills holes in coverage, enabling seamless roaming. Although the most modern venues includes built-in wireless infrastructure, older venues often require retrofitting to incorporate wireless communications equipment, or the equipment will only be temporary and must be installed just before an event. Temporary use will be typical with multi-purpose venues. One or more embodiments can provide a system that simplifies the temporary or retrofit placement of wireless data communications equipment as pods throughout a venue.

Server synchronization can be explained as a master-client relationship wherein a primary server can replicate itself (e.g., its data) as a slave server. Simultaneous synchronization enables the master to replicate itself as several slave severs (or clients). The benefit of utilizing server data synchronization within a public venue, in particular at a sports stadium wherein captured video data from multiple perspectives is stored in a main server, is to take the burden off of a data server when multiple clients are requesting to receive stored data from the server. During a live event such as a sports or entertainment event, video captured by several cameras at a venue can be processed and stored simultaneously by a primary server (typically located in a production/control room at the venue).

Note that the term venue as utilized herein can refer to venues such as, for example, sports stadiums, sports arenas, entertainment venues, movie theaters, concert arenas, convention centers, political conventions, casinos, fairgrounds, amusement parts, open spaces subject to an event, and so on. An example of a venue is not only a professional sports arena such as a baseball or football stadium or basketball or hockey arena, but also venues such as locations where, for example, high school graduation ceremonies or other events take place. Events can occur over a vast area of land (e.g., winter and summer Olympics, motocross, Tour de France), and therefore a venue can necessarily expand to include the land or area covered by and/or associated with the event. An amusement or theme park is also an example of a venue.

Data, including video, from the aforementioned primary server can be distributed to several hand held devices located within the venue over the venue's wireless data network. In one possible scenario, more than 1000 hand held devices, for example, can simultaneously request to receive (and view) the same data. In order to relieve a primary server of the burden of serving the 1000+ hand held clients, a better solution proposed by the present inventors is to provide several synchronized servers throughout a sports venue so that the burden can be shared. For example, if five synchronized servers are available and evenly spread out throughout a sports venue, then each server may only need to service, for example, two-hundred clients. The primary server, meanwhile, may only be responsible for example, for five clients, which can be designated or implemented as synchronized servers.

As will be described herein, self-contained pods for use at venues can include wireless communications electronics, one or more telescoping masts, and one or more cameras mounted on the mast(s). Such pods can provide extended data communications for mobile device users at the venue and can also capture video from the perspective of the pod. A synchronized data server can assure that data is synchronized with a control server and/or with other pods containing synchronized servers at the venue. A telescoping mast can also serve as an antenna and lift cameras to various heights where cameras provide different perspectives to spectators based on pod location and mast height. A rechargeable power source with the pod can be recharged by a solar panel. A second camera can capture security footage of activity around the pod and prevent/deter tampering. Optional sensors can provide environmental and/or security data for the pod.

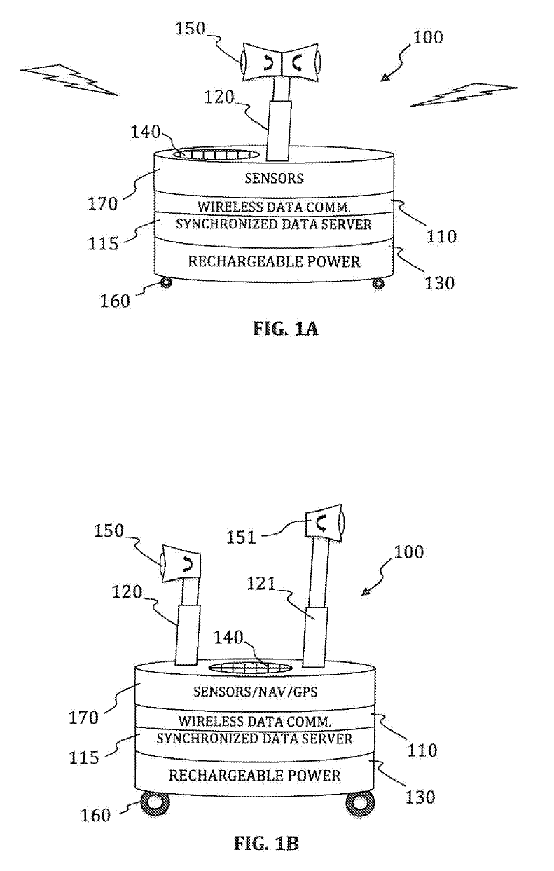

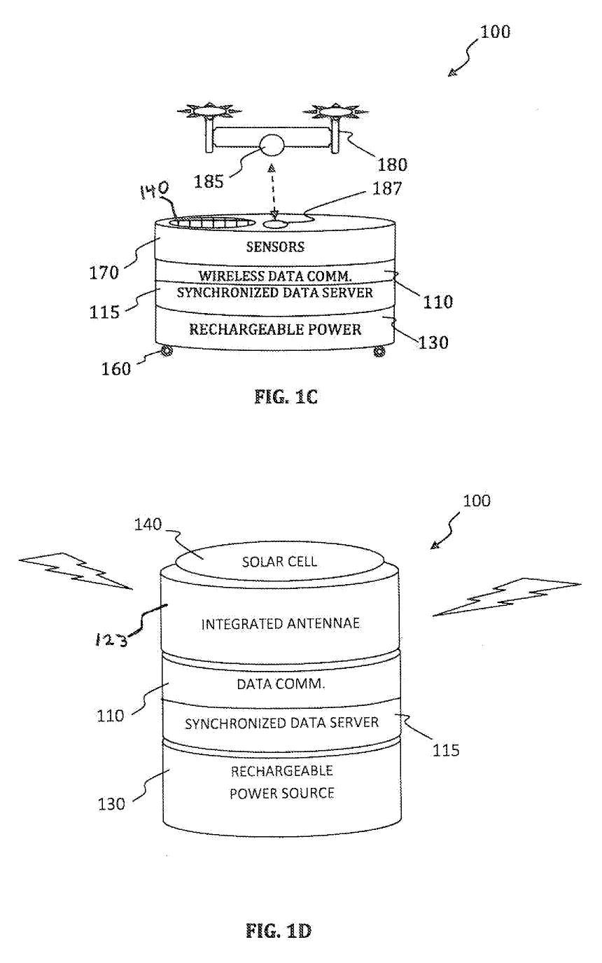

In some example embodiments, electronic wireless communications and data capture can be facilitated within one or more venues utilizing one or more self-contained pods. Examples of such pods are shown in FIGS. 1A-1D. Note that in FIGS. 1A-1D, identical or similar or analogous components or elements are generally indicated by identical reference numerals. FIGS. 1A-1D generally illustrate alternative pod embodiments.

FIG. 1A illustrates a block diagram of a self-contained pod 100 with wireless communications and server components thereof for establishing a data communications network, in accordance with an example embodiment. As depicted in the example embodiment of FIG. 1A, the portable self-contained pod 100 can include wireless communications electronics 110 (i.e., electronics for wireless data communications), a synchronized data server 115, and one or more telescoping mast(s) 120 that can also serve in some embodiments as an antenna. The pod 100 can further include a rechargeable power source 130 and, in some alternative embodiments, an optional solar power panel 140. One or more cameras 150 can also be provided with the pod 100 and may be adjustable and moveable to different heights with the telescoping mast 120. The pod 100 is an example of a venue-based data source. The movement of the telescoping mast 120 can be controlled wirelessly in some example embodiments through the use of a hand held device that communicates with the pod 100 via a wireless network and wireless data communications 110.

One example of a camera that can be utilized as camera 150 is a 360 degree camera. An example of a 360 degree camera that can be adapted for use with an example embodiment is the Giroptic 360cam by Gripoptic. Such a device can include, for example, three 185-degree fish-eye cameras, allowing it to capture 360 degrees of HD (High Definition) video and photos (including time-lapse and HDR). The Giroptic 360cam captures audio as well as video and can record 3D sound from three microphones. Media can be saved onto a microSD card, which is then loaded onto a computer via a micro USB port on the unit's base or via Wi-Fi. It can be appreciated that such a device (or other 360 degree video cameras) can be modified to communicate via other types of wireless communications, such as Bluetooth communications, cellular, and so forth as discussed herein. Note that reference herein to the Giroptic video camera is for illustrative purposes only and is not considered a limiting feature of the disclosed embodiments.

When more than one camera 150 is utilized, different perspectives can be captured from the perspective of the pod's location and mast height. When more than one camera 150 is provided, one camera can also be utilized to capture images beneath the mast to capture security footage of activity around the pod and prevent/deter tampering by spectators or pedestrians, while the second camera is capturing images of entertainment at the venue. Optional sensors 170 can provide environmental and/or security data for the pod 100. For example, sensors 170 can provide any of the following functionality for the pod: tamper, proximity, movement, temperature, light, moisture, acoustic, as well as others. Sensors can also include RFID tags to detect nearby devices. Any of these sensors features can be useful in various pod deployments where diverse environmental factors as well as crowds are involved. Other examples of sensors include radar devices, stereoscopic imaging devices, and LIDAR (Light Detection and Ranging) devices.

The pod 100 can be provided in some example embodiments in the form of a movable, weatherproof container that can be placed in strategic locations throughout a venue and remain protected from weather and vandalism. In some example embodiments, optional wheels 160 can be utilized to facilitate movement of the pod 100. In some example embodiments, however, the use of optional wheels 160 may not be necessary, particularly if the pod 100 is small (e.g., approximately the size of a smartphone or Flash drive or smaller). Optional wheels 160 may also be unnecessary in particular example embodiments in which the pod(s) is positioned at certain strategic locations in a venue (e.g., the pod may be tethered to wire above a venue and the camera(s) 150 may constitute a Skycam). Such strategic locations may be preferred due to the optimal views of the venue afforded to the camera(s) at such locations and/or preferred locations (and height) for the wireless transmission of data to and from the pod(s). The movement of wheels 160 can be controlled wirelessly in some example embodiments through the use of a hand held device that communicates with the pod 100 via a wireless network and wireless data communications 110.

The pod 100 can be configured in the form of a barrel, although the shape of a pod 100 should not be restricted. That is, it can be appreciated the pod 100 can be implemented with different shapes. For example, the pod 100 may be cone shaped or disc shaped or configured in the shape of a rectangular box and so on. In certain situations, an additional ballast may be utilized to weigh down the pod 100 to prevent movement of the pod 100 or stabilize the mast 120 and cameras 150 when incorporated with the pod 100.

The pod 100 is ideally portable, meaning it should be movable. Pod 100 is also ideally self-contained, which adds to ease of portability and movability. The pod 100 is a portable, self-contained communication device or node, a number of which can be distributed throughout a venue, including expanded outdoor areas to support communications of synchronized data including streaming video for access and use by wireless hand held devices (such hand held device 210) carried by spectators in close proximity to a pod 100. The pod 100 can also capture data, such as video with cameras 150 that can contribute to perspectives collected for distribution to spectators at the venue or away from the venue via the Internet. The synchronization data server 115 can cooperate as part of a master-slave server configuration to synchronize data with a number of such pods and a primary server, which can each contain slave/synchronized servers and can also be distributing captured data throughout the venue.

The size of the pod 100 may or may not be dependent on components utilized to provide battery-operated wireless data communications. WiFi transceivers and repeaters comprising the wireless communications electronics 110, for example, typically do not require much space; however, the size of rechargeable batteries 130 required to power the wireless communications electronics 110 will depend on the length of use and continuous power required for the wireless communications electronics 110. In daytime deployments where pods might be exposed to sunlight, an optional solar panel 140 can be located at the top surface of the pod container where the solar panel 140 can obtain maximum sunlight and can provide power to pod electronics and also provide a trickle charge to rechargeable batteries 130 located within the pod 100.

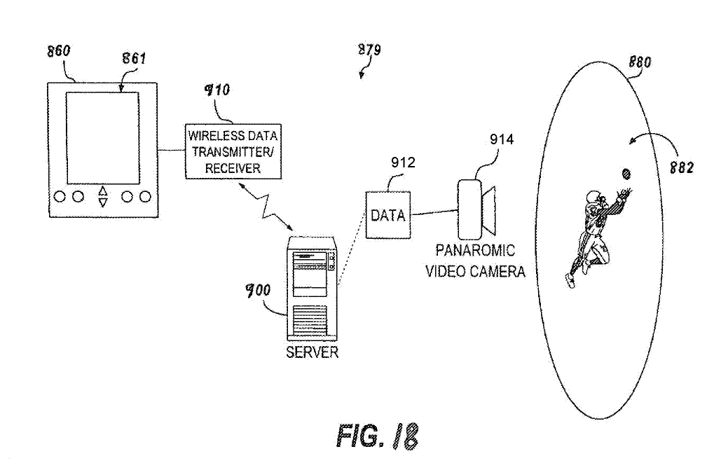

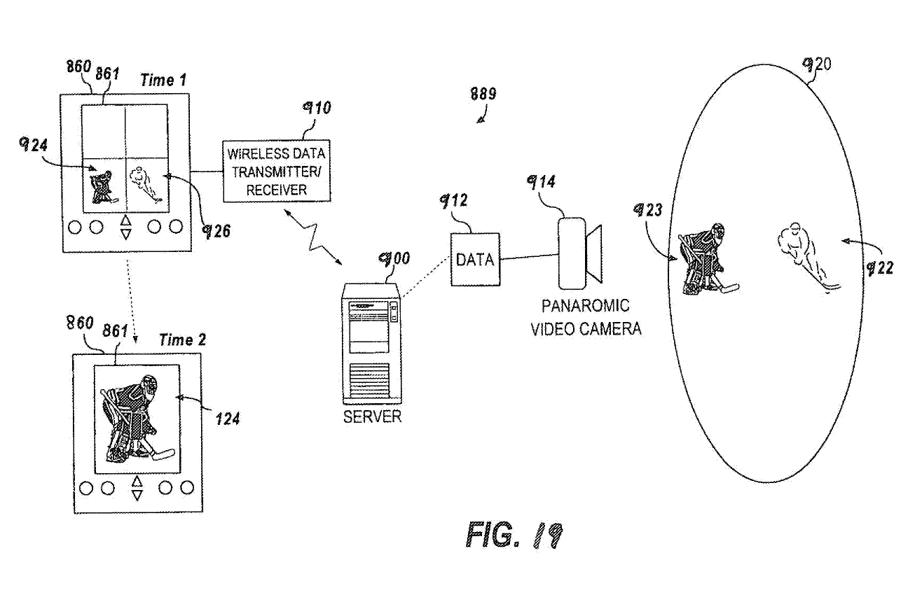

FIG. 1B illustrates a block diagram of a self-contained pod 100 with wireless communications and server components thereof for establishing a data communications network, in accordance with another example embodiment. In the alternative example embodiment of pod 100 shown in FIG. 18B, multiple cameras 150, 151 are shown disposed with respect to pod 100. The example pod 100 shown in FIG. 1B can include optional wheels 160, rechargeable power supply 130 (e.g., rechargeable batteries), the synchronized data server 115, wireless data communications 110, and sensors 170 which can also include GPS (Global Positioning Satellite) sensors and navigation (nav) sensors. The solar panel 140 is shown in FIG. 18 as being located between or proximate to the telescoping masts 120, 121 which respectively maintain the cameras 150, 151.

A GPS sensor can collect, for example, real-time latitude, longitude, and altitude data. Such a GPS sensor can be include a receiver with an antenna that utilizes a satellite-based navigation system with a network of 24 satellites in orbit around the earth to provide position, velocity, and timing information. The navigation sensor can be implemented as an inertial navigation system (INS) or navigation aid that utilizes a computer, motion sensors (e.g., accelerometers), and rotation sensors (e.g., gyroscopes) to continuously calculate via dead reckoning, the position, orientation, and velocity (e.g., direction and speed of movement) of a moving object (e.g., such as the pod 100 itself when moveable via the optional wheels 160) without the need for external references. Such an INS may include the use of an internal guidance system, inertial instruments, the use of inertial measurement units (IMU), and so on.

FIG. 1C illustrates a block diagram of a self-contained pod 100 with wireless communications and server components thereof for establishing a data communications network, in accordance with yet another example embodiment. In the alternative embodiment of pod 100 shown in FIG. 1C, the pod 100 can be configured to communicate wirelessly with a drone or unmanned aerial vehicle 180 that is equipped with a wireless camera 185. Digital video and images acquired by camera 185 can be transmitted wirelessly to the pod 100 via wireless data communications 110 and processed as digital data by the synchronized data server 115. Although pod 100 can be equipped with rechargeable power 130, the unmanned aerial vehicle 180 may be equipped with its own rechargeable battery to supply power to the unmanned aerial vehicle 180. In some example embodiments, the rechargeable battery 130 may supply power to both the pod 100 and its electronic/electrical components such as sensors 170, wireless data communications 110, and the synchronized data server 115. The solar panel 140 can also provide power as indicated previously to rechargeable batteries/power associated with the pod 100 and/or the drone or unmanned aerial vehicle 180. Note that the term “drone” as utilized herein can refer a UAV (Unmanned Aerial Vehicle), a UGV (Unmanned Ground Vehicle), or other types of drones including micro-implementations such as micro unmanned aerial vehicles and micro unmanned ground vehicles. In the example embodiment shown in FIG. 1C, the drone 185 shown is a UAV. In other example embodiments, the drone 185 may be a UGV.

The pod 100 can serve in some example embodiments as a launch pad for the unmanned aerial vehicle 180. The unmanned aerial vehicle 180 can dock with the pod 100 at a docking and/or charging port 187. The pod 100 can manage two or more unmanned aerial vehicles or drones. For example, one drone may be docked and recharging via the docking and/or charging port 187 while another drone conducts aerial surveillance and video image acquisition and then swaps out with the other drone for recharging at the docking and/or charging port 187. In this manner, the unmanned aerial vehicle 180 can be wirelessly tethered to the pod 100 via wireless data communications between the pod 100 and the drone 180.

FIG. 1D illustrates a block diagram of a self-contained pod 100 with wireless communications and server components thereof for establishing a data communications network, in accordance with another example embodiment. The pod 100 shown in FIG. 1D is similar or analogous to the pods shown in FIGS. 1A, 1B, and 1C with the inclusion of an antenna 123 and an optional solar cell 140 disposed on the pod 100. Note the antenna 123 shown in the FIG. 1D example embodiment can be implemented as, for example, an omni directional antenna, a directional antenna, and a dual polarized antenna. Examples of omni directional antennas that can be utilized as antenna 123 include, for example, the “Rubber Duck” antenna found on many WiFi access points and routers as well as the complicated antenna arrays utilized on cellular towers. In some example embodiments, antenna 123 may be a WiFi antenna that communicates electronically with the synchronized data server 115. Antenna 123 can also be configured in some example embodiments as an antenna capable of receiving and transmitting Bluetooth (BL) standard protocol wireless data communications including Bluetooth low energy (LE) or BLE wireless data communications. In the example shown in FIG. 1D, the pod 100 is depicted without the cameras 150, 151 and the telescoping mast 120 and functions primarily as a data communications node for a data communications network.

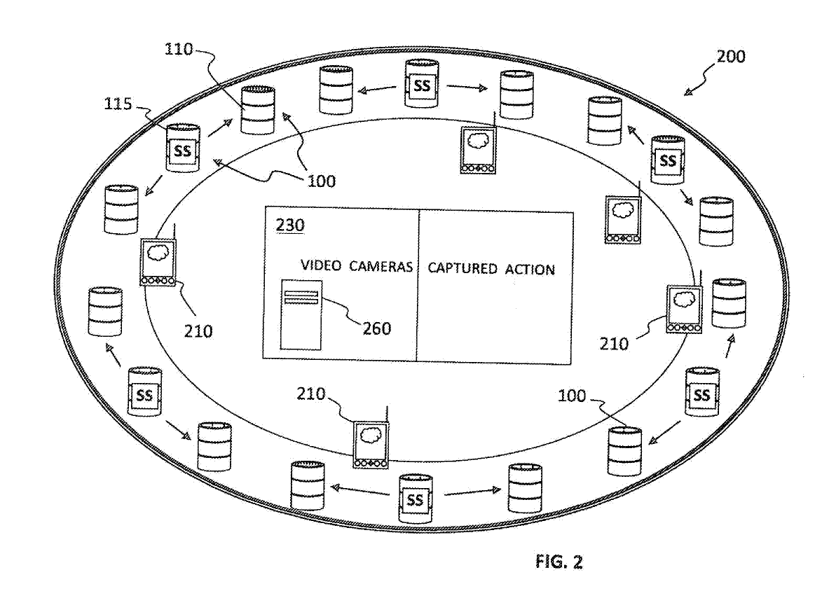

Note that in some example embodiments, the wireless communications electronics 110 shown in FIGS. 1A, 1B, 1C, and/or 1D can be configured as a Bluetooth low energy (LE) or BLE component that broadcasts an identifier to nearby portable electronic devices such as, for example, one or more of the client devices 210 shown in FIG. 2. Bluetooth LE, as the name hints, has low energy requirements. It can last up to 3 years on a single coin cell battery. BLE is 60-80% cheaper than traditional Bluetooth. BLE is ideal for simple applications requiring small periodic transfers of data. Classic Bluetooth (i.e., Bluetooth standard protocol) may be preferred for more complex applications requiring consistent communication and more data throughput.

One example of a BLE component which may be implemented in some embodiments is the iBeacon, which is a protocol developed by Apple Computers and which is built upon Bluetooth Low Energy (BLE), a highly power efficient version of the Bluetooth standard protocol. iBeacon-compatible hardware transmitters—typically called beacons—are a class of BLE devices that broadcast their identifier to nearby portable electronic devices. The technology can enable hand held devices such as, for example, smartphones, tablets, and other computing devices to perform actions when in close proximity to an iBeacon.

The iBeacon utilizes BLE proximity sensing to transmit a universal unique identifier picked up by a compatible “app” or operating system. The identifier and several bytes sent with it can be used to determine the device's physical location, track customers, or trigger a location-based action on the device such as a check-in on social media or a push notification. It can be appreciated that the use of an iBeacon type device or component is not considered a limiting feature of the disclosed embodiments, but is referred to herein for exemplary purposes only. Other non-iBeacon type devices and systems may be utilized in accordance with an alternative example embodiment. For example, Eddystone, a Google product, is a device based on an open source, cross-platform Bluetooth LE beacon format. Such non-iBeacon and iBeacon type devices and components can be referred to simply by the term “beacon”.

In another example embodiment, the wireless communications electronics 110 can be configured as an LTE (Long-Term Evolution) communications component for wireless communication of high-speed data for mobile phones and data terminals. Such an LTE communications component may be based on, for example, GSM/EDGE and UMTS/HSPA network technologies.

In still another example embodiment, the wireless communications electronics 110 can be configured as a WiFi and/or cellular router. In the case of a cellular router, the wireless communications electronics 110 in some example embodiments can be configured as a 5G cellular router. Note that 5G (5th generation mobile networks or 5th generation wireless systems) denote the next major phase of mobile telecommunications standards beyond the current 4G/IMT-Advanced standards. 5G has speeds beyond what the current 4G can offer. The Next Generation Mobile Networks Alliance defines the following requirements for 5G networks: data rates of several tens of megabits per second should be supported for tens of thousands of users; 1 gigabit per second to be offered simultaneously to many workers on the same office floor; several hundreds of thousands of simultaneous connections to be supported for massive sensor deployments; spectral efficiency should be significantly enhanced compared to 4G; coverage should be improved; signaling efficiency should be enhanced; and latency should be reduced significantly compared to LTE. In addition to providing simply faster speeds, it is predicted that 5G networks also need to meet the needs of new use cases, such as the Internet of Things (such as the network equipment in buildings or vehicles for web access) as well as broadcast-like services and lifeline communication in times of natural disaster. In other example embodiments, the wireless communications electronics 110 can be configured with Bluetooth LE communications components, LTE communications components, and/or 5G wireless communications capabilities.

In yet another example embodiment, the wireless communications electronics 110 may be configured with RFID (Radio Frequency Identification) components. RFID utilizes electromagnetic fields to automatically identify and track tags attached to objects. The tags contain electronically stored information. Passive tags collect energy from a nearby RFID reader's interrogating radio waves. Active tags have a local power source such as a battery and may operate at hundreds of meters from the RFID reader. In such an RFID example embodiment, hand held devices (e.g., hand held device 210 shown in FIG. 2) may be equipped with a passive receiver (tag), which is then correctly identified when the tag passes close to the RFID components of the wireless communications electronics 110. Whenever such a tag enters the range of the RFID components, the tag receives a signal, which it activates and replies by sending back to the RFID components a unique identifier.

Outdoor venues, such as, for example, racing venues, football stadiums, baseball stadiums, cricket stadiums, as well as large amusement and theme parks and outdoor public gathering places, will benefit from a solar powered communications pod 100. Solar power can extend operation time for the pod 100. Solar cells can vary in size depending on the surface area of the pod's top surface. Weather resistance is also an important consideration for the communications pods 100. Data captured in the form of video from cameras 150 offers additional perspective for spectators via hand held devices at the venue or remote from the venue (e.g., at home, in a different geographical location) from the pod(s) 100. In one example embodiment, a pod such as pod 100 can be configured with a housing that allows ventilation and minimizes water saturation and interference with electronics and power sources contained therein. A housing utilized for outdoor speaker systems that allows sound to emanate from the housing can in some example embodiments be employed with pod(s) 100 to also minimize moisture penetration within the speaker housing. It can be appreciated, of course, that the use of solar power is not a limiting feature of the disclosed embodiments. Other implementations may involve the use of replaceable and/or rechargeable batteries.

As illustrated in the top perspective view of FIG. 2, a venue 200 can be equipped with wireless data communications system nodes 100 distributed around and throughout the venue 200 for establishing a wireless communication network in communication with one or more hand held devices 210 (e.g., client devices) used by spectators and/or audience members within the venue 200, and for capturing video from various perspective around the venue, in accordance with an example embodiment. Such a wireless communications network can be a bidirectional packet based data network. Such a bidirectional packet based data network may be, for example, a Wireless LAN or a cellular communications network. An example of such a wireless communication network is the wireless network 710 described herein with respect to FIG. 11. Examples of hand held devices 210 include, for example, the client devices 702, 703, and 704 shown in FIG. 11. One or more of the hand held devices 210 may be mobile communication devices, such as, for example, smartphones, tablet computing devices, laptop computers, and so on.

A wireless communications network (e.g., such as wireless network 710 shown in FIG. 11) supported by the pods 100 can enable, for example, handheld devices 210 to receive multiple perspective of an event 230 in video captured within the venue by cameras as shown in block 230. As shown in FIG. 2, however, synchronized servers 115 (labeled “SS”) can be distributed evenly around a public venue in order to better facilitate hand held client access to video and data from a primary server 260 that is being simultaneously replicated by the synchronized servers 115. Each synchronized server 115 shown in FIG. 2 is coordinating wireless data traffic to hand held devices 210 with the assistance of two other pods 110. It can now be appreciated how much more efficient video can be distributed within venues using a synchronized server scheme.

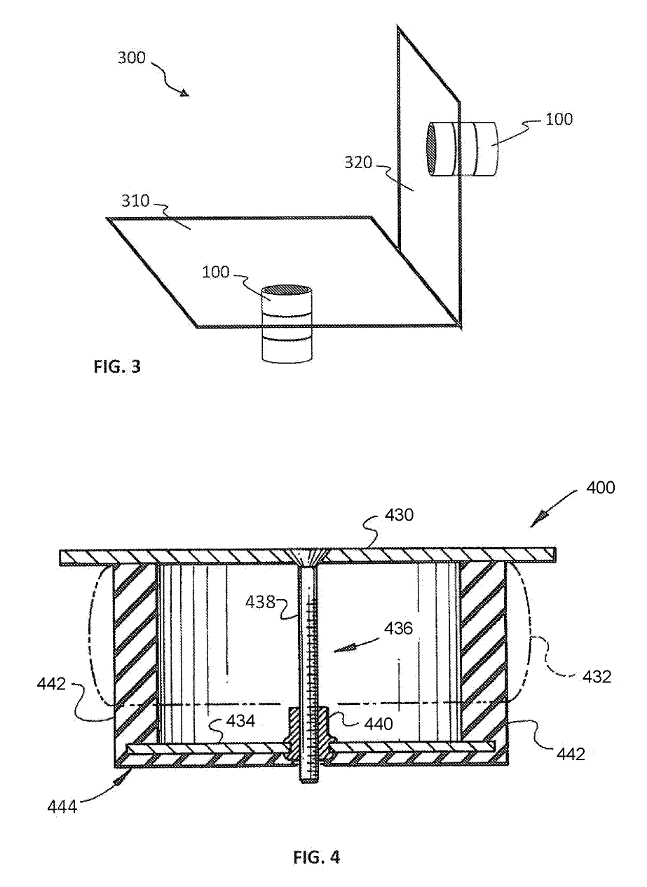

In some venues, it may be desirable to more permanently install communications pods 100 for ongoing use. Such can be the case wherein an older sports venue requires wireless communications infrastructure and the older venue must be retrofitted to incorporate the wireless communications infrastructure with little aesthetic and space encumbrances on the venue. As shown in FIG. 3, self-contained communications pods 100 can be embedded into the flooring 310 and walls 320 of a venue 300. Embedded pods can be accomplished by providing the communications electronics 110 in a carrier that can mount flush with the flooring 310 or wall 320 surfaces. Camera integration may not be feasible in floor placements, but cameras could be integrated into pods embedded into walls 320, and can thereby capture video from the perspective at the wall. A telescoping mast is clearly not needed in wall placements where a cameras is included. The surface of the pod would ideally integrate a solar cell and a camera lens in order to provide power and data capture to a pod installed in walls and utilized for data capture as well as communications for mobile devices.

A core hole plug assembly can provide a carrier for the communications electronics 110. As such, a core hole plug can serve as an embedded pod 100. The pod 100 in the form of a core hole plug assembly can also include a rechargeable power source 130 and embedded antennae 120. Alternatively, power can be provided to the embedded pod via wiring accessible within the flooring 310 or walls 320. A solar cell 140 can also be optionally provided at the surface of the pod to provide a trickle charge to rechargeable power source 130, if provided in the pod.

A core hole plug can be employed for covering and sealing a hole in a paved surface, wall, or other structure. Many locations such as urban environments, office parks, shopping centers, offices, and industrial and commercial buildings are surrounded in whole or in part with paved surfaces such as, but not limited to, concrete paving, asphalt paving, stone or brick paving, and paving made of similar materials. The paving takes many forms, e.g., driveways, sidewalks, etc. A typical paving is a concrete slab or other paving material about four to eight inches thick. Offices, warehouses, and other industrial and commercial buildings often have solid or hollow walls made of concrete, block, or other materials of various thicknesses, e.g., walls having thicknesses of six to eight inches or more.

Although core holes or other holes are typically about three inches or slightly greater in diameter, the diameter and depth of a communications pod 100 can vary depending on the required size of the internal compartment to accommodate the modules (e.g., battery, electronics) to support wireless communications.

Core holes are sometimes formed in paved surfaces and walls for various purposes such as, but not limited to, tests to determine if the paving or wall meets specifications, the treatment of cockroaches, ants, and various other pests, the passage of utilities through the walls, etc. Once a core has been taken from or a hole otherwise made in a paved surface, wall, or other structure there usually is a need to cover and seal the hole, e.g., after a core sample has been taken, after pests have been treated, prior to the installation or after the removal of utilities, etc. Since core hole plugs are relatively easy to install and unobtrusive or inconspicuous, rather than patching these holes, these holes are frequently covered and sealed with core hole plugs. In addition to being easy and quick to install and unobtrusive or inconspicuous, the core hole plugs have another advantage over patching the holes. Should there be a need to later gain access to the interior of the hole, the core hole plug can be removed.

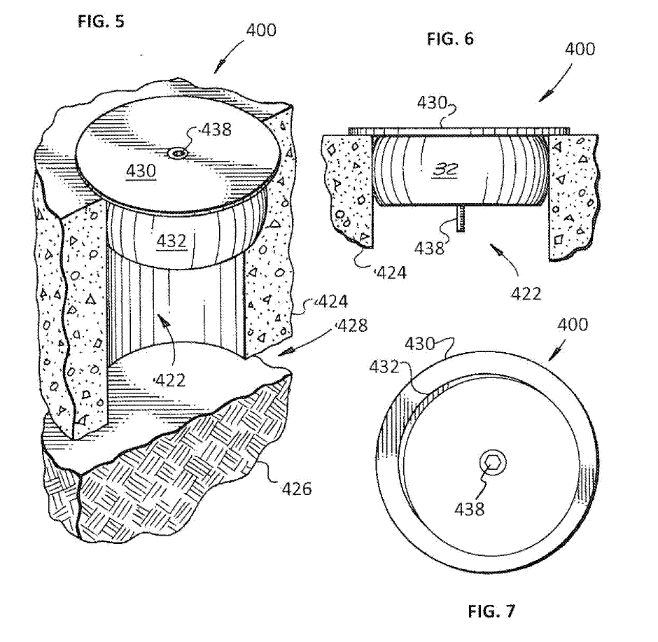

FIGS. 4-7 illustrate a core hole plug assembly 400, which can be adapted for use in accordance with an example embodiment. The illustrated core hole plug assembly 400 can be utilized for many different applications to cover and seal a hole in a paving layer, hollow or solid wall, or other structure. For the purposes of illustration, the core hole plug assembly 400 is shown in FIGS. 4-7 covering and sealing a hole 422 passing through a paving layer 424. The paving layer 424 may be any of numerous paving layers found adjacent and/or under building structures such as, but not limited to, concrete paving or slabs, asphalt paving, stone or brick paving, and paving made of similar materials. As previously discussed, the paving layers are typically about four to eight inches in thickness and the core holes 422 passing through these paving layers are typically about 3 inches in diameter. Since the soil 426 beneath a paving layer 424 may fall away from the bottom of the paving layer, a hole 422 passing through a paving layer is frequently several inches greater in depth than the thickness of the paving layer and may include a cavity 428 beneath a paving layer into which components of a core hole plug assembly may fall.

A core hole plug assembly 400 can include, for example, a cover plate 430; a deformable, resilient expansible plug 432; a compression plate 434; and a bolt and nut assembly 436 with a bolt 438 and a nut 440. The expansible plug 432 is cylindrical with a tubular sidewall 442. Preferably, the compression plate 434 is a circular disk and the nut 440 of the bolt and nut assembly 436 is welded or otherwise non-rotatably affixed to and integral with the compression plate 434. The compression plate 434 is permanently and non-rotatably secured to the lower end portion 444 of the expansible plug 432, preferably, by being molded into or otherwise completely embedded within the lower end portion 444 of the expansible plug 432 so that the compression plate 434 does not rotate relative to the expansible plug.

Preferably, the upper end of the expansible plug 432 is permanently and non-rotatably secured to the underside of the cover plate 430, e.g., adhesively or otherwise bonded to the underside of the cover plate, so that the expansible plug does not rotate relative to the cover plate. With the nut 440 of the bolt and nut assembly 436 non-rotatably affixed to the compression plate 434, the compression plate 434 non-rotatably secured to the lower end portion 444 of the expansible plug 432, and expansible plug 432 non-rotatably affixed to the underside of the cover plate 430, these components of the core hole plug assembly 400 function as a unit so that the bolt 438 of the bolt and nut assembly 436 can be threaded into or out of the nut 440 to move the compression plate 434 relative to the cover plate 430 (toward or away from the cover plate 430).

The bolt 438 of the bolt and nut assembly 436 passes down through a hole in the cover plate, through the expansible plug 432 and is threaded into the nut 440 affixed to the compression plate 434. When the bolt and nut assembly 436 is tightened by threading the bolt 438 into the nut 440, the compression plate 434 is drawn toward the cover plate 430 to compress the expansible plug 432 between the compression plate 434 and the cover plate 430 and expand the expansible plug 432 in diameter. When the bolt and nut assembly 436 is loosened by partially unthreading the bolt 438 from the nut 440, the compression plate 434 is moved away from the cover plate 430 and permits the resilient expansible plug 432 to return to its original shape and diameter.

In use, as the expansible plug 432 is compressed by tightening the bolt and nut assembly 436 and drawing the compression plate 434 toward the cover plate 430, the expansible plug 432 expands in diameter to force the outside surface of the expansible plug 432 into contact with the sidewall of a hole. This secures the core hole plug assembly 400 in place and forms a seal between the outside surface of expansible plug 432 and the sidewall of the hole. When the bolt and nut assembly 436 is loosened and the expansible plug 432 is allowed to return to its initial shape and diameter, the outside surface of the expansible plug 432 draws away from the sidewall of the hole and the core hole plug assembly 400 can be easily removed as a unit without fear of losing a nut, compression plate, or plug down the hole or wall cavity.

The cover plate 430 and the compression plate can be made of stainless steel, aluminum, a durable polymeric material, a durable fiberglass reinforced polymeric material, or some other suitable durable, preferably noncorrosive and chemical resistant material. If made of metal, the cover plate 430 can serve as the antennae for the pod 100 for carrying out wireless communication, in accordance with an example embodiment. The bolt and nut assembly 436 can be made with a stainless steel bolt 438 and a stainless steel nut 440.

Various heads may be used on the bolt 438 of the bolt and nut assembly 436 so that the bolt and nut assembly can be tightened and loosened using a wrench, an Allen wrench, a screwdriver, or other tool. Preferably, there can be a recess in the upper surface of the cover plate 430 surrounding the hole through which the bolt passes. The head of the bolt 438 is received within the recess so that the head of the bolt is flush or substantially flush with the upper surface of the cover plate 430. In accordance with an example embodiment, electronics 110 circuitry (e.g., circuit boards, solar cell 140), a synchronized server 115, and batteries 130 can be designed to accept a center bolt.

The expansible plug 432 can be made in some example embodiments of a deformable and resilient polymeric material such as, but not limited to, a deformable, resilient thermoplastic rubber or polymeric material, which has the resilience to return to its original diameter and shape when the expansible plug 432 is not under compression. Preferably, the material forming the expansible plug 432 is also durable and chemical resistant. The cover plate 430 is greater in diameter than the diameter of the expansible plug 432 and any hole the core hole plug assembly 400 is to seal. The compression plate 434 is typically made of stainless steel and is a little less than but about the same diameter as the diameter of the expansible plug 432. The cover plate 430 is typically about 3½ to 4 inches in diameter. When not compressed, the expansible plug 432 is typically about ⅛ to about ¼ of an inch less in diameter than the diameter of the hole with which the core hole plug assembly 400 is to be used (e.g., about 2¾ to about 2⅞ inches in diameter for use with a hole about 3 inches in diameter) and about 1 to 1½ inches in height.

With the compression plate 434 completely embedded within the lower end portion 444 of the expansible plug 432, the polymeric material forming the expansible plug forms a lowermost disk shaped layer of the assembly. A top view of the top surface of the cover plate is shown in FIG. 7.

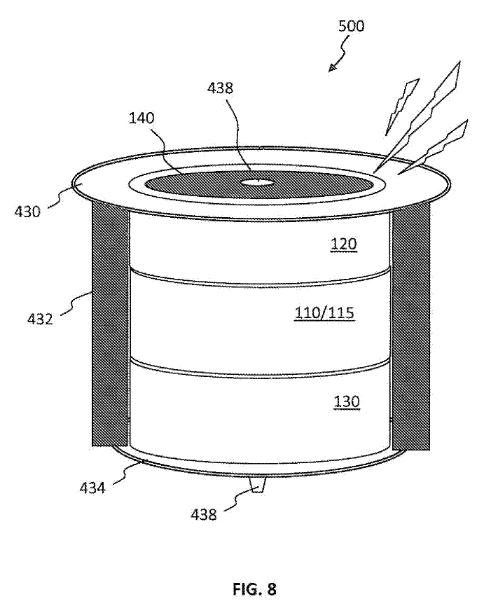

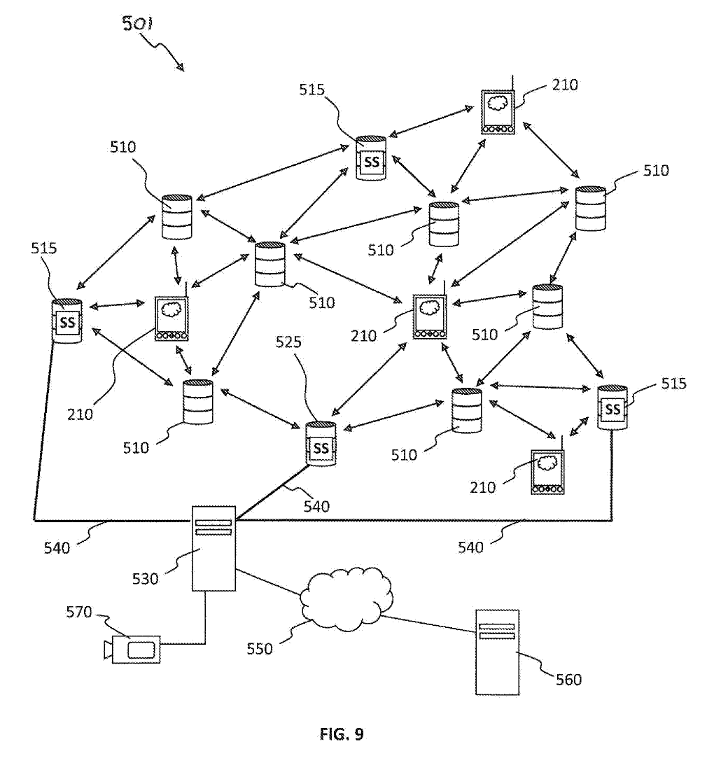

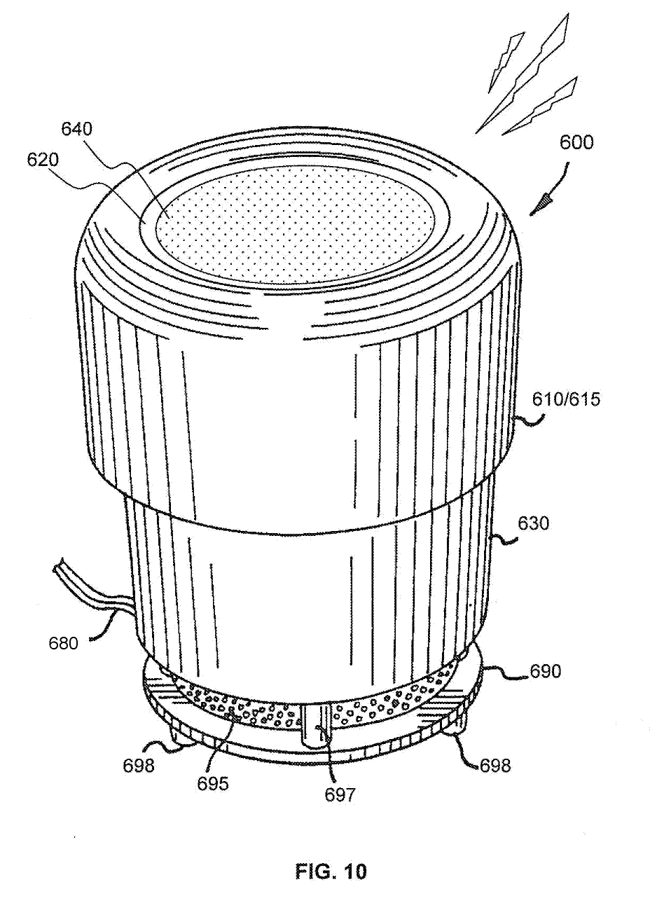

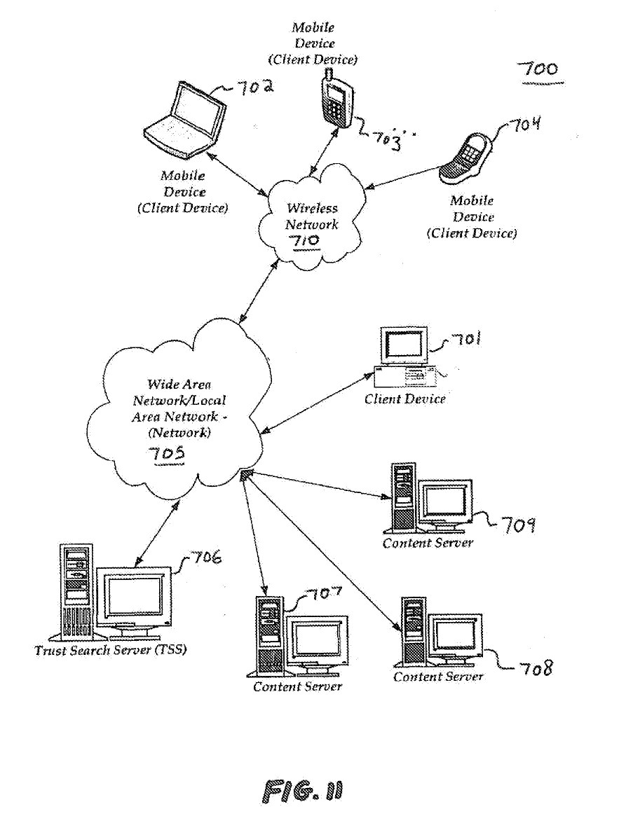

FIG. 8 illustrates a side view of a pod 500 in a form similar to the core hole plug assembly 400 shown in FIGS. 4-6, in accordance with an example embodiment. The pod 500 can include wireless communications electronics 110 to operate as a wireless data communications system nodes that can be distributed throughout the venue for establishing a wireless communication network in communication with hand held devices used by spectators or audience members within a venue, in accordance with an example embodiment. In some embodiments, the pod 500 can also include a synchronized server 115 to coordinate with and lessen the burden on a primary video server at the venue.

The example pod 500 shown in FIG. 8 can also include a rechargeable power source 130, embedded antennae 120, and a solar cell 140. Pod 500 can be embedded into the surface at a venue and include modules 110-140 supporting wireless communications (e.g., WiFi access points, wireless repeaters). Electronics that are tolerant to high operating temperatures can be utilized where little or no venting is provided given the embedded nature of the core plug configuration. Venting can be provided in some example installations from the bottom portion of the core hole plug.

FIG. 9 illustrates a block diagram of a system 501 with network resources operable within a venue to provide wireless data communications system nodes distributed throughout the venue for establishing a wireless communication network supporting communications with one or more hand held devices 210 utilized by, for example, spectators/audience members located within the venue or in some cases by users located remote from the venue such as their home, in a car, and so on, in accordance with an example embodiment. In some embodiments, system 501 can be configured or located within a venue or in association with a venue. System 501 can be implemented in the context of, for example, a wireless communications network (e.g., WiFi, cellular, etc.). Video captured by cameras 570 located throughout the venue can be provided as digital video data to enterprise equipment 530 located at the venue to manage recorded content. Such enterprise equipment 530 can be, for example, a data server.

Venue-based data including, for example, video, audio, statistics, venue information, concession information, advertising, etc., can be provided throughout the venue to one or more hand held devices 210 via any combination of synchronized servers nodes 515 and wireless communications nodes 510 located throughout the venue. Communications nodes 510 can include wireless routers 525 connected to a wired data network 540 established at the venue as well as repeaters provided throughout the venue to further extend wireless capabilities for hand held devices 210 located and in use at the venue. Synchronized server nodes 515 can include at least one server synchronized with at least one primary data server and any combination of wireless communication hardware to enable an access point for hand held devices 210 and wireless communications nodes 510 to communicate with the synchronized server node 515. Content from remote servers 560 can also be provided to hand held devices 210 via wired and wireless data networks 550 servicing the venue.

Referring to FIG. 10, a communications pod 600 including a weatherproof housing is illustrated in accordance with an example embodiment. The pod 600 includes a communications electronics portion 610, a rechargeable power source portion 630, and a base portion 690. The top surface of the communications electronics portion can include a solar cell 640, as shown. An integrated antennae ring 620 is also shown, which can facilitate communications without the need for extendable antennae hardware. If the pod 600 includes access point electronics, an Ethernet connection can be provided via a cord 680. If the pod 600 is a repeater, the Ethernet connection does not need to be provided as the repeater can facilitate communications to hand held devices from the repeaters wireless communications with Ethernet-connected access points. If the pod 600 is a synchronized data server, an Ethernet connection can be provided via cord 680. The cord 680 representing the Ethernet connection can also be representative of a power cord used to recharge the rechargeable power source (i.e., rechargeable lithium ion batteries or the like) locating within the pod 600.

Batteries can be recharged in-between uses or continuously through the cord. The cord 680 can also represent a combined power and data source for the pod 600. A vent 695 can be provided near the bottom of the housing at the base portion 690. Small spacers/pillars can provide a gap for the vent, which can enable electronics within the housing to breath/cool. Leg stands 698 can also be provided beneath the base portion 690. The housing illustrated in FIG. 10 is just one example of how pods can be presented for use in public venues. Other designs can be provided that still include features of the disclosed example embodiments without departing from the scope of the disclosed embodiments. Materials selected for the housing should ideally withstand a wide range of temperature ranges, ultraviolet exposure, and weather.

It should be appreciated that wireless data connections are becoming more robust and provide large bandwidth capabilities. For example, Third Generation (3G) cellular communication enables access to video by handheld devices. Fourth Generation (4G) wireless data communications have been deployed. 5G wireless data communications devices will be deployed soon. Given the teaching herein, nodes 600 operating as a synchronized server pod 515 throughout a public venue can be synchronized with a primary server using, for example, LTE, cellular 4G, or greater, wireless communications such as 5G. As the synchronized servers are being synchronized with near real time video data for a live event, the synchronized servers 515 can distribute near real time video and data content to hand held devices utilizing supporting communications pods 510. Infrastructure costs and maintenance requirements can thus be greatly reduced with a system as described herein; especially when deployment is temporary.

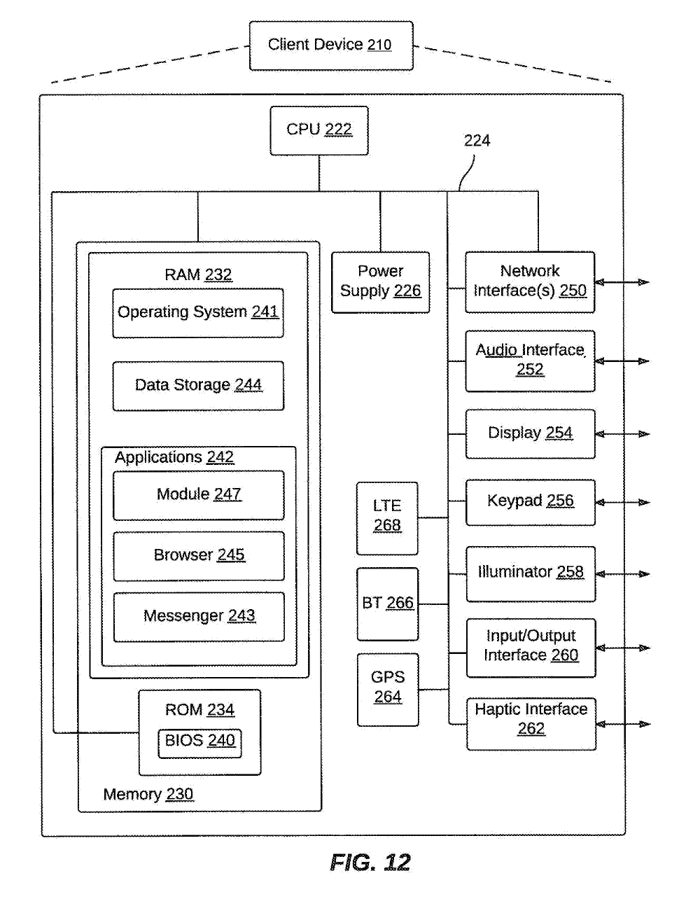

FIG. 11 illustrates a schematic diagram depicting an example embodiment of a system 700 composed of one or more networks. Other embodiments that may vary, for example, in terms of arrangement or in terms of type of components, are also intended to be included within the claimed subject matter. The system 700 depicted in FIG. 11, for example, can include a variety of networks, such as a WAN (Wide Area Network)/LAN (Local Area Network) 705, a wireless network 710, and a variety of devices, such as a client device 701, mobile devices 702, 703, 704, and a variety of servers, such as, for example, content servers 707, 708, 709 and a trust search server 706. In the example configuration depicted in FIG. 11, mobile devices 702, 703, and 704 are client devices that communicate wirelessly with system 700 through the wireless network 710. The WAN/LAN network 705 also can communicate with the wireless network 710. Note that the client devices 701, 702, 703, and/or 704 are analogous to the client device 210 discussed previously and an example of which is also shown in FIG. 12. Note that in some example embodiments, one or more of the servers 706, 707, 708, and 709 may be implemented as synchronized servers 115 discussed previously herein.

A content server such as content servers 707, 708, 709 may include a device that includes a configuration to provide content via a network to another device. A content server may, for example, host a site, such as a social networking site, examples of which may include, without limitation, Flicker®, Twitter®, Facebook®, LinkedIn®, or a personal user site (e.g., such as a blog, viog, online dating site, etc.). A content server may also host a variety of other sites including, but not limited to, business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor-type, or programmable consumer electronics, etc.

A network such as network 705 and/or network 710 depicted in FIG. 11 can couple devices so that communications may be exchanged, such as between a server and a client device or other types of devices, including between wireless devices coupled via a wired or wireless network, for example. A network may also include mass storage, such as network-attached storage (NAS), a storage area network (SAN), or other forms of computer or machine-readable media, for example. A network may include the Internet, one or more local area networks (LANs), one or more wide area networks (WANs), wire-line type connections, wireless type connections, or any combination thereof. Likewise, sub-networks may employ differing architectures or may be compliant or compatible with differing protocols, and may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels. Furthermore, a computing device or other related electronic devices may be remotely coupled to a network, such as via a telephone line or link, for example.

A wireless network such as the wireless network 710 depicted in FIG. 11 may couple client devices with the network. That is, such a wireless network may employ stand-alone ad-hoc networks, mesh networks, wireless LAN (WLAN) networks, cellular networks, or the like. A wireless network such as wireless network 710 can further include a system of terminals, gateways, routers, or the like coupled by wireless radio links, or the like, which may move freely, randomly, or organize themselves arbitrarily, such that network topology may change, at times even rapidly. A wireless network may further employ a plurality of network access technologies including Long Term Evolution (LTE), WLAN, Wireless Router (WR) mesh, or 2^{nd}, 3^{rd}, 4^{th}, 5^{th} generation (2G, 3G, 4G, or 5G) cellular communications technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, 5G cellular communications, or the like. A wireless network may include virtually any type of wireless communication mechanism by which signals may be communicated between devices, such as a client device or a computing device, between or within a network, or the like.

Signal packets communicated via a network, such as a network of participating digital communication networks (e.g., networks 705, 710), may be compatible with or compliant with one or more protocols. The signaling formats or protocols employed may include, for example, TCP/IP, UDP, DECnet, NetBEUI, IPX, AppleTalk, or the like. Versions of the Internet Protocol (IP) may include in some examples IPv4 or IPv6.

The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the internet may, for example, be routed via a path of gateways, servers, etc., that may route the signal packet in accordance with a target address and availability of a network path to the target address.

FIG. 12 illustrates a schematic diagram depicting one example embodiment of client device 210, which may be used as, for example, one or more of the client devices 701, 702, 703, and 704 depicted in FIG. 11. An example of the client device 210 is one or more of the hand held devices 210 discussed previously herein, which can be used by spectators within the venue 100. The client device 210 can function as a computing device capable of sending or receiving signals through a wired or a wireless network such as, for example, networks 705, 710 depicted in FIG. 11.

The client device 210 may implemented as, for example, a desktop computer or a portable device, such as a cellular telephone, a Smartphone, a display pager, a radio frequency (RF) device, an infrared (IR) device, a Personal Digital Assistant (PDA), a handheld computer, a tablet computer, a laptop computer, a desktop computer, a set top box, a wearable computer, or an integrated device combining various features, such as features of the forgoing devices, or the like.

A client device such as client device 210 may vary in terms of capabilities or features. The claimed subject matter is intended to cover a wide range of potential variations. For example, a cell phone may include a numeric keypad or a display of limited functionality, such as a monochrome liquid crystal display (LCD) for rendering text and other media. In contrast, however, as another example, a web-enabled client device may include one or more physical or virtual keyboards, mass storage, one or more accelerometers, one or more gyroscopes, global positioning system (GPS) or other location identifying type capability, or a display with a high degree of functionality, such as a touch-sensitive color 2D or 3D display, for example.

A client device, such as client device 210, may include or may execute a variety of operating systems, such as operating system 241, including in some example embodiments a personal computer operating system, such as a Windows, iOS or Linux, or a mobile operating system, such as iOS, Android, or Windows Mobile, or the like. A client device such as client device 210 may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Instagram Flickr®, Google+®, to provide only a few possible examples.

A client device, such as client device 210, may also include or execute an application to communicate content, such as, for example, textual content, multimedia content, or the like. A client device may also include or execute an application to perform a variety of possible tasks, such as browsing, searching, playing various forms of content, including locally stored or streamed video, or games (e.g., fantasy sports leagues, etc.). The foregoing is provided to illustrate that claimed subject matter is intended to include a wide range of possible features or capabilities. Examples of such applications (or modules) can include a messenger 243, a browser 245, and other client application(s) or module(s) such as a module 247, which can implement instructions or operations such as those described herein.

The example client device 210 shown in FIG. 12 generally includes a CPU (Central Processing Unit) 222 and/or other processors (not shown) coupled electronically via a system bus 224 to memory 230, power supply 226, and a network interface 250. The memory 230 can be composed of RAM (Random Access Memory) 232 and ROM (Read Only Memory) 234. Other example components that may be included with client device 200 can include, for example, an audio interface 252, a display 254, a keypad 256, an illuminator 258, and an input/output interface 260. In some example embodiments, a haptic interface 262 and a GPS (Global Positioning Satellite) unit 264 can also be electronically coupled via the system bus 224 to CPU 222, memory 230, power supply 226, and so on.

In some example embodiments, the client device 210 can be configured with a Bluetooth (BT) communications component 266, which in some configurations may communicate with, for example, the wireless communications electronics 110 discussed earlier. The client device 210 can also be configured with, for example, an LTE communications component 268. In some example embodiments, the Bluetooth communications component 266 may be implemented not only with standard or regular Bluetooth wireless communications capabilities but also as BLE (Bluetooth Low Energy) or Bluetooth LE as discussed earlier.

RAM 232 can store an operating system 241 and provide for data storage 244, and the storage of applications 242 such as, for example, browser 245 and messenger 243 applications. ROM 234 can include a BIOS (Basic Input/Output System) 240, which is a program that the CPU 222 utilizes to initiate the computing system associated with client device 210. BIOS 240 can also manage data flow between operating system 241 and components such as display 254, keypad 256, and so on.

Applications 242 can thus be stored in memory 230 and may be “loaded” (i.e., transferred from, for example, memory 230 or another memory location) for execution by the client device 200. Client device 200 can receive user commands and data through, for example, the input/output interface 260. Such inputs may then be acted upon by the client device 210 in accordance with instructions from operating system 241 and/or application(s) 242. The interface 260, in some embodiments, can serve to display results, whereupon a user may supply additional inputs or terminate a session.

The following discussion is intended to provide a brief, general description of suitable computing environments in which the disclosed methods and systems may be implemented. Although not required, the disclosed embodiments will be described in the general context of computer-executable instructions, such as program modules being executed by a single computer. In most instances, a “module” constitutes a software application. However, a module may also comprise, for example, electronic and/or computer hardware or such hardware in combination with software. In some cases, a “module” can also constitute a database and/or electronic hardware and software that interact with the database.

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term “module” as utilized herein may refer to a collection of routines and data structures that perform a particular task or implement a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc. Thus, the instructions or steps discussed herein can be implemented in some example embodiments in the context of such a module or a group of modules, sub-modules, and so on. For example, in some embodiments, the applications 242 illustrated in FIG. 12 in the context of client device 210 can function as a module composed of a group of sub-modules such as, for example, module 247, browser 245, messenger 243, and so on.

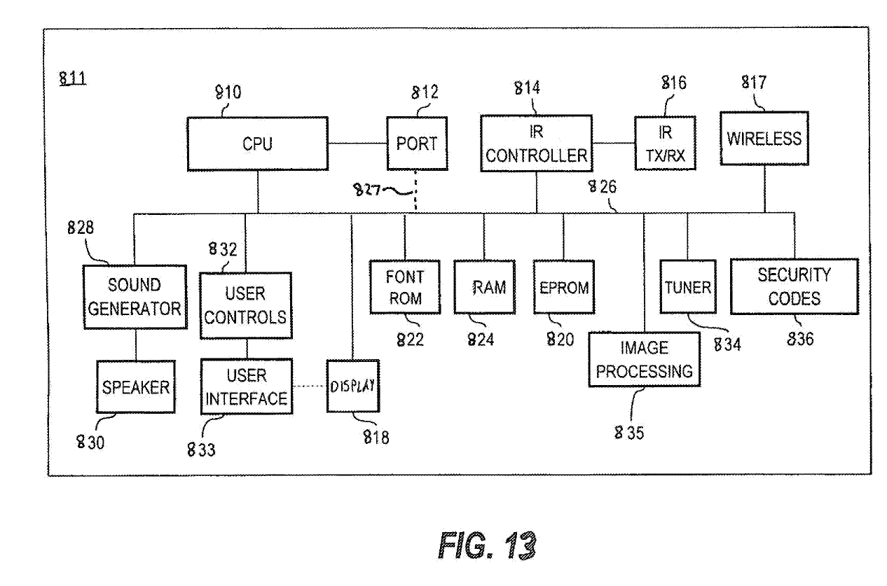

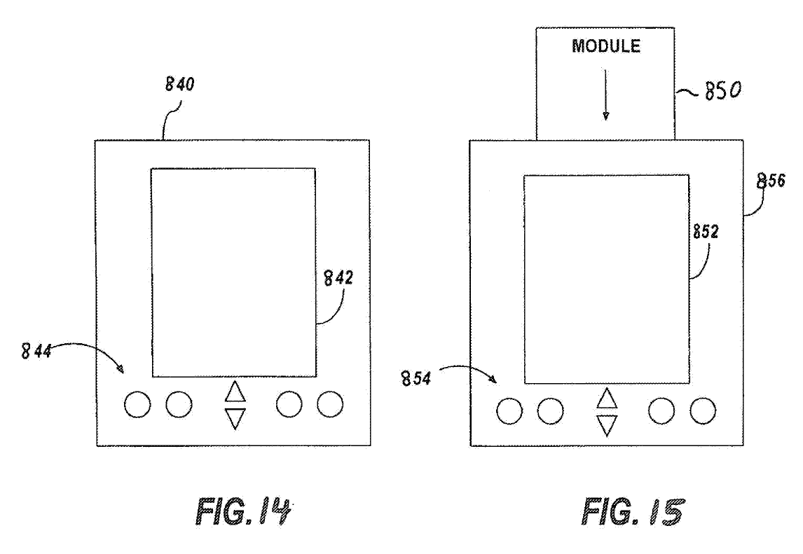

FIG. 13 illustrates a schematic diagram illustrating a general hardware configuration of an example wireless hand held device 811, which can be implemented in accordance another example embodiment. Those skilled in the art can appreciate, however, that other hardware configurations with less or more hardware and/or modules may be utilized in carrying out the methods and systems (e.g., hand held device 811) of the disclosed embodiments, as may be further described herein. Hand held device 811 is an alternative embodiment with respect to, for example, the example embodiment of mobile client device 210 discussed previously. As shown in the FIG. 13 example embodiment, a CPU (Central Processing Unit) 810 of the hand held device 811 can perform in some embodiments as a main controller operating under the control of operating clocks supplied from a clock oscillator. In some embodiments, the CPU 810 may be configured as an 800 MHz processor or a 1 GHz processor (e.g., referring to the speed of the CPU). In some example embodiments, the CPU 810 may be a multi-core processor in the context of a SoC (System-on-a-Chip) with other sub-processors onto single chipset of the SoC. External pins of CPU 810 are generally coupled to an internal bus 826 so that it may be interconnected to respective components.

The example hand held device 811 also includes semiconductor memory RAM (Random Access Memory) 824. An example of a RAM component, which can be utilized as RAM 824 is, for example, 5 GB/6 GB RAM. Other examples, which can be utilized as RAM 824 or in association with RAM 824, include SRAM (Static RAM) configured as a writeable memory that does not require a refresh operation and can be generally utilized as a working area of the CPU 810. Note that SRAM is generally a form of semiconductor memory based on a logic circuit known as a flip-flop, which retains information as long as there is enough power to run the device. Font ROM 22 can be configured as a read only memory for storing character images (e.g., font) displayable on a display 818. Examples of types of displays that may be utilized as display 818 include an active matrix display, an LCD (Liquid Crystal Display), or other small-scale displays. Examples of LCD displays include AMOLED (Active Matrix Organic LED) and standard smartphone or tablet computer LED.

CPU 810 can in some example embodiments drive the display 818 utilizing, among other media, font images from Font ROM (Read Only Memory) 822 and images transmitted as data through wireless unit 817 and processed by image-processing unit 835. In some example embodiments, EPROM 820 may be configured as a read only memory that is generally erasable under certain conditions and can be utilized for permanently storing control codes for operating respective hardware components and security data, such as a serial number.

In some example embodiments, an IR controller 814 can also be configured with the hand held device 811. The IR controller 814 can be generally configured as a dedicated controller for processing infrared codes transmitted/received by an IR transceiver 816 and for capturing the same as computer data. A wireless unit 817 can be generally configured as a dedicated controller and transceiver for processing wireless data transmitted from and to a wireless communications network such as, for example, a wireless network (e.g., WiFi, cellular, etc.) associated with system 501 depicted in FIG. 9, the wireless network 710 shown in FIG. 11, and so on.

A port 812 can be electrically connected to CPU 810 and can in some embodiments be temporarily attached, for example, to another electronic device or component to transmit information to and from hand held device 811 and/or to such other devices, such as personal computers, retail cash registers, electronic kiosk devices, and so forth. In some example embodiments, the port 812 can be, for example, a USB or micro-USB connection port, or another charging and data port, such as those found on smartphones and tablet computing devices. In some example embodiments, as indicated by dashed line 827 in FIG. 13, the port 812 may connect to the bus 826 instead of to the CPU 810.

User controls 832 can permit a user to enter data to hand held device 811 and initiate particular processing operations via CPU 810. A user interface 833 (e.g., a touch screen user interface) may be linked to user controls 832 to permit a user to access and manipulate the hand held device 811 for a particular purpose, such as, for example, viewing images on display 818. Those skilled in the art will appreciate that user interface 833 may be implemented as a touch screen user interface, as indicated by the dashed lines linking display 818 with user interface 833. In addition, CPU 810 may cause a sound generator 828 to generate sounds of particular or predetermined or other frequencies from a speaker 830. Speaker 830 may be utilized to produce music and other audio information associated with streaming video data transmitted to hand held device 811 from an outside source.

Those skilled in the art can appreciate that additional electronic circuits or the like other than, or in addition to, those illustrated in FIG. 13 may be utilized with the hand held device 811. Such components, however, are not described with respect to the example embodiment depicted in FIG. 13, because it can be appreciated that the hand held device 811 can be implemented as any number of possible wireless hand held devices such as, for example, smartphones (e.g., iPhone®, Android® phone, etc.), tablet computing devices (e.g., iPad®, Galaxy® Tablet, etc.), laptop computers, and so on.

In some example alternative embodiments, the hand held device 811 may be implemented with capabilities or features of a hand held television for receiving public digital television broadcasts, but the basic technology can be modified on such devices so that they may be adapted to (e.g., proper authentication, filters, passwords, security codes, biometric authentication, and the like) receive venue-based RF transmissions from at least one venue-based RF source (e.g., a wireless camera or data from a camera transmitted wirelessly through a transmitter). Those skilled in the art can thus appreciate that because of the brevity of the drawings described herein, only a portion of the connections between the illustrated hardware blocks is generally depicted. In addition, those skilled in the art will appreciate that hand held device 811 can be implemented as a specific type of a hand held device with capabilities of a Personal Digital Assistant (PDA), Smartphone paging device, Internet-enabled mobile phone, and other associated hand held computing devices.

Hand held device 811 (e.g., smartphone, tablet computing device, laptop computer, etc.) can be configured to permit images, such as streaming video broadcast images to be displayed on display 818 for a user to view. Hand held device 811 can be configured with, for example, an image-processing unit 835 (e.g., a GPU or Graphics Processing Unit) for processing images transmitted as streaming data (e.g., video streams) to hand held device 811 through wireless unit 817. The image processing unit 835 can be configured to perform video processing of, for example, video streams (including primary streams and/or sub-streams). Alternatively, such video image processing operations may take place at a server and then filtered or image processed video streamed from the server to the hand held device 811.

In some alternative example embodiments, a tuner unit 834 may be employed by the hand held device 811 as either a single tuner or a plurality of tuners, may be linked through internal bus 826 to CPU 810. Additionally, a security unit 836 may be utilized to process proper security codes (e.g., passwords, biometric data) to thereby ensure that data transferred to and from hand held device 811 may be secure and/or authorized. Security unit 836 may be implemented as an optional feature of hand held device 811. Security unit 836 can be configured with routines or subroutines that are processed by CPU 810, and which prevent wireless data from being transmitted/received from hand held device 811 beyond a particular frequency range, outside of a particular geographical area associated with a local wireless network, or absent authorized authorization codes (e.g., decryption) or other forms of device authorization, such as entry of a particular code or password, or entry by a user of biometric data via, for example, a biometric reader associated with the hand held device 811.

Hand held device 811 may thus be configured with wireless and/or wireline capabilities, depending on the needs and requirements of a manufacturer or customer. In most cases, hand held device 811 will simply be a wireless hand held device such as a smartphone, tablet computing device, or laptop computer. Such wireless capabilities can include features such as those found in smartphones, laptop computers, tablet computing devices, smartwatches, other wearable computing device, and so on. Hand held devices can be equipped with hardware and software modules necessary to practice various aspects of the disclosed embodiments. In some example embodiments, software modules may be downloaded via mobile “apps” from an online store, such as, for example, an online “app” store.

In some alternative embodiments, hand held devices may be provided with multi-RF (Radio Frequency) receiver-enabled hand held digital television viewing capabilities. Regardless of the type of hand held device implemented, such hand held devices can be adapted to receive and process data via image-processing unit 835 for ultimate display as moving images on display unit 818. Image-processing unit 835 can include image-processing routines, subroutines, software modules, and so forth, which perform image-processing operations. Note that in some embodiments, the venue-based data (e.g., streaming video and audio data) transmitted to the hand held device 811 may be subject to image-processing and other operations prior to transmission to the hand held device 811 to limit the amount of image-processing required by the image-processing unit 835.

FIG. 14 illustrates a pictorial representation of a hand held device 840, which may be utilized to implement an example embodiment. Those skilled in the art will appreciate that hand held device 840 of FIG. 14 is analogous to hand held device 811 of FIG. 13 and other hand held devices, such as, for example, the hand held device(s) 210 discussed previously herein. Hand held device 840 can be, for example, a hand held device such as a smartphone, a table computing device, a laptop computer, or wearable computing devices such as a smartwatch, wearable computing eyeglasses, and so on etc.

Hand held device 840 includes a display screen 842, which is generally analogous to, for example, the display 818 of FIG. 13 and the display 254 of client device 210 shown in FIG. 12. Streaming video data and/or other types of data (e.g., digital data) can be transmitted via a wireless network (examples of which were previously described herein) to the hand held device 840 for display on the display screen 842 for a user of the hand held device 840 to view. User controls 844 can permit a user to manipulate, for example, video, images, and/or text displayed on display screen 842. User controls 844 are generally analogous to user controls 832 shown FIG. 13. The display screen 842 is preferably configured as a touch screen interface and the user controls 844 can be implemented as graphically displayed user controls via such a touch screen interface and/or can be implemented as standalone control buttons (e.g., volume control, etc.). User controls graphically displayed via the touch screen user interface are preferably utilized to manipulate images/text displayed on display screen 842.

FIG. 15 depicts a pictorial representation of a hand held device 856 adapted for receiving a module 850, in accordance with an alternative example embodiment. Hand held device 856 of FIG. 15 is generally analogous to hand held device 840 of FIG. 14, the difference being that hand held device 856 may be adapted to receive a module/cartridge that permits hand held device 856 to function according to specific hardware and/or instructions contained in a memory location within module 850. In some alternative example embodiments, module 850 may be configured as a smart card. Such a smart card may provide, for example, access codes (e.g., encryption/decryption) to enable hand held device 856 to receive, for example, digital venue broadcasts of streaming digital data including streamed video, audio, and other streaming data. In yet other example embodiments, the module 850 may be a SIM (Subscriber Information Module) card, such as, for example, a full-size SIM, a mini-SIM, a micro-SIM, a nano-SIM, or in some cases, an embedded-SIM/Embedded Universal Integrated Circuit Card (eUICC). For security purposes, such a SIM card may include the use of AES (Advanced Encryption Standard) or Triple DES standards. An equivalent of SIM on CDMA networks is R-UIM (and an equivalent of USIM is CSIM).

Note that as utilized herein, the term “module” may refer to a physical module, such as a SIM card and/or other physical components that may be inserted into, for example, a smartphone, table computing device, smartwatch, etc. The term “module” may also refer to a software module composed of routines or subroutines that perform a particular function. Those skilled in the art can appreciate the meaning of the term module is based on the context in which the term is utilized. Thus, module 850 may be generally configured as a physical cartridge, smart card, SIM card, etc. The term “module” as utilized herein may also refer to a software module, depending on the context of the discussion thereof. In some cases, a physical hardware module may store a software module and together the device can also be referred to as a module.

In an example embodiment, module 850 when inserted into hand held device 856 may instruct hand held device 856 to function as a standard smartphone. Another module 850, when inserted into hand held device 856 may instruct hand held device 856 to function as a portable television that receives digital wireless television data from a local wireless network and/or venue-based (short range) broadcasts. Module 850 in yet other example embodiments can be configured to instruct the hand held device 856 to perform a particular functionality such as communicating via BLE with beacons incorporated into, for example, one or more of the previously discussed pods.

Those skilled in the art can thus appreciate that hand held device 856 can be adapted and/or instructed via, for example, a previously loaded “app” to receive and cooperate with module 850. Note that hand held device 856 includes a display screen 852 that is generally analogous to display screen 842 of FIG. 14, display 818 of FIG. 13, and display 254 shown in FIG. 12. Hand held device 856 can include user controls 854 that are generally analogous to user controls 844 of FIG. 14 and user controls 832 of FIG. 13. Hand held device 856 of FIG. 15 is, for example, generally analogous to the example hand held device 811 of FIG. 13 and the example client device 210 shown in FIG. 12. Thus, hand held device 856 can also implement touch screen capabilities through a touch screen user interface integrated with display screen 852.

In some example alternative embodiments, module 850 can be implemented as a micro smart card with an embedded computer chip. Such a micro smart card in some embodiments may be approximately the same size as a SIM card. The smart card chip can either be a microprocessor with internal memory or a memory chip with non-programmable logic. The chip connection can be configured via direct physical contact or remotely through other means, such as, for example, contactless electromagnetic interface. Such a smart card may be configured as either a contact or contactless smart card, or a combination thereof. A contact smart card in some instances may require insertion into a smart card reader (e.g., that is connected to the hand held device 856) with a direct connection to, for example, a conductive micromodule on the surface of the card. Such a micromodule may be generally gold plated. Transmission of commands, data, and card status takes place through such physical contact points.

A contactless card requires only close proximity to a reader. Both the reader and the card may be implemented with antenna means providing a contactless link that permits the devices to communicate with one another. Contactless cards can also maintain internal chip power or an electromagnetic signal (e.g., RF tagging technology). Two additional categories of smart codes, which are based on contact and contactless cards, are the so-called Combi cards and Hybrid cards. A Hybrid card generally may be equipped with two chips, each with a respective contact and contactless interface. The two chips may not be connected, but for many applications, this Hybrid serves the needs of consumers and card issuers. The Combi card may be generally based on a single chip and can be generally configured with both a contact and contactless interface.

Chips utilized in such smart cards are generally based on microprocessor chips or memory chips. Smart cards based on memory chips depend on the security of the card reader for their processing and can be utilized with low to medium security requirements. A microprocessor chip can add, delete, and otherwise manipulate information in its memory.

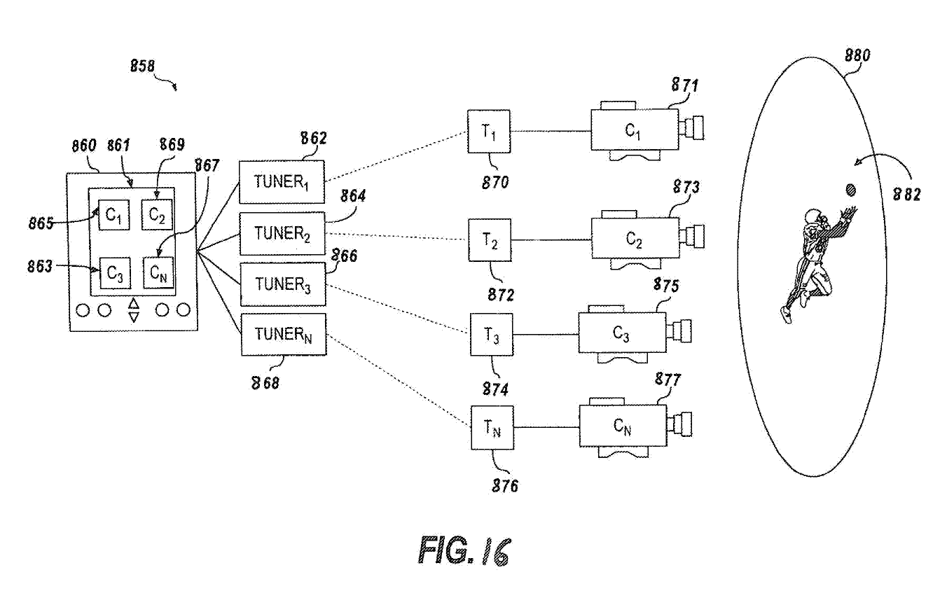

FIG. 16 illustrates a system 858 for providing multiple perspectives through a hand held device 860 of activities at a venue 880, in accordance with an alternative example embodiment. For illustrative purposes only, it may be assumed that venue 880 of FIG. 16 is a sports venue, such as a football stadium, baseball stadium, hockey stadium, soccer arena, basketball arena/stadium, a race track, and so on. It can be appreciated, of course, that venue 880 in non-sports contexts may be, for example, a concert arena, a convention center, a live performance theater, etc. A group of cameras 871, 873, 875, 877, etc., can be respectively positioned at strategic points about venue 880 to capture the best video of activity taking place within venue 880. Cameras 871, 873, 875, 877, etc., are respectively linked to transmitters 870, 872, 874, 876, etc. Each of these transmitters may be configured as equipment, which feeds a radio signal to an antenna for transmission.

In some embodiments, the cameras 871, 873, 875, 877, etc., can be positioned on, for example, the self-contained pod 100 discussed previously. For example, such cameras may be deployed as camera 150, 151 etc., discussed previously with respect to FIGS. 1A, 1B or, for example, camera 185 shown in FIG. 1C. In the case of unmanned aerial vehicles such as the unmanned aerial vehicle 180 shown in FIG. 1C, one or more of the cameras 871, 873, 875, 877 can be implemented on one or more unmanned aerial vehicles such as, for example, the camera 185 shown in FIG. 1C.

The antenna may be integrated with the transmitter. Each transmitter can include active components, such as a driver. Such transmitters may also include passive components, such as a TX filter. These components, when operating together, impress a signal onto a radio frequency carrier of the correct frequency by immediately adjusting its frequency, phase, or amplitude, thereby providing enough gain to the signal to project it to its intended target (e.g., a hand held device or a server).

In some example embodiments, a hand held device 860 may be held by a user at a stadium seat within view of the activity at the venue 880. Hand held device 860 is generally analogous to hand held device 811 of FIG. 13, hand held device 840 of FIG. 14, and client device 210 shown in FIG. 12 (assuming that client device 21 is implemented as a hand held device). Hand held device 860 depicted in FIG. 16 can be instructed via an “app” to receive and display venue-based data. Hand held device 860 includes a display screen 861 (e.g., a touch screen display). Display screen 861 may include a touch screen display area 865 that may be associated with, for example, camera 871. In the particular example embodiment shown in FIG. 16, video images captured by camera 871 can be transmitted from transmitter 870, which is linked to camera 871. Additionally, display screen 861 includes touch screen display areas 869, 863, and 867, which are respectively associated with cameras 873, 875, and 877.

As shown in the example embodiment of FIG. 16, cameras 871, 873, 875, and 877 are respectively labeled C₁, C₂, C₃, and C_{N} to indicate that a plurality of cameras may be utilized in accordance with system 858 to view activities taking place within venue 880, such as a football game, baseball game, or concert. Although only four cameras are illustrated in FIG. 16, those skilled in the art will appreciate that additional or fewer cameras may be also implemented in accordance with system 858. Touch screen display areas 865, 869, 863, and 867 are also respectively labeled C₁, C₂, C₃, and C_{N} to illustrate the association between these display areas and cameras 871, 873, 875, and 877.

In an example embodiment, hand held device 860 may be integrated with a plurality of tuners as illustrated by tuners 862, 864, 866, and 868. Such tuners can be activated via user controls (e.g., graphically displayed user controls via a touch screen user interface) on hand held device 860 and/or via touch screen icons or areas displayed on display screen 861 that are associated with each tuner. Such graphically displayed icons/areas may be respectively displayed within display areas 865, 869, 863, and 867, or within a separate display area of display screen 861. A user may access, for example, tuner 862 to retrieve real-time video images transmitted from transmitter 870 for camera 871. Likewise, a user can access tuner 864 to retrieve real-time video images transmitted from transmitter 872 from camera 873.

In addition, a user can access tuner 866 to retrieve real-time video images transmitted from transmitter 874 for camera 875. Finally, a user can access tuner 868 via the hand held device 860 to retrieve real-time video images transmitted from transmitter 876 for camera 877. In the example embodiment depicted in FIG. 16, a football player 882 is shown as participating in a football game within venue 880. Cameras 871, 873, 875, and 877 capture moving images (e.g., video data) of the football player 882 from various angles and transmit these images to hand held device 860.

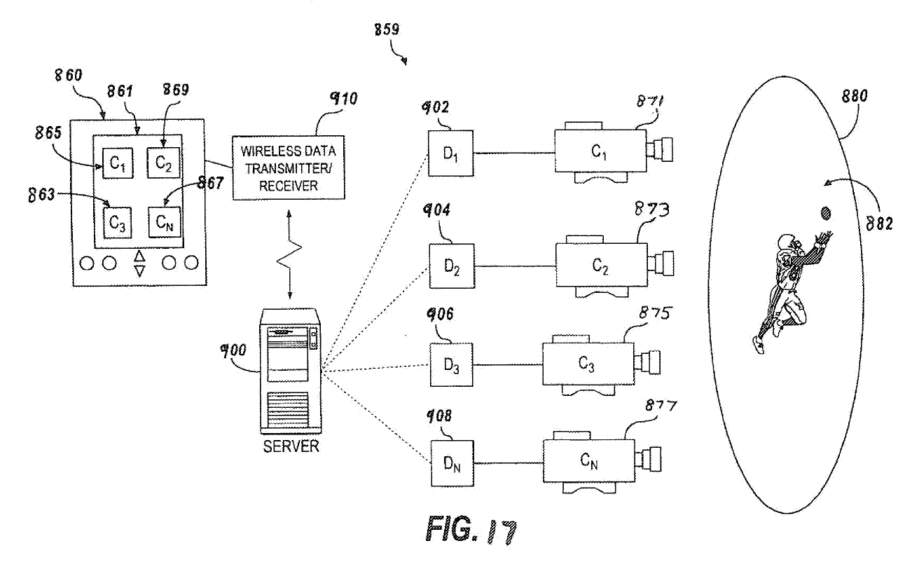

FIG. 17 depicts a system 859 for providing multiple perspectives of an activity (e.g., a sporting event) taking place at a venue 880 through a hand held device 860 configured and/or instructed to receive, process, and display real time video data, in accordance with an example embodiment. Note that in FIG. 16 and FIG. 17, analogous parts are indicated by identical reference numerals. Thus, for example, cameras 871, 873, 875, and 877 of FIG. 17 are analogous to cameras 871, 873, 875, and 877 depicted in FIG. 16. Hand held device 860 of FIG. 17 is also analogous to hand held device 860 of FIG. 16 and can include similar features. As indicated previously, in some example embodiments, the cameras 871, 873, 875, and 877 can be implemented as, for example, the cameras 150, 151 and/or camera 185 discussed herein.

The system 859 shown in FIG. 17 includes a server 900 that can communicate wirelessly with hand held device 860 via a wireless data transmitter/receiver 910. Server 900 is analogous to, for example, servers such as the servers 706, 707, 708, and 709 shown in FIG. 11 and the servers 530, 560 shown in FIG. 9. Hand held device 860 illustrated in FIG. 17 can be configured or instructed to receive wireless real time video data transmitted from cameras 871, 873, 875, and 877, respectively, through data transmitters 902, 904, 906, and 908 to the server 900 and thereafter to receive such real time video data wireless data transmitter/receiver 910. Note that in some example embodiments, the wireless data transmitter/receiver 910 may be to the wireless unit 817 shown in FIG. 13. The hand held device 860 of FIG. 17 is analogous to the hand held device 811 of FIG. 13 and the client device 210 of FIG. 12. The server 900 can function in some example embodiments as a primary server or as a synchronized data server such as server 115.

Hand held device 860 depicted in FIG. 17 can incorporate a touch screen user interface, as described previously herein. A difference between system 858 of FIG. 16 and system 859 of FIG. 17 lies in the inclusion of digital transmitters 902, 904, 906, and 908, which are respectively linked to cameras 871, 873, 875, and 877 of FIG. 17. In the example illustration of FIG. 17, cameras 871, 873, 875, and 877 may be configured as high definition video cameras which capture real time images of events or activities taking place within venue 880, such as real time video footage of football player 882.

Captured video of football player 882 can be transferred from one or more of video cameras 871, 873, 875, and 877 of FIG. 17 and transmitted through a respective digital transmitter, such as digital transmitter 902, 904, 906, or 908 and transmitted via wired and/or wireless communications to server 900. In some embodiments, the server 900 can process the video data received from one or more of the digital transmitters and format such video data (and audio data) for transmission via wireless means to wireless data transmitter/receiver 910, which may be integrated with hand held device 860. Transmitter/receiver 910 can communicate with various components of hand held device 860, such as a CPU, image-processing unit, memory units, and so forth.

Although real time video data may be transmitted to server 900, captured past digital video (e.g., instant replay, GIFs, etc.) may also be stored within server 900 and transferred to hand held device 860 for display via display screen 861. For example, instant replays may be transferred as video data to hand held device 860 upon the request of a user of hand held device 860. Such instant replay footage can be displayed on display screen 861 for the user to view.

FIG. 18 illustrates a system 879 for providing multiple perspectives of activity at venue 880 through hand held device 860 configured or instructed to receive and process real time video data from at least one wide-angle and/or panoramic video camera 914, in accordance with a preferred embodiment. In system 879 of FIG. 18, the wide-angle/panoramic (hereinafter referred to as “panoramic”) video camera 914 is preferably configured as a high-definition panoramic video camera that captures images of activities taking place at venue 880. In the example illustrated in FIG. 18, panoramic video camera 914 can capture images of a football game taking place in venue 880 and one or more football players, such as football player 882. Note that in some example embodiments, camera 914 can be a camera such as, for example, one or more of the cameras 150, 151 and/or the camera 185 with respect to one or more self-contained pods such as, for example, pod 100 and so on.

A data transmitter 912 may be linked to and communicate electronically with the panoramic video camera 914. Video data captured by panoramic video camera 914 may be transferred to data transmitter 912, which thereafter transmits the video data to server 900 via a direct link or a wireless link, depending on the needs or requirements of the promoters or venue owners. Note that such a wireless link may take place via wireless communications (e.g., WiFi, cellular etc.) facilitated by a wireless network such as, for example, the wireless network 550 shown in FIG. 9 or the wireless 710 shown in FIG. 11.

Note that this is also true of the system 859 described herein with respect to FIG. 17. In case of the example embodiment shown in FIG. 17, video data may be transmitted from one or more of data transmitters 902, 904, 906, and 908 via a direct wire/cable link or through wireless transmission means, such as through a wireless network such as the wireless network 550 shown in FIG. 9 or the wireless 710 shown in FIG. 11.

Those skilled in the art will appreciate, of course, that hand held device 860 of FIG. 18 is analogous to the other hand held devices described herein. In FIGS. 16, 17, and 18, for example, like or analogous parts are identified by identical reference numerals. Thus, video captured by panoramic video camera 914 of activity taking place at venue 880 may be displayed as real time video images or instant replay data on display screen 861 of hand held device 860.

FIG. 19 depicts a system 889 for providing multiple perspectives for activity at a venue 920 at a first time and/or perspective (Time 1) and a second time and/or perspective (Time 2), in accordance with an example embodiment. In FIGS. 16, 17, 18, and 19, like or analogous parts are indicated by identical reference numerals. Thus, in system 889 of FIG. 19, an event, in this case illustrated as a hockey game, is taking place within venue 920. Venue 920 may be, for example, a hockey arena. Panoramic video camera 914 may be linked to data transmitter 912. Note that in some example embodiments, camera 914 can be a camera such as, for example, one or more of the cameras 150, 151 and/or the camera 185 with respect to one or more self-contained pods such as, for example, pod 100 and so on. That is, camera 914 can be implemented in the context of a self-contained pod such as pod 100 and may be mounted on, for example, the telescoping mast 120 discussed previously. Note that although only a single camera 914 is shown in the figures, it can be appreciated that multiple such cameras can be deployed in a venue.

As explained previously, data transmitter 912 may be linked to server 900 via a direct link, such as a transmission cable or line, or through wireless communication means, such as through a wireless network as already discussed. Server 900 can also communicate with hand held device 860 through a wireless network or other wireless communication means by transmitting data through such a network or wireless communications means to wireless data transmitter/receiver 910. Wireless data transmitter/receiver 910, as explained previously, may be integrated with hand held device 860. Note that in some alternative example embodiments, the wireless data transmitter/receiver 910 may actually be composed of one or more wireless data transmitter/receivers some of which may be integrated with the hand held device 860 and others which may be located separate from the hand held device 860.

Thus, as depicted in FIG. 19, video 924 of a hockey player 922 can be captured as video data by panoramic video camera 914, along with video 926 of a hockey player 923 and graphically displayed within display screen 861 (e.g., a touch screen display) of hand held device 860 as indicated at Time 1. Video 924 and 926 can be displayed within a grid-like interface on display screen 861. Note that in the illustration of FIG. 19, display screen 861 may be divided into four sections. It can be appreciated that fewer more much such sections may be displayed via display screen 861.

When a user touches, for example, the area or section of display screen 861 in which video 924 is displayed, the entire display area of display screen 861 can then be consumed with a close-up video shot of video 924, as indicated at Time 2, thereby providing the user with a closer view of hockey player 922. Those skilled in the art can appreciate that the touch screen display area of display screen 861 can be arranged with graphical icons and/or user-controls that perform specific pan and zoom functions. Such icons/user-controls, when activated by a user, permit the user to retrieve panned/zoomed images of events taking place in real time within venue 920.

Note that although only one panoramic video camera 914 and one data transmitter 912 are illustrated in FIG. 19, a plurality of panoramic video cameras, servers, and data transmitters may be implemented in accordance with the present invention to capture the best video images, image-processing, and signal capacity to users, whether real time or otherwise, of events taking place at venue 920.

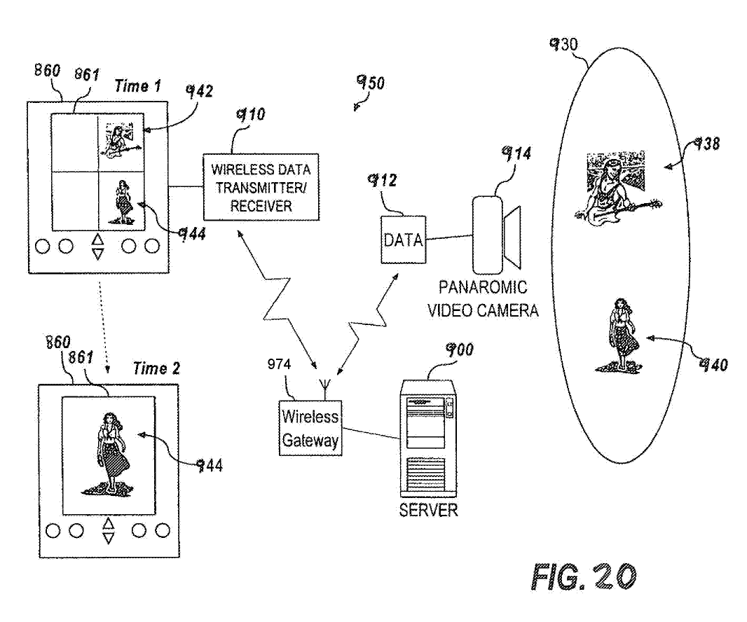

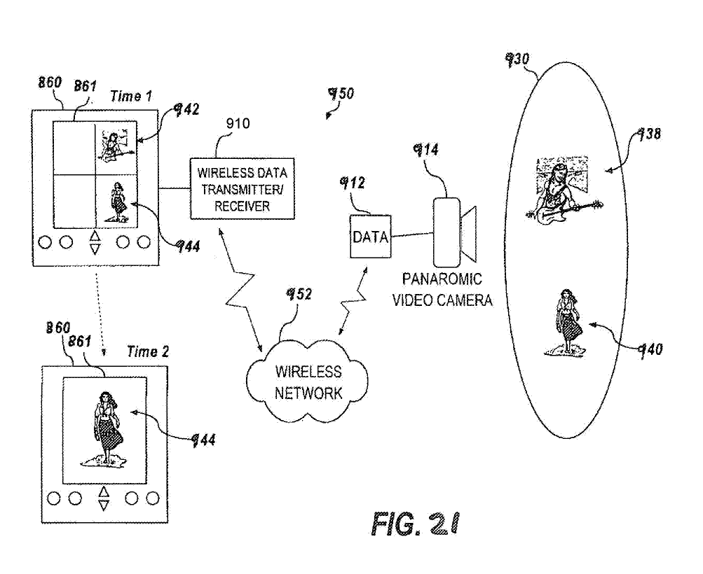

FIG. 20 illustrates a system 950 for providing multiple perspectives through hand held device 860 of an activity at a venue 930, including the use of a wireless gateway 974, in accordance with an example embodiment. Those skilled in the art can appreciate that wireless gateway 974 may be configured as an access point for a wireless LAN (Local Area Network) also referred to as a WLAN and/or as a gateway to a cellular network. For example, in some embodiments, the wireless gateway 974 may be implemented as a cellular router for a cellular network. Access points for wireless LAN networks and associated wired and wireless hardware (e.g., servers, routers, gateways, etc.) can be utilized in accordance with varying example embodiments. In some example embodiments, a wireless gateway such as wireless gateway 974 can communicate wirelessly with, for example, the wireless data communications components/electronics 110 of the self-contained pod 100.

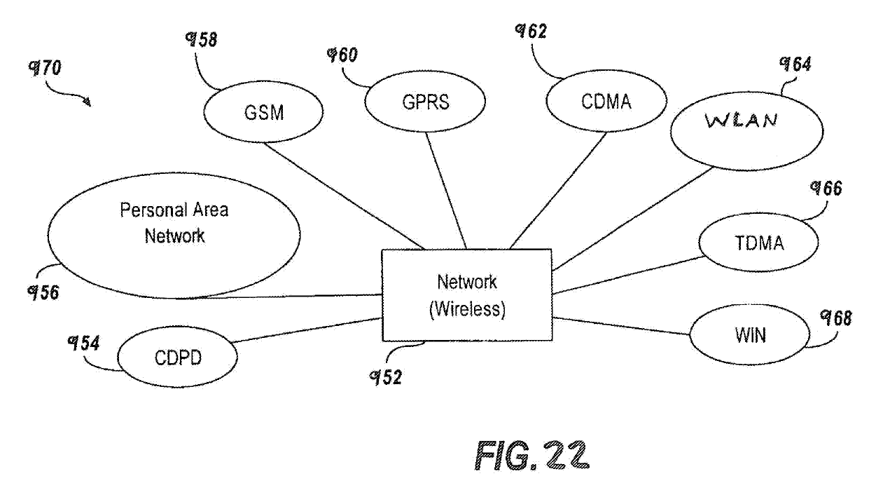

The wireless gateway 974 can be configured to route packets from, for example, a wireless LAN as wireless LAN 964 shown in FIG. 22 to another network, wired or wireless LAN. Wireless gateway 974 can be implemented as software or hardware or a combination of both. Wireless gateway 974 can be configured to combine the functions of a wireless access point, a router, and also provide firewall functionalities. Wireless gateway 974 can also be configured to provide network address translation (NAT) functionalities, so that multiple client devices such as hand held device 860 and so on can use the Internet with single public IP. Wireless gateway 974 can also be configured to function like a DHCP (Dynamic Host Configuration Protocol) to assign IPs automatically to devices connected to the network 952. Wireless gateway 974 can also be configured to protect the wireless network 952 using securing encryption methods, such as, for example, WEP, WPA, WPA2, and WPS.

Note that in FIGS. 16, 17, 18, 19, and 20, like or analogous parts are generally indicated by identical reference numerals. System 950 of FIG. 20 is analogous to system 889 of FIG. 19, the difference being in the nature of the venue activity. That is, a concert event is shown taking place in FIG. 20 rather than a sporting event. Venue 930 can be, for example, a concert hall or stadium configured with a sound stage.

Gateway 974 can be configured as a communications gateway through which data may enter or exit a communications network, such as wireless network 952 illustrated in FIG. 21 for a large capacity of hand held device users. Wireless network 952 may be configured as, for example, a WLAN and/or a cellular telephone communications network. Hand held device 860 can be configured to communicate and receive transmissions from such a wireless network based on device identification (e.g., device address). Communication with hand held devices, such as hand held device 860, however, may also be achieved in some particular example embodiments through RF (Radio Frequency) broadcasts, thereby not requiring two-way communication and authentication between, for example, a WLAN and such hand held devices. A broadcast under such a scenario may also require that such a hand held device or hand held devices possess encryption/decryption capabilities or the like in order to be authorized to receive and authorize transmissions from the venue

The remaining elements of FIG. 20 are also analogous to the elements depicted in the previous drawings, with the addition of wireless gateway 974, which may communicate with server 900 and may be in communication with multiple wireless data transmitters/receivers 910 and one or more electronic hand held devices, including hand held device 860. Wireless data transmitter/receiver 910, as explained previously, may be integrated with hand held device 860. One or more panoramic video cameras, such as panoramic video camera 914, can be positioned at a venue 930 at locations that capture images not only of the events taking place on a concert stage, but also events taking place within the stadium itself. As indicated previously, the server 900 can function in some example embodiments as a primary server or as a synchronized data server such as server 115 in the self-contained pod 100.

If an audience member 940, for example, happens to be walking along a stadium aisle within view of panoramic video camera 914, the audience member's video image can be displayed as video image 944 within display screen 861 of hand held device 860, as indicated at Time 1. Likewise, panoramic video camera 914 captures images of band member 938 whose video image can be displayed as video image 942 within a display area of display screen 861, as indicated at Time 1.

Thus, a user of hand held device 860 can view not only the events taking place on a central performing platform of venue 930, but also other events within the arena itself. The band member 938 may be located on a central performing platform (not shown) of venue 930 when panoramic video camera 914 captures real-time video images of band member 938. The user may also, for example, wish to see a close-up of audience member 940. By activating user controls and/or a touch screen interface integrated with display screen 861, the user can, for example, pan or zoom to view a close-up video shot of audience member 940, as indicated at Time 2.

Captured video are transferred from panoramic video camera 914 as video data through transmitter 912 to server 900 and through wireless gateway 974 to wireless data transmitter/receiver 910. Although a single server 900 is illustrated in FIG. 20, those skilled in the art can appreciate that a plurality of such servers may be implemented in accordance with an example embodiment to process captured and transmitted video data. Video data may also be simultaneously transferred from server 900 or a plurality of such servers to literally thousands of hand held devices located within the range of the wireless network and/or wireless gateways associated with venue 930. Thus, for example, hand held device 860 may be located away from the venue 930, such as at a user's home or car, and the user may be able to view the event taking place at the venue 930, which may be located hundreds if not thousands of miles away from the user's home or car.

FIG. 21 illustrates a system 950 for providing multiple perspectives through hand held device 860 of an activity at a venue 930 in association with the wireless network 952, in accordance with an example embodiment. System 950 shown in FIG. 21 is analogous to system 950 of FIG. 20, the difference noted in the inclusion of the wireless network 952. Thus, in FIG. 20 and FIG. 21, like or analogous parts are indicated by identical reference numerals. Video data captured by a camera or cameras, such as panoramic video camera 914, may be transferred to data transmitter 912, which transmits the video data to wireless network 952. Wireless network 952 then retransmits the data, at the request of authorized users of hand held devices, such as hand held device 860, to wireless data transmitters/receivers, such as transmitter/receiver 910 integrated with hand held device 860. The wireless network 952 is preferably a bidirectional packet based data network.

Wireless network 952 may also receive and retransmit other data, in addition to video data. For example, a server or other computer system may be integrated with wireless network 952 to provide team and venue data, which can then be transferred to wireless data transmitter/receiver 910 from wireless network 952 and displayed thereafter as team and venue information within display screen 861 of hand held device 860. Other data that may be transferred to hand held device for display include real-time and historical statistics, purchasing, merchandise and concession information, and additional product or service advertisements.

Such data can include, for example, data such as box scores, player matchups, animated playbooks, shot/hit/pitch charts, player tracking data, historical information, and offense-defense statistics. In a concert venue, for example, as opposed to a sporting event, information pertaining to a particular musical group can be also transferred to the hand held device, along with advertising or sponsor information. Note that both the video data and other data described above generally comprise types of venue-based data. Venue-based data, as referred to herein, may include data and information, such as video, audio, advertisements, promotional information, propaganda, historical information, statistics, event scheduling, and so forth, associated with a particular venue and generally not retrievable through public networks. Such venue-based data can include streaming video and/or audio data.

Such information can be transmitted together with video data received from data transmitter 912. Such information may be displayed as streaming data (e.g., streaming video, streaming audio, etc.) within display area 861 of hand held device 860 or simply stored in a database accessible by the hand held device 860 for later retrieval by the user.

The system 950 shown in FIG. 21 can display a particular video perspective of a venue-based activity at the hand held device 860. In system 950, one or more receivers such as the receiver 910 at the hand held device 860 can simultaneously receive from the bidirectional wireless network 952 a plurality of high definition streaming video perspectives of the venue-based activity simultaneously transmitted from more than one venue-based data source (e.g., such as video camera 914, cameras 150, 151 associated with pod 100, etc.) located at the venue 930. In some example embodiments, the bidirectional wireless network 930 may be, for example, a wireless LAN and/or a cellular communications network. A processor associated with a server (e.g., such as server 900, the synchronized server 115, etc.) or a process associated with the hand held device 860 such as, for example, processor 810 shown in FIG. 13 or processor 222 shown in FIG. 12 can process the plurality of perspectives for display on a display screen (e.g., display 254, display 861) associated with said hand held device. The display screen displays a particular video perspective on said display screen in response to a user selection of said particular video perspective from among said plurality of video perspectives.

Data transmitted from wireless network 952 to hand held devices such as the hand held device 860 can include streaming media. Such streaming media is multimedia that is constantly received by and presented to an end-user such as hand held device 860 while being delivered by a provider. Thus, “to stream” can refer to the process of delivering media in this manner to hand held device 860. The term “streaming” or “to stream” can also refer to the delivery method of the medium rather than the medium itself and is an alternative to downloading.

A client media player can begin to play the data (such as a video of the event at the venue 930) before the entire file has been transmitted. The term “streaming media” can apply to media other than video and audio such as live closed captioning, ticker tape, and real-time text, which are all considered “streaming text.” Such streaming media can include live streaming, which refers to content delivered live over the Internet, and in some example embodiments requires a form of source media (e.g., a video camera, an audio interface, screen capture software), an encoder to digitize the content, a media publisher, and a content delivery network to distribute and deliver the content. In the example shown in FIG. 21, wireless network 952 can distribute and deliver the media content wirelessly to hand held devices such as hand held device 860 (e.g., a smartphone, a laptop computer, a tablet computing device, a smartwatch, etc.).

FIG. 22 illustrates an entity diagram 970 depicting network attributes of wireless network 952 that may be utilized in accordance with one or more example embodiments. That is, an example of a wireless network that may be utilized to implement wireless network 952 is a WLAN, a cellular network, WiFi, 802.11xx wireless network, and so on. The entity diagram 970 indicates that wireless network 952 can be implemented as any number of different types of wireless networks including cellular (e.g., GSM, GPRS, CDMA, TDMA, etc.), WLAN (e.g., WiFi, 802.11xx, etc.), and other types (e.g., Personal Area Network, etc.).

Wireless network 952 of FIG. 22 is analogous to wireless network 952 of FIG. 21. Wireless network 952 as illustrated in FIG. 21 can be configured as a variety of possible wireless networks. Thus, entity diagram 970 illustrates attributes of wireless network 952, which may or may not be exclusive of one another.

Those skilled in the art can appreciate that a variety of possible wireless communications and networking configurations may be utilized to implement wireless network 952. Wireless network 952 may be, for example, implemented according to a variety of wireless protocols, including WLAN, WiFi, 802.11xx, cellular, Bluetooth, and RF or direct IR communications. Wireless network 952 can be implemented as a single network type (e.g., WLAN) or a network based on a combination of different network types (e.g., GSM, CDMA, etc.). That is, the hand held devices discussed herein can communicate with different types of wireless networks (e.g., cellular, WiFi, 802.11xx, etc.).

In one example embodiment, wireless network 952 may be configured with teachings/aspects of CDPD (Cellular Digital Packet Data) networks. CDPD network 954 is shown in FIG. 22. CDPD may be configured as a TCP/IP based technology that supports Point-to-Point (PPP) or Serial Line Internet Protocol (SLIP) wireless connections to mobile devices, such as the hand held devices described and illustrated herein. Cellular service is generally available throughout the world from major service providers. Data can be transferred utilizing CDPD protocols.

Current restrictions of CDPD are not meant to limit the range or implementation of the method and system described herein, but are described herein for illustrative purposes only. It is anticipated that CDPD will be continually developed, and that such new developments can be implemented in accordance with some example embodiments.

Wireless network 952 may also be configured with teachings/aspects of a wireless personal area network (WPAN) 956. WPAN 956 is a computer network that can be utilized for data transmission among devices such as computers, telephones, personal digital assistants, etc. WPANs can be used for communication among the personal devices themselves (intrapersonal communication) or for connecting to a higher level network and the Internet (e.g., an uplink). WPAN (Wireless Personal Area Network) is a PAN carried over wireless network technologies, such as, for example, INSTEON, IrDa, Wireless USB, Bluetooth®, Z-Wave®, ZigBee®, and a Body Area Network.

WPAN 956 in some example embodiments may be based on, for example, a wireless standard such as IEEE 802.15. Two types of wireless technologies that can be used for WPAN 956 are Bluetooth® and Infrared Data Association. WPAN 956 can serve to interconnect ordinary computing and communicating devices that many people have on their desk or carry with them such as smartphones, tablet computing devices, etc., or it can serve a more specialized purpose such as allowing audience members at a venue or, for example, athletic team members to communicate during an activity at a venue.

A key concept in WPAN technology is known as “plugging in.” In the ideal scenario, when any two WPAN-equipped devices come into close proximity (within several meters of each other) or within a few kilometers of a central server, they can communicate as if connected by a cable. Another important feature is the ability of each device to lock out other devices selectively, preventing needless interference or unauthorized access to information

Potential operating frequencies are around 2.4 GHz in digital modes. The objective is to facilitate seamless operation among home or business devices and systems. Every device in a WPAN will be able to plug into any other device in the same WPAN, provided they are within physical range of one another. In addition, WPANs worldwide will be interconnected. Thus, for example, coaching staff of a sports team on site at a venue might use a PDA or other hand held device to directly access databases at team headquarters located elsewhere (e.g., in another State), and to transmit information to that database.

In a Bluetooth® implementation of the WPAN 956, short-range radio waves are used over distances up to approximately 10 meters. For example, Bluetooth devices such as a keyboard, pointing devices, audio headsets, printers may connect to PDA's, cell phones, or computers wirelessly. A Bluetooth PAN is also called a piconet (combination of the prefix “pico,” meaning very small or one trillionth, and network), and is composed of up to 8 active devices in a master-slave relationship (a very large number of devices can be connected in “parked” mode). The first Bluetooth device in the piconet is the master, and all other devices are slaves that communicate with the master. A piconet typically has a range of 10 meters (33 ft.), although ranges of up to, for example, 100 meters (330 ft.) can be reached under ideal circumstances. Infrared Data Association (IrDA) uses infrared light, which has a frequency below the human eye's sensitivity. Infrared in general is used, for instance, in TV remotes. Typical WPAN devices that use IrDA include printers, keyboards, and other serial data interfaces. WPAN 956 thus may in some example embodiments be implemented via IrDA.

In some example embodiments, wireless network 952 may also be configured utilizing teachings/aspects of a particular cellular network such as a GSM network 158. GSM (Global System for Mobile communication) is a digital mobile telephony system that is widely used in Europe and other parts of the world. GSM uses a variation of time division multiple access (TDMA) and is the most widely used of the three digital wireless telephony technologies (TDMA, GSM, and CDMA). GSM digitizes and compresses data, then sends it down a channel with two other streams of user data, each in its own time slot. It operates at either, for example, the 900 MHz or 1800 MHz frequency band.

GSM and PCS (Personal Communications Systems) networks generally operate in the 800 MHz, 900 MHz, and 1900 MHz range. PCS initiates narrowband digital communications in the 900 MHz range for paging, and broadband digital communications in the 1900 MHz band for cellular telephone service. In the United States, PCS 1900 is generally equivalent to GSM 1900. GSM operates in the 900 MHz, 1800-1900 MHz frequency bands, while GSM 1800 is widely utilized throughout Europe and many other parts of the world.

In the United States, GSM 1900 is generally equivalent to PCS 1900, thereby enabling the compatibility of these two types of networks. Current restrictions of GSM and PCS are not meant to limit the range or implementation of the present invention, but are described herein for illustrative purposes only. It is anticipated that GSM and PCS will be continually developed, and that aspects of such new developments can be implemented in accordance with example embodiments.

In some example embodiments, wireless network 952 may also utilize teachings/aspects of GPRS network 960. GPRS technology bridges the gap between current wireless technologies and the so-called “next generation” of wireless technologies referred to frequently as the third-generation or 3G wireless technologies. GPRS is generally implemented as a packet-data transmission network that can provide data transfer rates up to 115 Kbps. GPRS can be implemented with CDMA and TDMA technology and can support X.25 and IP communications protocols. GPRS also enables features, such as Voice over IP (VoIP) and multimedia services. Current restrictions of GPRS are not meant to limit the range or implementation of the disclosed embodiments, but are described herein for illustrative purposes only. It is anticipated that GPRS will be continually developed and that such new developments can be implemented in accordance with alternative embodiments.

Wireless network 952 may also be implemented utilizing teaching/aspects of a CDMA network 962 or CDMA networks. CDMA (Code Division Multiple Access) is a protocol standard based on IS-95 CDMA, also referred to frequently in the telecommunications arts as CDMA-1. IS-95 CDMA is generally configured as a digital wireless network that defines how a single channel can be segmented into multiple channels utilizing a pseudo-random signal (or code) to identify information associated with each user. Because CDMA networks spread each call over more than 4.4 trillion channels across the entire frequency band, it is much more immune to interference than most other wireless networks and generally can support more users per channel.

Wireless network 952 may also be configured with a form of CDMA technology known as wideband CDMA (W-CDMA). Wideband CDMA may be also referred to as CDMA 2000 in North America. W-CDMA can be utilized to increase transfer rates utilizing multiple 1.25 MHz cellular channels. Current restrictions of CDMA and W-CDMA are not meant to limit the range or implementation of the disclosed embodiments, but are described herein for illustrative purposes only. It is anticipated that CDMA and W-CDMA will be continually developed and that such new developments can be implemented in accordance with alternative embodiments.

CDMA network 962 can in some embodiments be implemented via a collaborative multi-user transmission and detection scheme referred to as Collaborative CDMA which has been investigated for the uplink that exploits the differences between users' fading channel signatures to increase the user capacity well beyond the spreading length in multiple access interference (MAI) limited environment. It is possible to achieve this increase at a low complexity and high bit error rate performance in flat fading channels, which is a major research challenge for overloaded CDMA systems. In this approach, instead of using one sequence per user as in conventional CDMA, a small number of users are grouped to share the same spreading sequence and enable group spreading and despreading operations. A collaborative multi-user receiver can be composed of two stages: group multi-user detection (MUD) stage to suppress the MAI between the groups and a low complexity maximum-likelihood detection stage to recover jointly the co-spread users' data using minimum Euclidean distance measure and users' channel gain coefficients. In CDMA, signal security is high.

Wireless network 952 may be also implemented utilizing teachings/aspects of a WLAN 964, which is a wireless computer network that links two or more devices using a wireless distribution method (often spread-spectrum or OFDM radio) within a limited area such as a home, school, venue, office building, etc. This gives users the ability to move around within a local coverage area and still be connected to the network 952, and can provide a connection to the wider Internet. Most modern WLANs are based on IEEE 802.11 standards marketed under the WiFi or Wi-Fi brand name.

The IEEE 802.11 WLAN has two basic modes of operation: infrastructure and ad hoc mode. In ad hoc mode, mobile units transmit directly peer-to-peer. In infrastructure mode, mobile units communicate through an access point that serves as a bridge to other networks (such as the Internet or another LAN (Local Area Network)). Since wireless communication uses a more open medium for communication in comparison to wired LANs, the 802.11 designers also included encryption mechanisms: Wired Equivalent Privacy (WEP, now insecure), Wi-Fi Protected Access (WPA, WPA2), to secure wireless computer networks. Many access points can also offer Wi-Fi Protected Setup, a quick (but now insecure) method of joining a new device to an encrypted network.

Most Wi-Fi networks are deployed in infrastructure mode. In infrastructure mode, a base station acts as a wireless access point hub, and nodes communicate through the hub. The hub usually, but not always, has a wired or fiber network connection, and may have permanent wireless connections to other nodes. Wireless access points can be fixed and provide service to their client nodes within range. Wireless clients, such as laptops, smartphones, tablet computing devices, etc., can connect to the access point to join the network. Sometimes a network will have multiple access points with the same ‘SSID’ and security arrangement. In that case, connecting to any access point on that network joins the client to the network. In that case, the client software will try to choose the access point to try to give the best service, such as the access point with the strongest signal.

An ad hoc network (not the same as a WiFi Direct network) is a network where stations communicate only peer to peer (P2P). There is no base and no one gives permission to talk. This can be accomplished using the Independent Basic Service Set (IBSS). A WiFi Direct network is another type of WLAN where stations communicate peer to peer.

In a Wi-Fi P2P group, the group owner operates as an access point and all other devices are clients. There are two main methods to establish a group owner in the Wi-Fi Direct group. In one approach, the user sets up a P2P group owner manually. This method is also known as Autonomous Group Owner (autonomous GO). In the second method, also called negotiation-based group creation, two devices compete based on the group owner intent value. The device with higher intent value becomes a group owner and the second device becomes a client. Group owner intent value can depend on whether the wireless device performs a cross-connection between an infrastructure WLAN service and a P2P group, remaining power in the wireless device, whether the wireless device is already a group owner in another group and/or a received signal strength of the first wireless device.

A peer-to-peer network allows wireless devices to directly communicate with each other. Wireless devices within range of each other can discover and communicate directly without involving central access points. This method is typically used by two computers so that they can connect to each other to form a network. This can basically occur in devices within a closed range. If a signal strength meter is used in this situation, it may not read the strength accurately and can be misleading, because it registers the strength of the strongest signal, which may be the closest computer.

In some example embodiments, wireless network 952 may also be configured utilizing teachings/aspects of a TDMA network 966. TDMA (Time Division Multiple Access) is a telecommunications network utilized to separate multiple conversation transmissions over a finite frequency allocation of through-the-air bandwidth. TDMA can be utilized in accordance with the present invention to allocate a discrete amount of frequency bandwidth to each user in a TDMA network to permit many simultaneous conversations or transmission of data. Each user may be assigned a specific timeslot for transmission. A digital cellular communications system that utilizes TDMA typically assigns 10 timeslots for each frequency channel.

A hand held device operating in association with a TDMA network sends bursts or packets of information during each timeslot. Such packets of information are then reassembled by the receiving equipment into the original voice or data/information components. Current restrictions of such TDMA networks are not meant to limit the range or implementation of the present invention, but are described herein for illustrative purposes only. It is anticipated that TDMA networks will be continually developed and that such new developments can be implemented in accordance with the present invention.

Wireless network 952 may also be configured utilizing teachings/aspects of a Wireless Intelligent Networks (WIN) 968. WINs (Wireless Intelligent Networks) are the architecture of the wireless switched network that allows carriers to provide enhanced and customized services for mobile telephones. Intelligent wireless networks generally include the use of mobile switching centers (MSCs) having access to network servers and databases such as Home Location Registers (HLRs) and Visiting Location Registers (VLRs) for providing applications and data to networks, service providers, and service subscribers (wireless device users).

Local number portability allows wireless subscribers to make and receive calls anywhere—regardless of their local calling area. Roaming subscribers are also able to receive more services, such as call waiting, three-way calling, and call forwarding. An HLR is generally a database that contains semi-permanent mobile subscriber (wireless device user) information for wireless carriers' entire subscriber base.

A useful aspect of WINs is enabling the maintenance and use of customer profiles within an HLR/VLR-type database. Profile information may be utilized, for example, with season ticket holders and/or fans of traveling teams or shows. HLR subscriber information as used in WINs includes identity, service subscription information, location information (the identity of the currently serving VLR to enable routing of communications), service restrictions, and supplementary services/information. HLRs handle SS7 transactions in cooperation with Mobile Switching Centers and VLR nodes, which request information from the HLR or update the information contained within the HLR. The HLR also initiates transactions with VLRs to complete incoming calls and update subscriber data. Traditional wireless network design is generally based on the utilization of a single HLR for each wireless network, but growth considerations are prompting carriers to consider multiple HLR topologies.

The VLR may also be configured as a database that contains temporary information concerning the mobile subscribers currently located in a given MSC serving area, but whose HLR may be elsewhere. When a mobile subscriber roams away from the HLR location into a remote location, SS7 messages are used to obtain information about the subscriber from the HLR, and to create a temporary record for the subscriber in the VLR.

Signaling System No. 7 (referred to as SS7 or C7) is a global standard for telecommunications. In the past, the SS7 standard has defined the procedures and protocol by which network elements in the public switched telephone network (PSTN) exchange information over a digital signaling network to affect wireless and wireline call setup, routing, control, services, enhanced features, and secure communications. Such systems and standards may be utilized to implement wireless network 952 in support of venue customers, in accordance with some example embodiments.

Improved operating systems and protocols allow Graphical User Interfaces (GUIs) to provide an environment that displays user options (e.g., graphical symbols, icons or photographs) on a wireless device's screen. Extensible Markup Language (“XML”) is generally a currently available standard that performs as a universal language for data, making documents more interchangeable. XML allows information to be used in a variety of formats for different devices, including PCs, smartphones, tablet computing devices, and so on.

XML enables documents to be exchanged even where the documents were created and/or are generally used by different software applications. XML may effectively enable one system to translate what another system sends. As a result of data transfer improvements, wireless device GUIs can be utilized in accordance with a hand held device and wireless network 952, whether configured as a paging network or another network type, to render images on the hand held device that closely represent the imaging capabilities available on desktop computing devices.

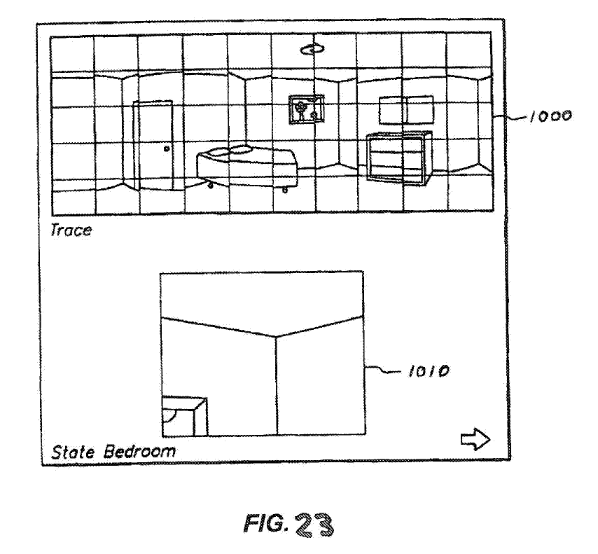

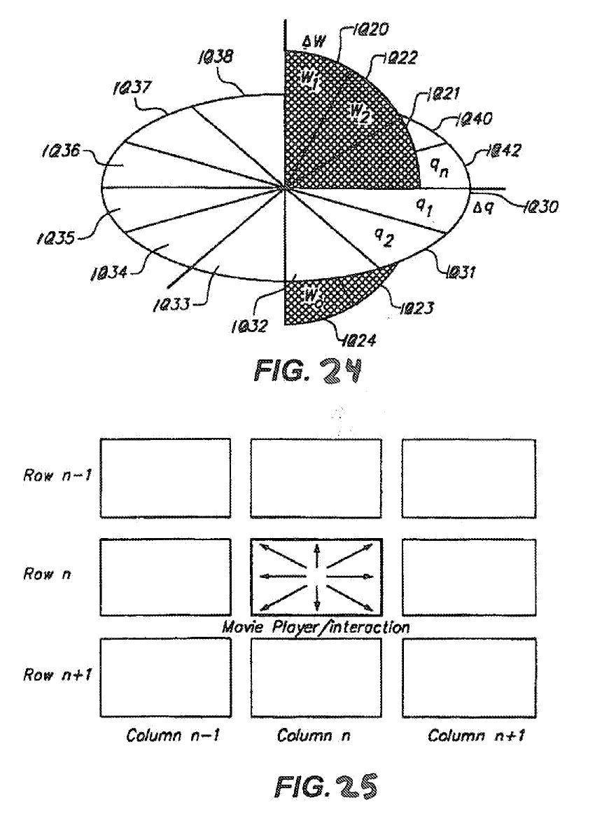

Those skilled in the art can appreciate that the system and logical processes described herein relative to FIG. 23 to FIG. 30 are not limiting features of the disclosed embodiments. Rather, FIG. 23 to FIG. 30 provide examples of image-processing systems and logical processes that can be utilized in accordance with alternative example embodiments. That is, FIG. 23 to FIG. 30 demonstrates that video captured accordingly to one or more of the disclosed embodiments can be subject to image processing, whether performed via the hand held device and/or elsewhere (e.g., at a server). Such a system and logical processes represent possible techniques, which may be utilized in accordance with one or more embodiments to permit a user of a hand held device to manipulate video images viewable on a display screen of the hand held device.

FIG. 23 thus illustrates an example overview display 1000 and a detail window 1010 that may be utilized with an example embodiment. The overview image display 1000 is a view representative of a 360° rotation around a particular point in a space. Such an image (e.g., a video image) may be captured by, for example, a video camera such as the video cameras described herein previously. While a complete rotational view may be utilized in accordance with an example embodiment, one of ordinary skill in the computer arts will readily comprehend that a semi-circular pan (such as used with wide-angle cameras) or other sequence of images could be substituted for the 360° rotation. The vantage point is generally where the camera was located as it panned the space. Usually the scene is captured in a spherical fashion as the camera pans around the space in a series of rows as depicted in FIG. 24. The space can be divided into w rows 1020-1024 and q columns 1030-1042 with each q representing another single frame as shown in FIG. 24.

User control over the scene (e.g., rotation, pan, zoom) may be provided by pressing a touch screen display of a display screen of a hand held device, such as the hand held devices described herein. User control over the scene may also be provided by manipulating external user controls integrated with a hand held device. Movement from a frame in the overview image display to another frame is in one of eight directions as shown in FIG. 25. The user may interact with the video representation of the space one frame at a time. Each individual frame is an image of one of the pictures taken to capture the space as discussed above. The individual frames may be pieced together.

Interacting with a video one frame at a time results in the ability to present a detailed view of the space, but there are severe limitations. First, the interaction results in a form of tunnel vision. The user can only experience the overview image display as it unfolds a single frame at a time. No provision for viewing an overview or browsing a particular area is provided. Determining where the current location in the image display is, or where past locations were in the overview image display is extremely difficult. Such limitations can be overcome by creating of a motif not dissimilar to the natural feeling a person experiences as one walks into a room.

Another limitation of a simple overview viewer is that there is no random access means. The frames can only be viewed sequentially as the overview image display is unfolded. As adapted for use in accordance an example embodiment, this problem has been overcome by providing tools to browse, randomly select and trace selected images associated with any overview image.

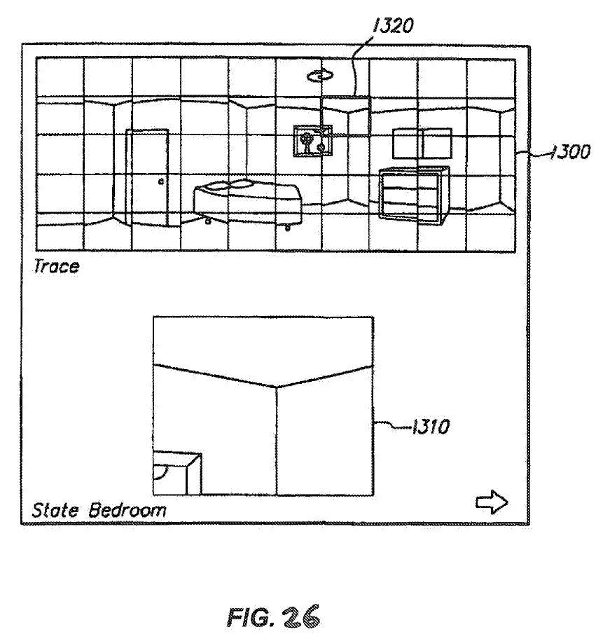

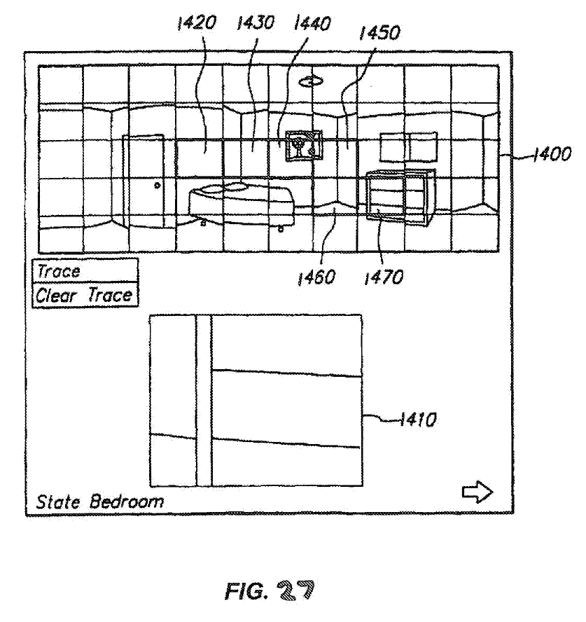

FIG. 26 illustrates an overview image 1300, a detail window 1310, and a corresponding area indicia, in this case a geometric figure outline 1320. The detail window 1310 corresponds to an enlarged image associated with the area bounded by the geometric figure outline 1320 in the overview image 1300. As the cursor is moved, the location within the overview image 1300 may be highlighted utilizing the geometric figure outline 1320 to clearly convey what location the detail window 1310 corresponds.

One of ordinary skill in the computer arts will readily comprehend that reverse videoing the area instead of enclosing it with a geometric figure would work equally well. Differentiating the area with color could also be used without departing from the invention. A user can select any position within the overview image, press the cursor selection device's button (for example, user controls in the form of touch screen user interface buttons or icons), and an enlarged image corresponding to the particular area in the overview display is presented in the detail window 1310. Thus, random access of particular frames corresponding to the overview image may be provided.

FIG. 27 illustrates a series of saved geometric figure outlines corresponding to user selections in tracing through an overview display for subsequent playback, in accordance with an example embodiment. The overview image 1400 has a detail window 1410 with an enlarged image of the last location selected in the overview image 1470. Each of the other cursor locations traversed in the overview image 1420, 1430, 1440, 1450, and 1460 are also enclosed by an outline of a geometric figure to present a trace to the user.

Each of the cursor locations may be saved, and because each corresponds to a particular frame of the overview image, the trace of frames can be replayed at a subsequent time to allow another user to review the frames and experience a similar presentation. Locations in the detailed window and the overview image can also be selected to present other images associated with the image area, but not necessarily formed from the original image.

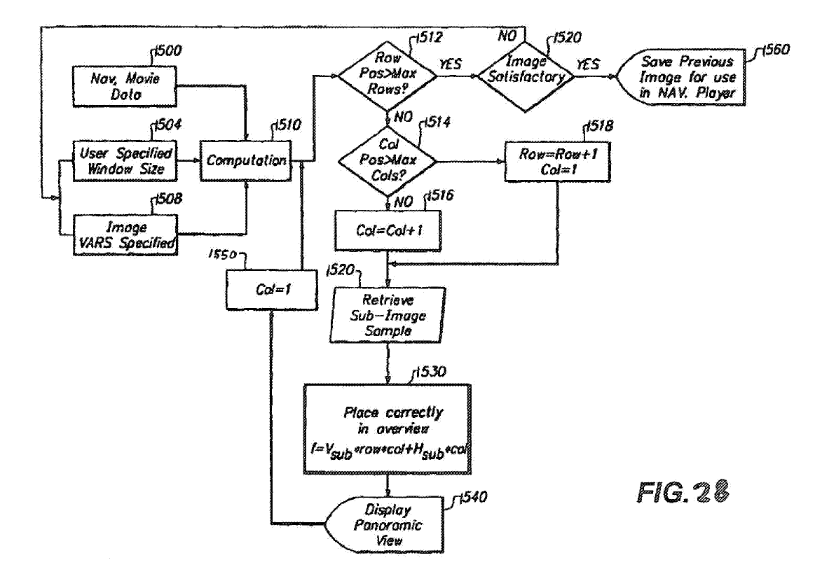

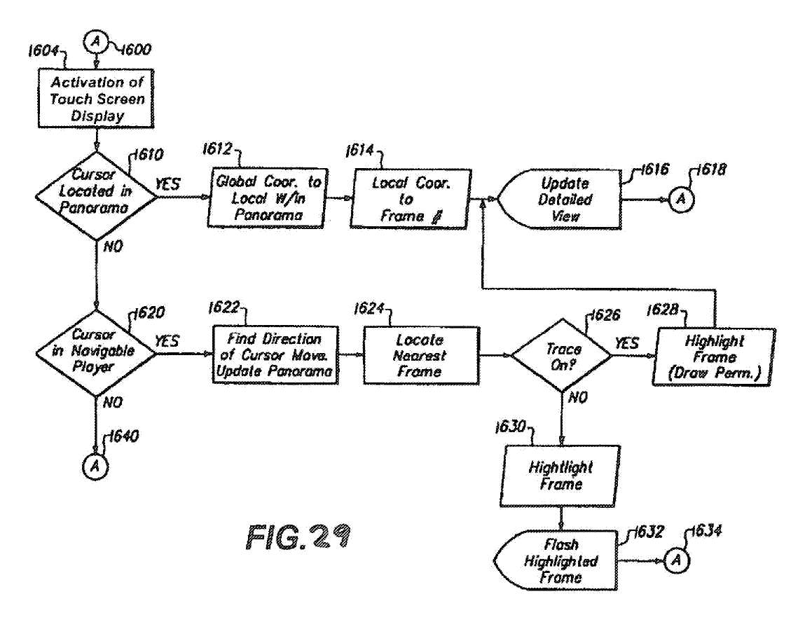

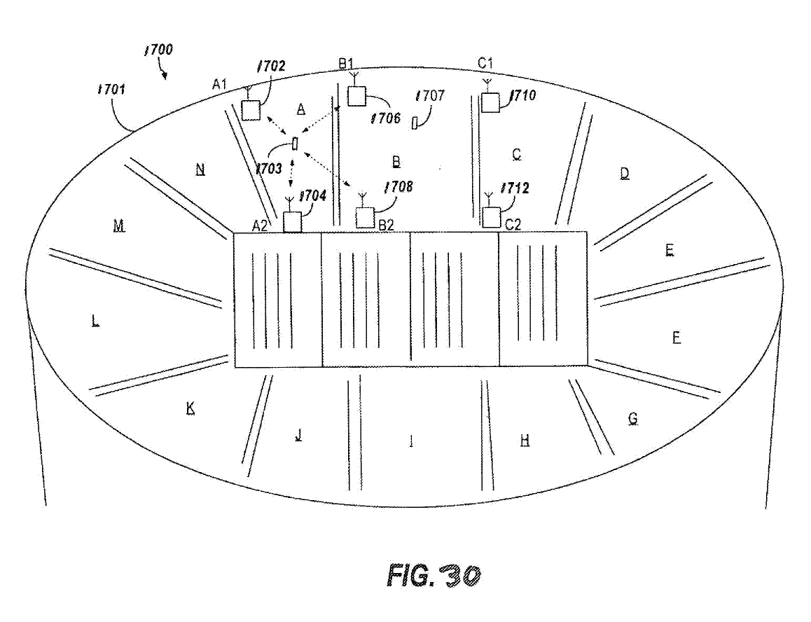

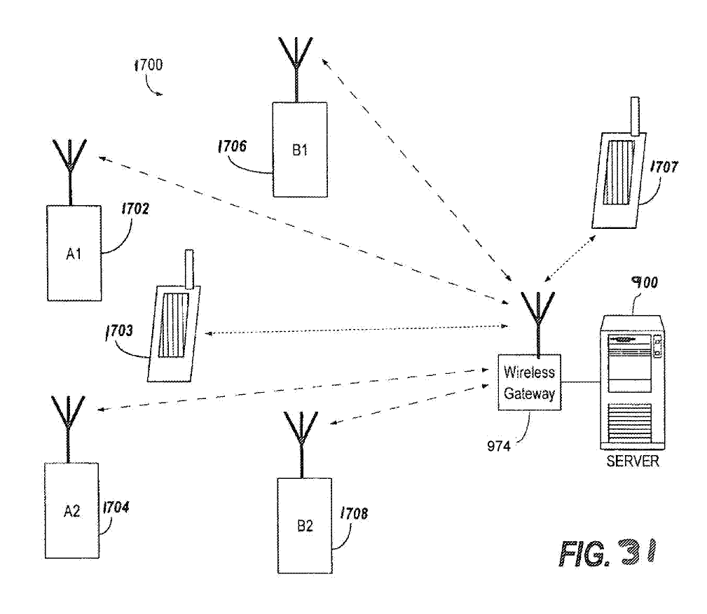

For example, a china teacup may appear as a dot in a china cabinet, but when the dot is selected, a detailed image rendering of the china teacup could appear in the detailed window. Moreover, a closed door appearing in an image could be selected and result in a detailed image of a room located behind the door even if the room was not visible in the previous image. Finally, areas in the detailed window can also be selected to enable further images associated with the detailed window to be revealed. Details of objects within a scene are also dependent on resolution capabilities of a camera. Cameras having appropriate resolution and/or image processing capabilities may be preferably used with certain aspects of the disclosed embodiments. The overview image was created as discussed above. A more detailed discussion of example image processing operations is presented below with reference to FIG. 28 and FIG. 29 herein.

FIG. 28 illustrates a flowchart providing a logical process for building an overview image display in the context of video image processing, in accordance with an example embodiment. Such a logical process may be utilized in accordance with an example embodiment, but is not considered a necessary feature of the disclosed embodiments. Those skilled in the art will appreciate that such a logical process is merely an example of one type of image-processing algorithm that may be utilized in accordance with a possible example embodiment. For example, such a logical process may be implemented as a routine or subroutine that runs via image-processing unit 835 of FIG. 13 of a hand held device or which may be processed via a server or other computing device. Those skilled in the art can appreciate that the logical process described with relation to FIGS. 28 and 29 herein are not limiting features of the disclosed embodiments.

Such logical processes, rather, are merely one of many such processes that may be utilized in accordance with an example embodiment to permit a user to manipulate video images displayed via a display screen of a hand held device. Navigable movie/video data in the form of images input to the hand held device to form individual images can thus be processed, as illustrated at function block 1500. User specified window size (horizontal dimension and vertical dimension) may be entered, as illustrated at function block 1504.

Image variables can be specified (horizontal sub-sampling rate, vertical sub-sampling rate, horizontal and vertical overlap of individual frame images, and horizontal and vertical clip (the number of pixels are clipped from a particular frame in the x and y plane)), as depicted at function block 1508. Function blocks 1500, 1504, and 1508 are fed into the computation function block 1510 where the individual frames are scaled for each row and column, and the row and column variables are each initialized to one.

Then a nested loop can be invoked to create the overview image. First, as indicated at decision block 1512, a test is performed to determine if the maximum number of rows has been exceeded. If so, then the overview image is tested to determine if its quality is satisfactory at decision block 1520. If the quality is insufficient, the user may be provided with an opportunity to adjust the initial variables, as illustrated at function blocks 1504 and 1508. The processing is then repeated. If, however, the image is of sufficient quality, it can be saved and displayed for use, as depicted at block 1560.

If the maximum rows has not been exceeded as detected in decision block 1512, then another test can be performed, as illustrated at decision block 1514, to determine if the column maximum has been exceeded. If so, then the row variable can be incremented and the column variable can be reset to one at function block 1518 and control flows to input block 1520. If the column maximum has not been exceeded, then the column variable may be incremented and the sub-image sample frame can be retrieved, as depicted at input block 1520. Then, as illustrated at function block 1530, the frame may be inserted correctly in the overview image.

The frame may be inserted at the location corresponding to (Vsub*row*col)+Hsub*col; where row and col refer to the variables incremented in the nested loop, and Vsub and Hsub are user specified variables corresponding to the horizontal and vertical sub sampling rate. Finally, the incremental overview image can be displayed based on the newly inserted frame as depicted at display block 1540. Thereafter, the column variable can be reset to one and processing can be passed to decision block 1512.

A computer system corresponding to the example embodiments depicted in FIGS. 23 to 29 may be generally interactive. A user may guess at some set of parameters, build the overview image, and decide if the image is satisfactory. If the image is not satisfactory, then variables can be adjusted and the image is recreated. This process can be repeated until a satisfactory image results, which may be saved with its associated parameters. The picture and the parameters can then be input to the next set of logic.

Such features may or may not be present with the hand held device itself. For example, images may be transmitted from a transmitter, such as data transmitter 912, and subroutines or routines present within the server itself may utilize predetermined sets of parameters to build the overview image and determine if the image is satisfactory, generally at the request of the hand held device user. A satisfactory image can then be transmitted to the hand held device. Alternatively, image-processing routines present within an image-processing unit integrated with the hand held device may operate in association with routines present within a server to determine if the image is satisfactory and/or to manipulate the image (e.g., pan, zoom).

FIG. 29 illustrates a flowchart illustrative of a logical process for playback interaction, in accordance with an example embodiment. The logical process illustrated in FIG. 29 may be utilized in accordance with an example embodiment, depending of course, upon design considerations and goals. Playback interaction may commence, as illustrated at label 1600, which immediately flows into function block 1604 to detect if user controls have been activated at the hand held device. Such user controls may be configured as external user controls on the hand held device itself (e.g., buttons, etc.), or via a touch screen user interface of the hand held device.

When a touch screen user input or user control button press is detected, a test can be performed to determine if a cursor is positioned in the overview portion of the display, as shown in block 1610. If so, then the global coordinates can be converted to overview image coordinates local to the overview image as shown in output block 1612. The local coordinates can be subsequently converted into a particular frame number as shown in output block 1614. Then, the overview image is updated by displaying the frame associated with the particular location in the overview image and control flows via label 1600 to function block 1604 to await the next button press.

If the cursor is not detected in the overview image as illustrated at decision block 1610, then another test may be performed, as indicated at decision block 1620, to determine if the cursor is located in the navigable player (detail window). If not, then control can be passed back via label 1600 to function block 1604 to await the next user input. However, if the cursor is located in the detail window, then as depicted a function block 1622, the direction of cursor movement may be detected. As depicted at function block 1624, the nearest frame can be located, and as illustrated at decision block 1626, trace mode may be tested.

If trace is on, then a geometric figure can be displayed at the location corresponding to the new cursor location in the overview image. The overview image may then be updated, and control can be passed back to await the next user input via user controls at the hand held device and/or a touch screen user interface integrated with the hand held device. If trace is not on, the particular frame is still highlighted as shown in function block 1630, and the highlight can be flashed on the overview image as illustrated at output block 1632. Thereafter, control may be returned to await the next user input.

Although the aforementioned logical processes describe the use of a cursor as a means for detecting locations in a panorama, those skilled in the art can appreciate that other detection and tracking mechanisms may be utilized, such as, for example, the pressing of a particular area within a touch screen display.

FIG. 30 illustrates a pictorial representation illustrative of a Venue Positioning System (VPS) 1700 in accordance with an example embodiment. FIG. 30 illustrates a stadium venue 1701, which is divided according to seats and sections. Stadium venue 1701 may be utilized for sports activities, concert activities, political rallies, or other venue activities. Stadium venue 1701 can be divided, for example, into a variety of seating sections A to N. For purposes of simplifying this discussion, VPS 1700 is described in the context of sections A to C only.

A venue positioning system (VPS) device 1704 is positioned in section A of stadium venue 1701, as indicated at position A2. A VPS device 1702 is located within section A at position A1. In the illustration of FIG. 30, it is assumed that VPS device 1702 is located at the top of a staircase, while VPS device 1704 is located at the bottom of the staircase, and therefore at the bottom of section A, near the sports field. A VPS device 1706 is located near the top of section B at position B1. A VPS device 1708 is located at the bottom of section B at position B2, near the sports field. Similarly, in section C, venue positioning devices 1710 and 1712 are respectively located at positions C1 and C2.

A hand held device 1703 may be located at a seat within section A. For purposes of this discussion, and by way of example only, it is assumed that hand held device 1703 is being operated by a stadium attendee watching a sporting event or other venue activity taking place on the sports field. A hand held device 1707 is located within section B. Hand held device 1707, by way of example, may be operated by a concessionaire or venue employee.

If the user of hand held device 1703 desires to order a soda, hot dog, or other product or service offered by venue operators during the venue event, the user merely presses an associated button displayed via a touch screen user interface integrated with the hand held device. Immediately, a signal is transmitted by hand held device 1703, in response to the user input to/through the VPS device, wireless network, or wireless gateway as previously described. One or more of VPS devices 1702, 1704, 1706, and 1708 may detect the signal. The VPS devices may also operate merely as transponders, in which case hand held devices will be able to determine their approximate location within the venue and then transmit position information through wireless means to, for example, concession personnel.

In some example embodiments, VPS devices 1702, 1704, 1706, and 1708 can function in concert with one another to determine the location of hand held device 1703 within section A. Triangulation methods, for example, may be used through the hand held device or VPS devices to determine the location of the hand held device within the venue. This information is then transmitted by one or more of such VPS devices either directly to hand held device 1707 or initially through a wireless network, including a wireless gateway and associated server, and then to hand held device 1707. The user of hand held device 1707 can then directly proceed to the location of hand held device 1703 to offer concession services.

Additionally, hand held device 1703 can be configured with a venue menu or merchandise list. In response to requesting a particular item from the menu or merchandise list, the request can be transmitted as wireless data from hand held device 1703 through the wireless network to hand held device 1707 (or directly to a controller (not shown) of hand held device 1707) so that the user (concession employee) of hand held device 1707 can respond to the customer's request and proceed directly to the location of hand held device 1703 used by a customer.

FIG. 31 illustrates in greater detail the VPS 1700 of FIG. 30, in accordance with yet another example embodiment. In FIGS. 30-31, like or analogous parts are indicated by identical reference numerals, unless otherwise stated. Additionally, wireless gateway 974 and server 900 of FIG. 31 are analogous to the previously discussed and illustrated wireless gateway 974 and server 900. Venue positioning units 1702, 1704, 1706, and 1708 are located within section A and section B. A wireless gateway 974 communicates with the server 900. Wireless gateway 974 can also communicate with hand held device 1707 and hand held device 1703. Note that the hand held devices 1707 and 1703 are analogous or similar to the previously discussed hand held devices (e.g., smartphones, tablet computing devices, wearable computing devices, etc.).

Wireless gateway 974 can also communicate with VPS devices 1702, 1704, 1706, and 1708 if the VPS devices are also operating as data communication devices in addition to providing mere transponder capabilities. When VPS devices 1702, 1704, 1706, and 1708 detect the location of hand held device 1703 within stadium venue 1701, the location is transmitted to wireless gateway 974 and thereafter to, for example, hand held device 1707. It should be appreciated that a hand held device user may also identify his/her location in a venue by entering location information (e.g., seat/section/row) on the hand held device when making a request to a service provider such as a food concession operation. The VPS devices will still be useful to help concession management locate concession employees located within the venue that are in closest proximity to the hand held device user. A wireless gateway 974 and server 900 can be associated with a wireless network implemented in association with stadium venue 1701. Those skilled in the art will appreciate that such a wireless network may in some embodiments be limited geographically to the stadium venue 1701 itself and the immediate surrounding area. However, the server 900 and the hand held devices 1703 and 1707 are also capable of communicating with other wireless networks not limited to the stadium venue 1701 and surrounding areas, such as a cellular telephone network as described previously herein.

In most cases, the hand held devices such as hand held devices 1703 and 1707 are hand held devices such as smartphones, tablet computing devices, and so on that users bring into the venue. That is, such hand held devices are owned by the patrons themselves, which they bring into the venue for their use by permission of the venue promoter or venue owners in return for the payment of a fee by the patron paid through, for example, an “app” downloaded to their devices from, for example, online stores such as the Apple Store and so on. In return for the fee, the venue promoter or stadium owner can provide the patron with a temporary code or password or may enable other means of authorization (e.g., biometrics), which permits them to access the wireless network associated with the venue itself, such as wireless network 952 described herein. Patron-owned devices may utilize smart card technology to receive authorization codes (e.g., decryption and/or encryption) needed to receive venue provided video/data. Such authorization codes or passwords may also be transferred to the patron-owned device via, for example, IR or short range RF means. In some example embodiments, wireless network 952 described herein may be configured as a proprietary wireless Intranet/Internet providing other data accessible by patrons through their hand held devices. In some example embodiments, the VPS devices 1702, 1704, 1706, and 1708 may be implemented as pods, such as the pod 100 discussed previously herein.

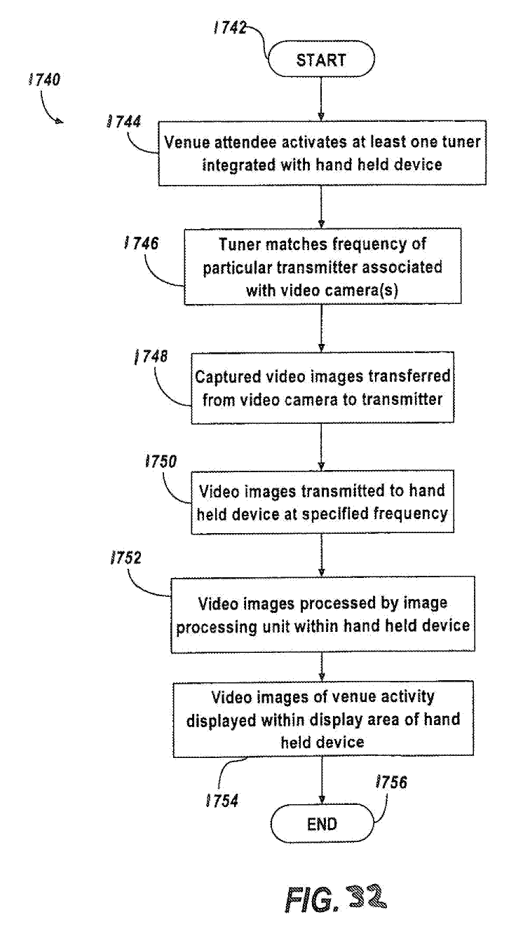

FIG. 32 illustrates a flowchart of operations depicting logical operational steps of a method 1740 for providing multiple venue activities through a hand held device, in accordance with an example embodiment. The process can be initiated, as depicted at block 1742. As illustrated next at block 1744, a venue attendee may activate at least one hand held tuner integrated with a hand held device, such as the hand held device illustrated in FIG. 16. At least one tuner may be integrated with the hand held device, although more than one tuner (or other simultaneous signal receiving capability) may be used within a hand held device in support of some example embodiments.

In some example embodiments, the tuner, or tuners, is/are associated with a transmission frequency/frequencies of a transmitter that may be linked to a particular camera/cameras focusing on a venue activity, or to a wireless gateway or wireless network transmission. To view the images from that particular angle, a user can retrieve the video images from the camera associated with that particular angle. The user may have to adjust a tuner until the right frequency/image is matched, as indicated at block 1746. As illustrated at block 1748, captured video images can be transferred from the video camera to the transmitter associated with the camera, or a server in control of the camera(s). Video images are generally transmitted to the hand held device at the specified frequency, in response to a user request at the hand held device, as depicted at block 1750.

An image-processing unit integrated with the hand held device, as illustrated at block 1752 may then process transferred video images. An example of such an image-processing unit is image-processing unit 835 of FIG. 13. As indicated thereafter at block 1754, the video images of the venue activity captured by the video camera can be displayed within a display area of the hand held device, such as display 818 of FIG. 13. The process can then terminate, as illustrated at block 1756.

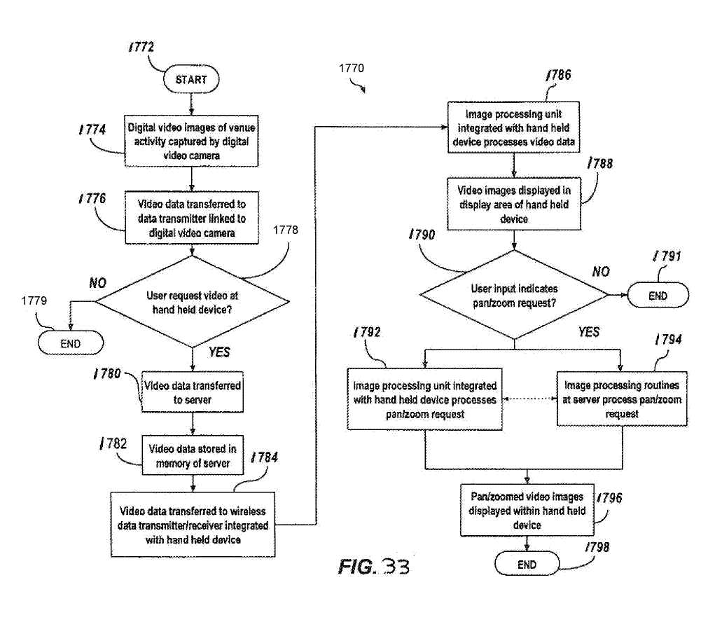

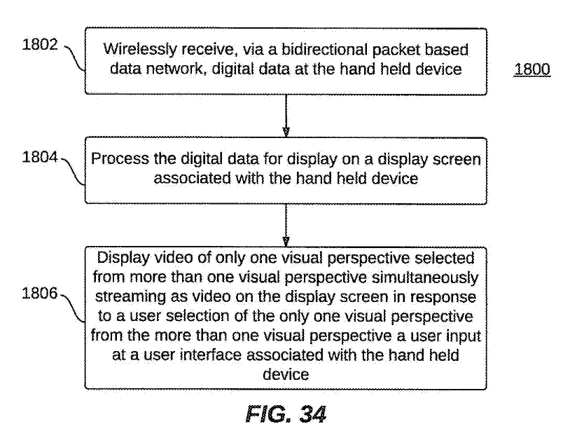

FIG. 33 illustrates a flowchart of operations depicting logical operational steps of a method 1770 for providing multiple venue activities through a hand held device from one or more digital video cameras, in accordance with another example embodiment. As indicated at block 1772, the process is initiated. As illustrated next at block 1774, video images of a venue activity may be captured by one or more digital video cameras.

Such digital video cameras may be in some example embodiments panoramic/wide-angle in nature and/or configured as high definition video cameras as discussed previously. The video camera or cameras may be respectively linked to data transmitters, such as data transmitters 902, 904, 906, and/or 908 of FIG. 17 or data transmitter 912 of FIG. 18 to FIG. 21 herein, as shown at block 1176. As depicted next at decision block 1778, if a user does not request a view of the venue activity through the hand held device, the process terminates, as illustrated thereafter at block 1779.

If, as illustrated at decision block 1778, the user does request a view of the venue activity through the hand held device, then as described thereafter at block 1780, video data may be transferred from a data transmitter to a server, such as servers 260, 530, 560, or 900 discussed previously. The video data may be stored in a memory location of the server or a plurality of servers, as indicated at block 1782. The video data may then be transferred to a wireless data transmitter/receiver that is integrated and/or communicates with the hand held device, as indicated at block 1784.

As illustrated thereafter at block 1786, the video data may be subject to image-processing by an image-processing unit and associated image-processing routines and/or subroutines integrated with the hand held device. In some example embodiments, such image-processing of the video data can take place via a server prior to transmission to the hand held device. When image-processing is complete, the video images may be displayed in a display area of the hand held device, as shown at block 1788. As illustrated next at block 1790, if a user chooses to pan/zoom for a better view of the video images displayed within the hand held device, then two possible operations may follow, either separately or in association with one another.

The image-processing unit integrated with the hand held device may process the user's pan/zoom request, as illustrated at block 1792. Alternatively, image-processing routines and/or subroutines resident at the server or a plurality of servers may process the user's pan/zoom request, following the transmission of the user's request from the hand held device to the server or plurality of servers, as illustrated at block 1794. Such a request may be transmitted through a wireless gateway linked to the server or servers.

Image-processing may occur at the server or servers if the hand held device is not capable of directly processing the video data and video images thereof due to low memory or slow CPU allocation. Likewise, some image-processing may take place within the hand held device, while video image-processing requiring faster processing capabilities and increased memory may take place additionally at the server or servers to assist in the final image representation displayed at the hand held device.

When image-processing is complete, the pan/zoomed images can be displayed within a display screen or display area of the hand held device, as illustrated thereafter at block 1796. The process then terminates, as depicted at block 798. If the user does not request pan/zoom, as indicated at block 1790, the process may then terminate, as described at block 1791.

FIG. 34 illustrates a flow chart of operations depicting logical operational steps of a method 1800 for receiving venue-based data at a hand held device, in accordance with another example embodiment. Note that such a hand held device may be located at a venue or can be remote from the venue such as at a person's home or car or in another state or geographical area. As indicated at block 1802, a step or logical operation can be processed for wirelessly receiving, via a bidirectional packet based data network, digital data at the hand held device. The packet based data network is selectable by the user from the group of a wireless LAN (e.g., WLAN 964) and at least one cellular communications network (such as discussed previously). Such digital data can include video streaming simultaneously from more than one visual perspective within an entertainment venue and wherein the digital data is transmitted from at least one venue-based data source at the entertainment venue.

Thereafter, as depicted at block 1804, a step or logical operation can be implemented to process the digital data for display on a display screen associated with the hand held device. Then, as indicated at block 1806, a step or logical operation can be processed for displaying video of only one visual perspective within the venue selected from more than one visual perspective simultaneously streaming as video on the display screen in response to a user selection of the only one visual perspective from the more than one visual perspective a user input at a user interface associated with the hand held device. In some example embodiments, the aforementioned at least one venue-based data may be a video camera or one or more video cameras.

In some example embodiments, the aforementioned step or logical operation of receiving at a hand held device data transmitted from at least one venue-based data source can further include a step or logical operation for receiving through at least one wireless receiver at the hand held device, data transmitted from the at least one venue-based data source. Additionally, a step or logical operation can be provided for transmitting the data from the at least one venue-based data source to the hand held device through a wireless network. A step or logical operation can also be provided or implemented for processing the data for display on the display screen utilizing at least one image-processing module.

The aforementioned data can include venue-based data including real-time video data of the more than one video stream from more than one video camera located within the venue. Such data may also include or constitute instant replay video from more than one video perspective. Such data can also include promotional information and advertising information. The aforementioned venue can be, for example, a football stadium, a baseball stadium, a soccer stadium, a basketball arena, a boxing arena, a wrestling arena, a car racing venue (e.g., a NASCAR venue), a horse racing stadium, a golf course or portions of a golf course, a concert hall, a convention center, a casino, a theater, an amusement park, a theme park, and so on.

Additionally, in some example embodiments, the aforementioned step or logical operation of wirelessly receiving digital data streams at a hand held device over a packet-based data network can further comprise a step or logical operation for wirelessly communicating with a base station that is geographically remote from the entertainment venue, wherein the handheld device is connected to the base station via the bidirectional wireless packet based data network. In yet another example embodiment, a plurality of base stations can be provided, wherein a first group of the plurality of base stations is located within an entertainment venue and a second group of the plurality of base stations is located outside of the entertainment venue (i.e., remote from the venue such as in another city or state or locality) and wherein the base station is in at least one of the first group and the second group. The aforementioned digital data can be uncast over the packet-based data network or multicast over the packet-based data network. The digital data can be provided in some example embodiments by two or more independent sources. Such two or more sources can independently deliver the digital data to the hand held device. The hand held device in some example embodiments may be in data communication with a server, wherein the server is configured to store and transmit the digital data independent of the number of hand held devices that are configured to receive the generated digital data.

In some example embodiments, the hand held device can be in data communication with a server, and the server can be configured to transmit the digital data and also further configured to allow access through a login procedure to the generated digital data by a plurality of hand held devices. In some example embodiments, the digital data can be composed of live video of a sporting event that originates from a venue. In some example embodiments, the live sports video can be received wirelessly at the hand held device over a packet-based data network and concurrently distributed to a plurality of devices over a broadcast network.

In some example embodiments, streaming of video on the display screen in response to a user selection can further involve accessing a digital data stream currently transmitting over a packet-switch based network from a first location to at least two hand held devices, wherein the hand held device receives the digital data stream that is concurrently receivable by at least another hand held device. In some example embodiments, the hand held device may be located in at least one of in the venue and out of the venue (e.g., remote from the venue such as at another geographical location). In still another example embodiment, the video streaming simultaneously from more than one visual perspective within a venue can be simultaneously distributed to a plurality of hand held devices. In yet other example embodiments, the video streaming simultaneously to the plurality of hand held devices may be substantially similar (or may not). In some example embodiments, the video streaming simultaneously is accessible by the hand held device over the Internet. In still another example embodiment, the hand held device can be configured to display currently available live sporting events for viewing.

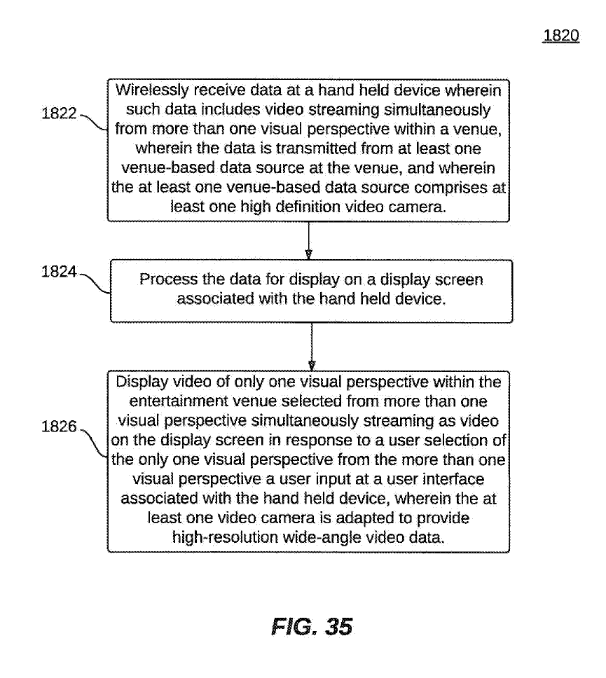

FIG. 35 illustrates a flow chart of operations depicting logical operational steps of a method 1820 for receiving venue-based data at a hand held device, in accordance with an alternative example embodiment. As indicated at block 1822, a step or logical operation can be implemented for wirelessly receiving data at a hand held device wherein such data includes video streaming simultaneously from more than one visual perspective within a venue and wherein the data is transmitted from at least one venue-based data source at the venue, and wherein the at least one venue-based data source comprises at least one high definition video camera.

Next, as illustrated at block 1824, a step or logical operation can be implemented for processing the data for display on a display screen associated with the hand held device. Then, as shown at block 1826, a step or logical operation can be provided for displaying video of only one visual perspective within the entertainment venue selected from more than one visual perspective simultaneously streaming as video on the display screen in response to a user selection of the only one visual perspective from the more than one visual perspective a user input at a user interface associated with the hand held device, wherein the at least one video camera is adapted to provide high-resolution wide-angle video data. The data can be broadcast to the hand held device(s) through wireless communications.

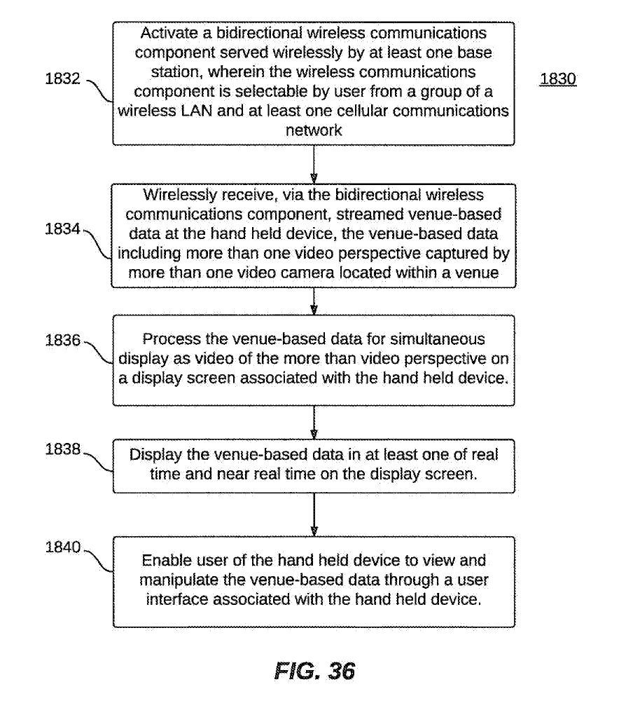

FIG. 36 illustrates a flow chart of operations depicting logical operational steps of a method 1830 for wirelessly receiving venue-based data at a hand held device, in accordance with another example embodiment. As indicated at block 1832, a step or logical operation can be provided for activating a bidirectional wireless communications component served wirelessly by at least one base station, wherein the wireless communications component is selectable by the user from the group of a wireless LAN and at least one cellular communications network. Thereafter, as shown at block 1834, a step or logical operation can be provided for wirelessly receiving, via the bidirectional wireless communications component, streamed venue-based data at the hand held device, the venue-based data including more than one video perspective captured by more than one video camera located within a venue.

Next, as illustrated at block 1836, a step or logical operation can be provided to process the venue-based data for simultaneous display as video of the more than video perspective on a display screen associated with the hand held device. Then, as shown at block 1838, a step or logical operation can be provided for displaying the venue-based data in at least one of real time and near real time on the display screen. Thereafter, as described at block 1840, a step or logical operation can be implemented to enable a user of the hand held device to view and manipulate the venue-based data through a user interface associated with the hand held device.

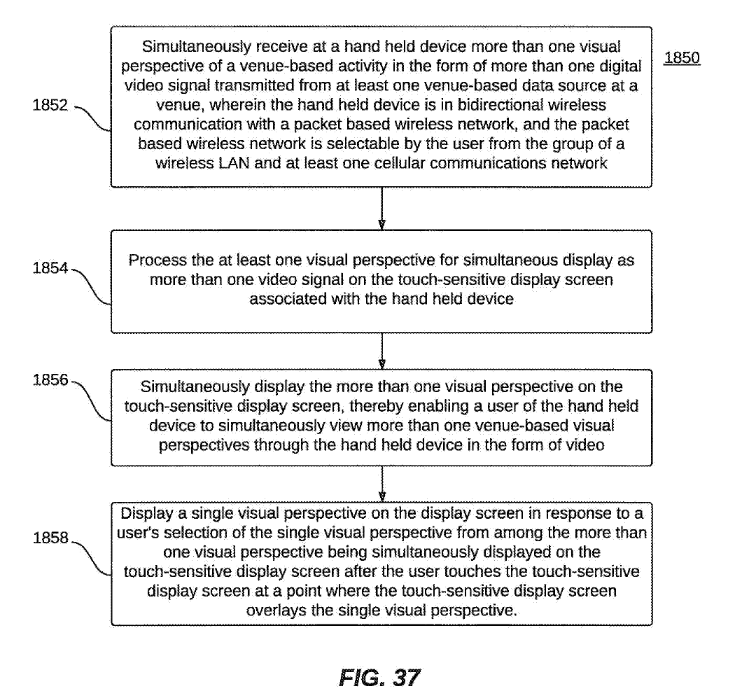

FIG. 37 illustrates a flow chart of operations depicting logical operational steps of a method 1850 for receiving at least one visual perspective of a venue-based activity at a hand held device. Note that a software module can be provided, which is represented by a graphical icon on a touch-sensitive color display screen associated with the hand held device. The software module can be activated by a user touching an area of the touch-sensitive display screen associated with the graphical icon. The software module causes the hand held device to perform steps or logical operations of method 1850, including, for example: simultaneously receiving at a hand held device more than one visual perspective of a venue-based activity in a form of more than one digital video signal transmitted from at least one venue-based data source at an entertainment venue, wherein the hand held device is in bidirectional wireless communication with a packet based wireless network, the packet based wireless network selectable by the user from the group of a wireless LAN and at least one cellular communications network, as depicted at block 1852; processing the at least one visual perspective for simultaneous display as more than one video signal on the touch-sensitive display screen associated with the hand held device, as shown at block 1854; simultaneously displaying the more than one visual perspective on the touch-sensitive display screen, thereby enabling a user of the hand held device to simultaneously view more than one venue-based visual perspectives through the hand held device in the form of video, as indicated at block 1856; and as illustrated at block 1858, displaying a single visual perspective on the display screen in response to a user's selection of the single visual perspective from among the more than one visual perspective being simultaneously displayed on the touch-sensitive display screen after the user touches the touch-sensitive display screen at a point where the touch-sensitive display screen overlays the single visual perspective.

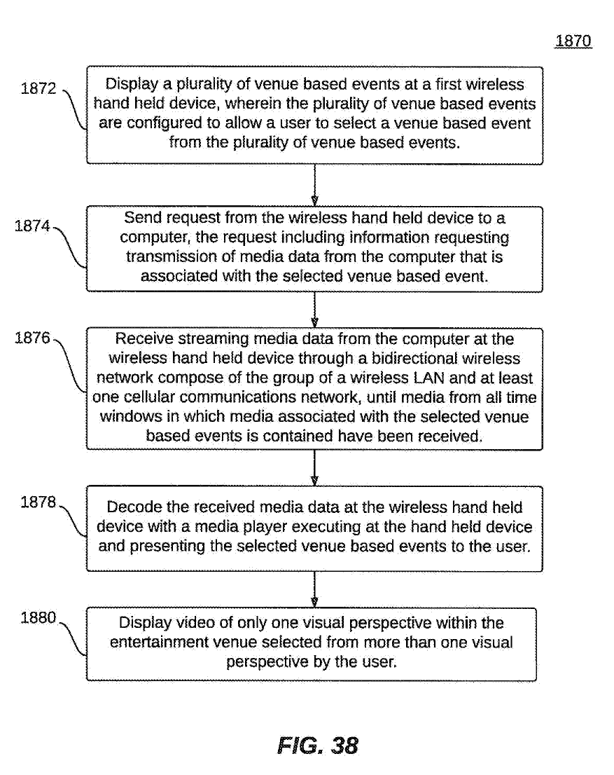

FIG. 38 illustrates a flow chart of operations depicting logical operational steps of a method 1870 for selectively presenting a portion of a venue based event to a user, in accordance with an alternative embodiment. As shown at block 1872, a step or logical operation can be implemented for displaying a plurality of venue based events at a first wireless hand held device, wherein the plurality of venue based events are configured to allow a user to select a venue based event from the plurality of venue based events. Thereafter, as depicted at block 1874, a request can be sent from the wireless hand held device to a computer, the request comprising information requesting transmission of media data from the computer that is associated with the selected venue based event.

As shown thereafter at block 1876, a step or logical operation can be provided for receiving streaming media data from the computer at the wireless handheld device through a bidirectional wireless network comprised from the group of a wireless LAN and at least one cellular communications network, until media from all time windows in which media associated with the selected venue based events is contained have been received. Then, as shown at block 1878, the received media data can be decoded at the wireless hand held device with a media player executing at the hand held device and presenting the selected venue based events to the user. Thereafter, as indicated at block 1880, a step or logical operation can be implemented for displaying video of only one visual perspective within the entertainment venue selected from more than one visual perspective by the user.

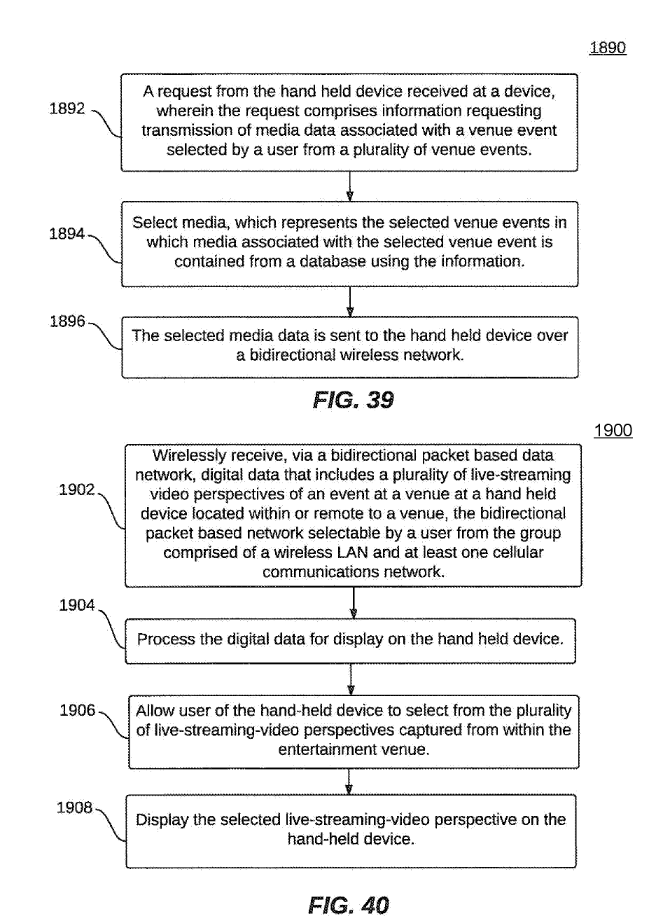

FIG. 39 illustrates a flow chart depicting logical operational steps of a method 1890 for sending a portion of an event to a first device. As a indicated at block 1892, a request from the hand held device can be received at a device, wherein the request comprises information requesting transmission of media data associated with a venue event (e.g., a sporting event, a concert event, etc.) selected by a user from a plurality of venue events. Thereafter, as depicted at block 1894, the media can be selected, which represents the selected venue events in which media associated with the selected venue event is contained from a database using the information. Then, as illustrated at block 1896, the selected media data can be sent to the hand held device over a bidirectional wireless network.

FIG. 40 illustrates a flow chart depicting logical operational steps of a method 1900 for viewing live-streaming video of a venue-based activity on a hand-held device at locations within or remote to the venue. As indicated at block 1902, a step can be implemented for wirelessly receiving, via a bidirectional packet based data network, digital data that includes a plurality of live-streaming video perspectives of an event at a venue at a hand held device located within or remote to a venue, the bidirectional packet based network selectable by a user from the group comprised of a wireless LAN and at least one cellular communications network. Thereafter, as shown at block 1904, a step or logical can be implemented for processing the digital data for display on the hand held device. Then, as depicted at block 1906, a step or logical operation can be implemented to allow a user of the hand-held device to select from the plurality of live-streaming-video perspectives captured from within the venue. Then, as shown at block 1908, a step or logical operation can be provided to display the selected live-streaming-video perspective on the hand-held device.

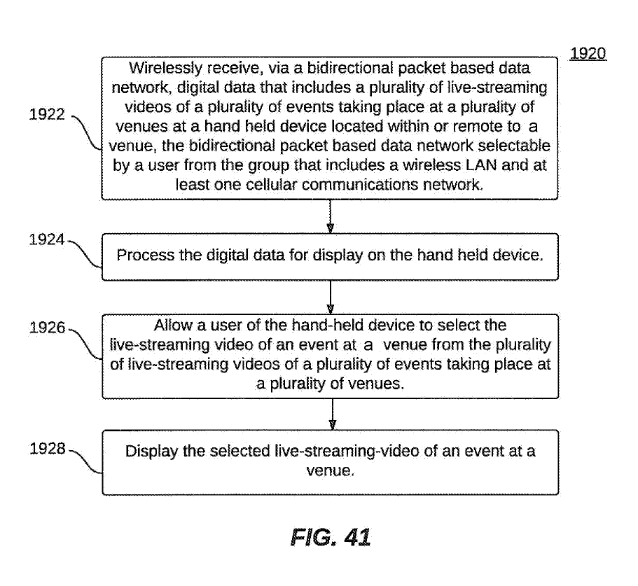

FIG. 41 illustrates a flow chart depicting logical operational steps of a method 1920 viewing live-streaming video of a venue-based activity on a hand-held device at locations within or remote to the venue, in accordance with another example embodiment. As depicted at block 1922, a step or logical operation can be implemented for wirelessly receiving, via a bidirectional packet based data network, digital data that includes a plurality of live-streaming videos of a plurality of events taking place at a plurality of entertainment venues at a hand held device located within or remote to an entertainment venue, the bidirectional packet based data network selectable by a user from a group of networks including, for example, a wireless LAN and at least one cellular communications network. Thereafter, as illustrated at block 1924, a step or logical operation can be implemented to process the digital data for display on the hand held device. Then, as shown at block 1926, a step or logical operation can be provided to allow a user of the hand-held device to select the live-streaming video of an event at a venue from the plurality of live-streaming videos of a plurality of events taking place at a plurality of venues. Then, as depicted at block 1928, a step or logical operation can be implemented for displaying the selected live-streaming-video of an event at a venue.

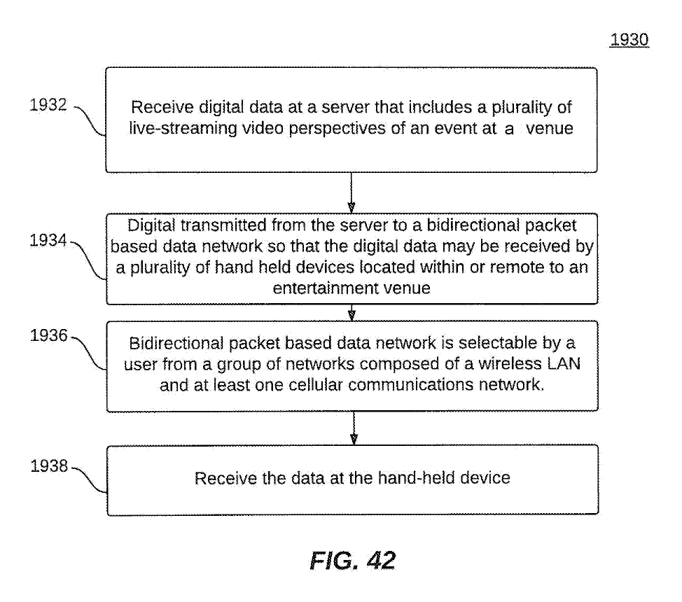

FIG. 42 illustrates flow chart depicting logical operational steps of a method 1930 enabling a user of a hand-held device to view live-streaming video of a venue-based activity at locations within or remote to the venue, in accordance with another example embodiment. As shown at block 1932, a step or logical operation can be provided for receiving digital data at a server that includes a plurality of live-streaming video perspectives of an event at a venue. Note that examples of such a include servers 706, 707, 708, and 709 shown in FIG. 11, and server 900 shown in FIGS. 17-20. Another example of such a server is the synchronized server 115. As illustrated next at block 1934, the digital data can be transmitted from the server to a bidirectional packet based data network so that the digital data may be received by a plurality of hand held devices located within or remote to an entertainment venue. As shown at block 1936, the bidirectional packet based data network is selectable by a user from a group of networks composed of a wireless LAN and at least one cellular communications network. Thereafter, as shown at block 1938, a step or logical operation can be provided for receiving the data at the hand-held device.

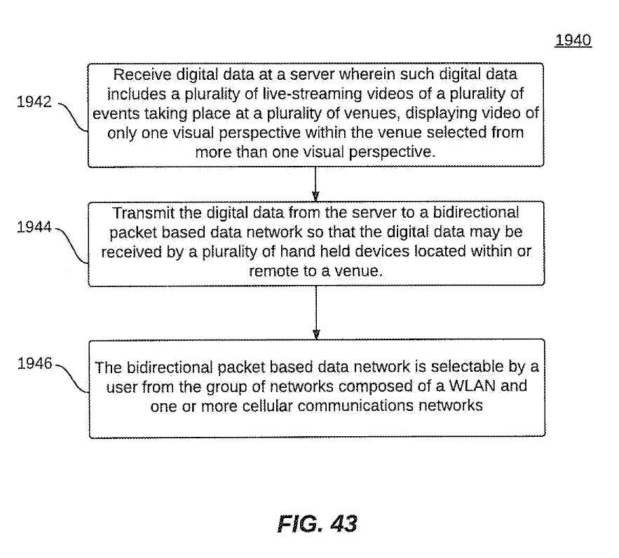

FIG. 43 illustrates a flow chart depicting logical operational steps of a method 1940 for enabling a user of a hand-held device to view live-streaming video of a venue-based activity at locations within or remote to the venue, in accordance with another example embodiment. As shown at block 1942, digital data can be received at a server (e.g., such as server 260, synchronized server 115, servers 530, 560, servers 706, 707, 708, 708, server 900, etc.) wherein such digital data includes a plurality of live-streaming videos of a plurality of events taking place at a plurality of venues, displaying video of only one visual perspective within the venue selected from more than one visual perspective.

Then, as indicated at block 1944, the digital data can be transmitted from the server to a bidirectional packet based data network so that the digital data may be received by a plurality of hand held devices located within or remote to an entertainment venue. As shown at block 1946, the bidirectional packet based data network is selectable by a user from the group of networks composed of a wireless LAN (e.g., WLAN 964) and one or more cellular communications networks (e.g., GSM 958, CDMA 962, TDMA 966, etc.).

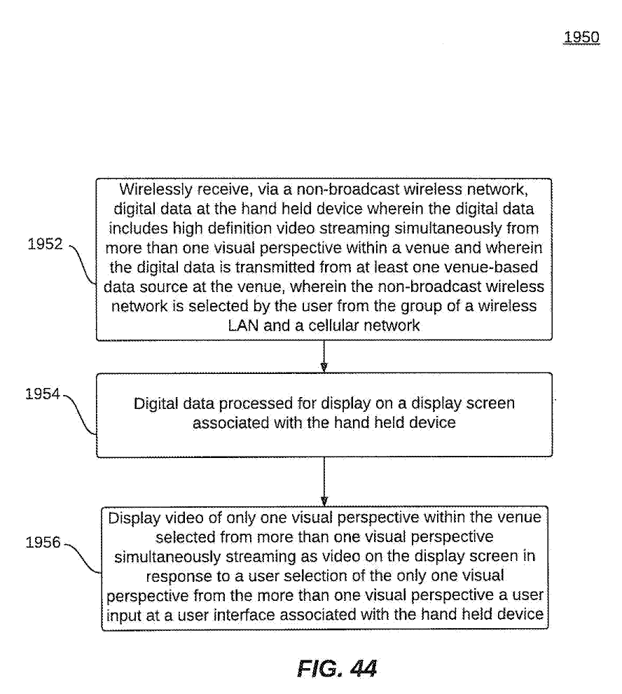

FIG. 44 illustrates a flow chart depicting logical operations of a method 1950 for receiving venue-based data at a hand held device, in accordance with another example embodiment. As shown at block 1952, a step or logical operation can be provided for wirelessly receiving, via a non-broadcast wireless network, digital data at the hand held device wherein the digital data includes high definition video streaming simultaneously from more than one visual perspective within an entertainment venue and wherein the digital data is transmitted from at least one venue-based data source at the entertainment venue, wherein the non-broadcast wireless network is selected by the user from the group of a wireless LAN and a cellular network. As indicated next at block 1954, the digital data can be processed for display on a display screen associated with the hand held device. Then, as illustrated at block 1956, a step or logical operation can be provided for displaying video of only one visual perspective within the venue selected from more than one visual perspective simultaneously streaming as video on the display screen in response to a user selection of the only one visual perspective from the more than one visual perspective a user input at a user interface associated with the hand held device.

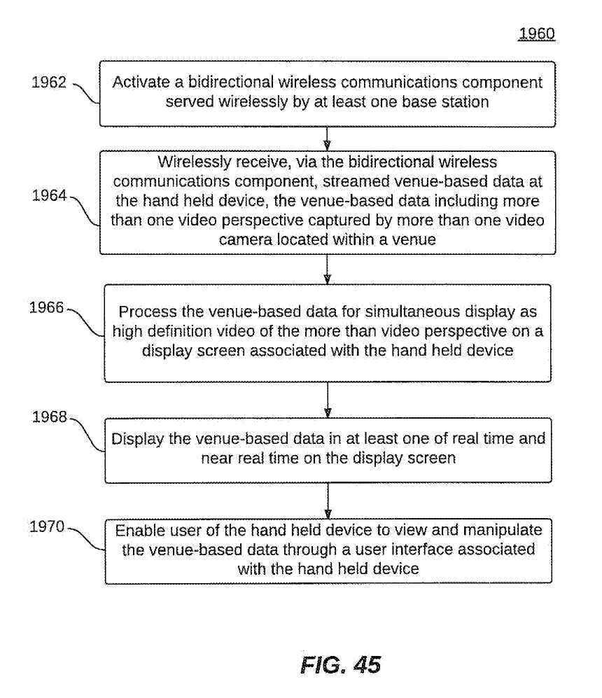

FIG. 45 illustrates a flow chart depicting logical operations of a method 1960 for wirelessly receiving venue-based data at a hand held device, in accordance with another example embodiment. Note that from a first computer, a software module can be provided to the hand held device that when executed causes the hand held device to perform the method 1960 composed of logical operations, such as, activating a bidirectional wireless communications component served wirelessly by at least one base station, as shown at block 1962; wirelessly receiving, via the bidirectional wireless communications component, streamed venue-based data at the hand held device, the venue-based data including more than one video perspective captured by more than one video camera located within an entertainment venue, the bidirectional wireless communications component activating a network selectable by a user from the group comprised of a wireless LAN and at least one cellular communications network, as indicated at block 1964; processing the venue-based data for simultaneous display as high definition video of the more than video perspective on a display screen associated with the hand held device, as illustrated at block 1966; displaying the venue-based data in at least one of real time and near real time on the display screen, as indicated at block 1968; and enabling a user of the hand held device to view and manipulate the venue-based data through a user interface associated with the hand held device, as depicted at block 1970.

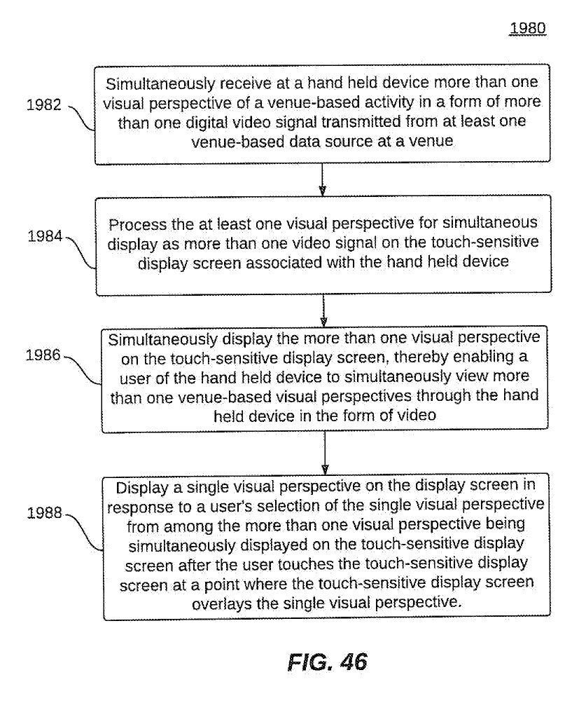

FIG. 46 illustrates a flow chart of operations depicting logical operational steps of a method 1980 for receiving at least one visual perspective of a venue-based activity at a hand held device, in accordance with an example embodiment. Note that in some embodiments, a software module can be provided from a computer to the hand held device, wherein when installed, the software module is represented by a graphical icon on a touch-sensitive color display screen associated with the hand held device. The software module can be activated by a user touching an area of the touch-sensitive display screen associated with the graphical icon.

The software module can cause the hand held device to perform the method 1980, which is composed of steps or logical operations such as: simultaneously receiving at a hand held device more than one visual perspective of a venue-based activity in a form of more than one digital video signal transmitted from at least one venue-based data source at an entertainment venue, wherein the hand held device is in bidirectional wireless communication with a packet based wireless network, wherein the packet based wireless network is selectable by the user from the group of a wireless LAN and a cellular network, as shown at block 1982; processing the at least one visual perspective for simultaneous display as more than one video signal on the touch-sensitive display screen associated with the hand held device, as indicated at block 1984; simultaneously displaying the more than one visual perspective on the touch-sensitive display screen, thereby enabling a user of the hand held device to simultaneously view more than one venue-based visual perspectives through the hand held device in the form of video, as shown at block 1986; and as shown at block 1988, displaying a single visual perspective on the display screen in response to a user's selection of the single visual perspective from among the more than one visual perspective being simultaneously displayed on the touch-sensitive display screen after the user touches the touch-sensitive display screen at a point where the touch-sensitive display screen overlays the single visual perspective.

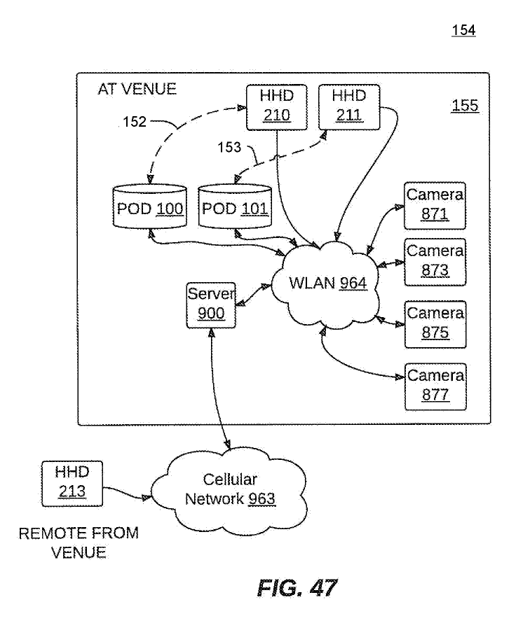

FIG. 47 illustrates a system 154 for displaying a particular video perspective of a venue-based activity at a hand held device located at a venue 155 or remote from the venue 155 and providing venue-based data to such a hand held device, in accordance with an example embodiment. System 154 can include system components located at the venue 155 and/or remote from the venue 155 (e.g., at home, in a car, etc.). For example, a hand held device (HHD) such as hand held device 210, hand held device 211, and so on may be brought into the venue 155 by a user (e.g., a venue attendee, a spectator or fan, an athletic team member, player or coach, concession personnel, and so on). In a baseball game, for example, thousands of fans may bring their respective hand held devices to the ballgame that will take place at a baseball stadium. The baseball team players, coaches, and team staff also typically bring their own hand held devices into the baseball stadium.

Multiple pods such as pod 100, pod 101, and so on may be located at the venue 155. As indicated previously, such pods may be moveable and portable or may be embedded within the infrastructure of the stadium itself. Recall that each such pod can include data communications such as electronic data communications 110 described previously, a synchronized data server such as the previously described synchronized data server 115 (i.e., also referred to as “SS” or synchronized server) and other components such as a rechargeable power course 130 and an optional solar cell 140. System 154 can include the previously described server 900, which may be located at the stadium. Note that although a single server 900 is referred to, it can be appreciated that multiple servers may be implemented at the venue in the context of system 154. Pod 101 is thus similar or analogous to pod 100 or other pods, such as pod(s) 510, 515, and 600 discussed previously.

Cameras 871, 873, 875, and 877 can be implemented at the venue 155 in the context of system 154 and can be configured to capture high-definition video of an event place at the venue 155. It can be appreciated that cameras 871, 873, 875, and 877 may be high-definition video cameras or may be implemented as different types of video cameras some of which may offer high-definition video and some of which may not. Cameras 871, 873, 875, and 877 are capable of communicating wirelessly with a bidirectional wireless network such as WLAN 964, which may be implemented at the venue 155.

Pods such as pods 100, 101, etc., can communicate wirelessly with the WLAN 964 in addition to server 900 and the hand held devices 210, 211. Each hand held device 210, 211, etc., includes at least one receiver. Such a receiver can simultaneously receive from the bidirectional wireless network a plurality of high definition streaming video perspectives of a venue-based activity simultaneously transmitted from more than one venue-based data source (e.g., cameras 871, 873, 875, and 877 or servers(s) 900) located at the venue 155. Note that the bidirectional wireless network can be composed of not just a single network such as WLAN 964, but a group of wireless networks such as WLAN 964 and one or more cellular communications networks such as, for example cellular communications network 963.

A processor such as a CPU associated with server 900 or a CPU such as CPU 810 and/or an image processor such as the image processing unit 835 can process the plurality of perspectives for display on a display screen associated with a hand held device such as, for example, hand held devices 210, 211, and 213. A display screen of, for example hand held device 210 or 211 can display a particular video perspective on the display screen in response to a user selection of the particular video perspective from among the plurality of video perspectives via the hand held device.

As indicated previously, the wireless electronic communications components or circuitry 110 associated with a pod such as, for example, pod 100 may in some example embodiments include beacon technology, examples of which are the aforementioned iBeacon technology and Google's Eddystone product (such example devices can be referred to as simply “beacons” or individually as a “beacon” and refers generally to devices and systems) that utilize BLE proximity sensing to transmit a universally unique identifier. As indicated previously, hand held devices such as HHD 210, 211, and 213 may offer BLE signal reception capabilities. For example, recall that client device 210 shown in FIG. 12 includes a BT module 266 that in some embodiments can offer not simply standard Bluetooth protocol communications, but also BLE communications. Dashed lines 152 and 153 shown in FIG. 47 indicate that in the case where hand held devices 210 and 211 are equipped with BLE electronic components and/or modules (e.g., BLE compatible app or operation system), and each of the pods 100, 101, etc., include wireless data communications configured with a BLE beacon, the beacons contained with the self-contained pods 100, 101 can utilize BLE proximity sensing to transmit a universally unique identifier picked up by a hand held device's compatible app or operating system. The identifier and several bytes sent with it can be utilized to determine, for example, the hand held device's physical location in the venue 155, track attendees (via their respective hand held devices) of venue 155 (e.g., spectators, fans, team members, players, venue concession personnel, etc.), or trigger a location-based action on a hand held device such as a venue “check-in” or a push notification.

Data can then be collected with respect to such hand held devices and transmitted to server 900 via WLAN 964 (which can also communicate wirelessly with the pods 100, 101, etc.) or other servers and analyzed. Results of such analysis can then be granularized and parsed and provided to, for example, owners of the venue 155 or, for example, athletic teams or leagues (e.g., Major League Baseball (MLB), National Hockey League (NHL), National Basketball Association (NBA), National Football League (NFL)) for their usage. Such analyzed and parsed data may also be provided to, for example, a remote hand held device such as hand held device 213, which is shown in the FIG. 47 example embodiment as being remote from the venue. The hand held device 213, for example, may be located at a person's home or in a car geographically far (e.g., in another State) from the venue. The hand held device 213, however, as indicated previously can access different types of networks, including a cellular network 963, which can communicate with the server 900.

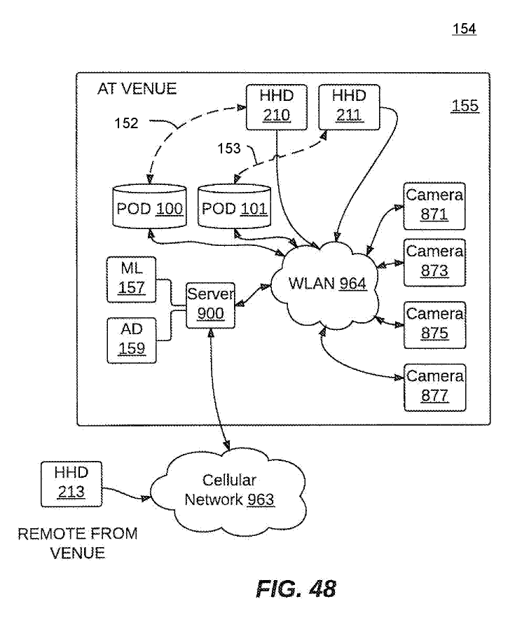

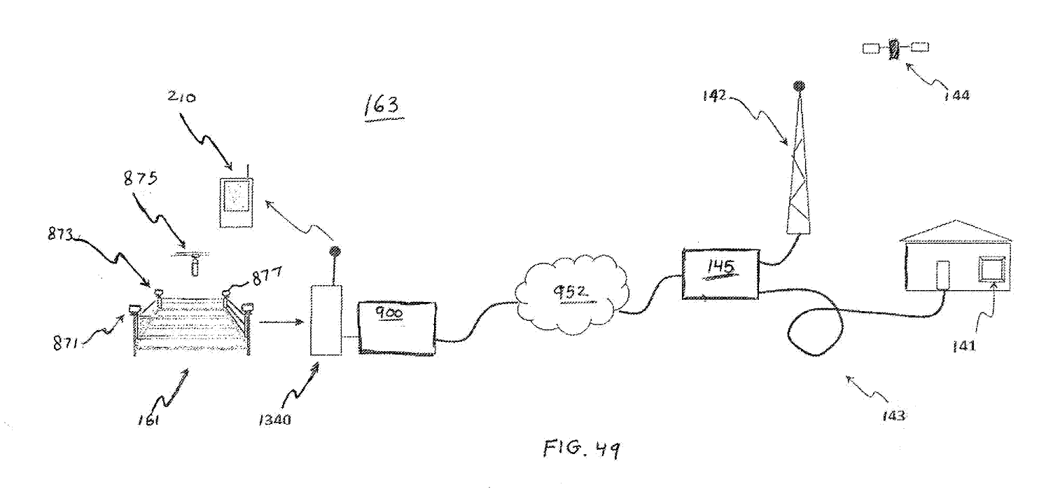

FIG. 48 illustrates an alternative version of the system 154 shown in FIG. 47 for displaying a particular video perspective of a venue-based activity at a hand held device located at a venue or remote from the venue and providing venue-based data to such a hand held device, in accordance with another example embodiment. Note that in FIGS. 47-48, identical parts or elements are indicated by the same reference numerals. Thus, as shown in FIG. 48, the server 900 (or multiple or synchronized servers) may store and process a machine learning (ML) module 157 and/or an anomaly detection (AD) module 159. That is, such modules can be stored in a memory location of server 900 (or another server in communication with server 900) and processed by the server 900. Data collected from the pods 100, 101 (e.g., there may be only a single pod in the venue 155 or hundreds or more such pods located at the venue 155) and hand held devices 210, 211, etc., can be collected via WLAN 964 and stored in server 900 (or other servers) and then subject to analysis and processing via the machine learning module 157 and/or the anomaly detection module 159. Video and images collected from cameras 871, 873, 875, and 877 may also be subject to analysis and processing by the machine learning module 157 and the anomaly detection module 159. The machine learning module 157 can implement a machine learning application that can be utilized to, for example, get the pods 100, 101, or other devices in the venue 155 such as cameras 871, 873, 875, 877, etc., to act without being explicitly programmed. The machine learning module 157 can implement, for example, supervised learning, unsupervised learning, reinforcement learning, semi-supervised learning, and so on with respect to data collected from devices such as pods, 100, 101 etc., cameras 871, 873, 875, 877, and hand held devices such as hand held devices 210, 211, and so on. The machine learning module 157 can be employed to train, for example, the movement of cameras such as cameras 150, 151 deployed on a self-contained pod such as pod 100. The machine learning module 157 can also be utilized to train one or more synchronized servers, such as the machine learning server 115 and so on and/or sensors such as sensors 170 deployed or integrated with pod 100.

The anomaly detection module 159 can perform anomaly detection (or outlier detection) to identify items, events, or observations that do not conform to an expected pattern or other items in a dataset. Such datasets can be derived from the data collected from, for example, pods 100, 101, etc., hand held devices 210, 211, etc., cameras 871, 873, 875, 877, and other devices in the venue 155 that communicate wirelessly with server 900 via WLAN 964 and which is stored in, for example, a database in server 900 (or in some embodiments, in a specific database server or in synchronized servers as discussed herein). The anomaly detection module 159 alone or in combination with the machine learning module 157 is useful for data mining of data collected in venue 155 from, for example, pods 100, 101, etc., hand held devices 210, 211, etc., cameras 871, 873, 875, 877, and other computing devices in the venue 155 that communicate wirelessly with server 900 via WLAN 964.

FIG. 49 illustrates a schematic diagram of a system 163 for providing video and data to one or more hand held devices, such as, hand held device 210, in accordance with another example embodiment. Video can be captured by one or more of the cameras 871, 873, 875, 877 at an activity 161 and provided to server 900, which is then processed at the server 900 and transmitted to one or more hand held devices such as hand held device 210, which may (or may not) be located near the activity 161. In the example shown in FIG. 49, the activity may be a boxing match, a wrestling match, a mixed martial arts match, etc. The server 900 communicates with data communications hardware 1340 and also with a data network 952. Thus, the video data captured by cameras 871, 873, 875, and/or 877 can be provided to one or more wireless hand held devices 210 located near the activity 161 through data communication hardware 1340. In some embodiments, the server 900 can be implemented as, for example, a synchronized data server 110 in the context of a self-contained pod such as pod 100. In such a scenario, the pod 100 may be located at or near the activity 161 or elsewhere in a venue or arena in which the activity 161 is taking place.

Data can also be provided by data communication hardware 1340 through data network 952 to remote multimedia content provider hardware 145 for transmission via cable 143, radio frequency transmission 142, or satellite 144 to a multimedia presentation device 141 (e.g., high definition television, set-top box used with satellite and cable television service such as devices provided by TiVo® computer, or handheld devices located away from the activity 161) as illustrated. In the illustration, the example activity 161 is shown as a boxing ring incorporating cameras 871, 873, 875, and 877 surrounding the ring and synchronized in a master-slave relationship located over the ring for automated capture of video using master-slave camera technology. Servers and multimedia devices referred to herein can include systems such as those supported by subscription services (e.g., digital cable television and satellite television providers) and digital recording equipment. Thereafter, multiple camera view data can be viewed and replayed via cable or satellite to a user's/subscriber's remote viewer (e.g., HDTV display, set-top boxes). Note that server 900, as indicated previously, can include the use of modules such as machine learning module 157 which may be utilized to control the activities of cameras 871, 873, 875, and 877. Pods such as pods 100, 101, etc., described previously can also be located in the venue where the activity 161 is taking place.

Wireless networks and servers can also receive and retransmit other data, in addition to video data. For example, a server or other computer system may be integrated with wireless network to provide team and venue data, which can then be transferred to wireless data transmitter receiver from wireless network and displayed thereafter as team and venue information within display screen of a user's display device. Other data that may be transferred to hand held device for display include real-time and historical statistics, purchasing, merchandise and concession information, and additional product or service advertisements.

Data can also include box scores, player matchups, animated playbooks, player tracking data, shot/hit/pitch charts, historical information, and offense-defense statistics. In a concert venue, for example, as opposed to a sporting event, information pertaining to a particular musical group can be also transferred to the hand held device, along with advertising or sponsor information. Note that both the video data and other data described above generally comprise types of venue-based data. Venue-based data, as referred to herein, may include data and information, such as video, audio, advertisements, promotional information, propaganda, historical information, statistics, event scheduling, and so forth, associated with a particular venue and generally not retrievable through public networks. Information data can be transmitted together with video data received from data transmitter. Such information may be displayed as streaming data within a dedicated display area of a user's video display or simply stored in a database for later retrieval by the user.

Examples of venue-based data include not only video streaming data of video taking place in the venue (e.g., real time video), but also highlights such as instant replay videos. Other examples of venue-based data or “data” transmitted wirelessly via wireless communications also includes tracking data. Sensors such as sensors 170 can be utilized to track the events taking place in the venue. For example, in the case of a sporting event, sensors 170 together with cameras such as cameras 150, 151, 835, 914, etc., can be utilized to track the action that is taking place on the field. One example of a system that can provide such data is a player tracking system, such as, for example, the StatCast™ system of MLB Advanced Media. It can be appreciated that reference to StatCast™ system is for exemplary purposes only. Other event tracking systems can also be adapted for use in accordance with alternative embodiments. Self-contained pods such as described herein can thus facilitate the acquisition of event data for payer tracking systems and other event tracking systems.

The self-contained pods described herein can be integrated with a player tracking system of this type to track and capture the physical position of every player, pitch and batted ball many times per second, and accumulate and process such data using remote servers and/or with synchronized servers, such as, for example, synchronized server 115. In such an example embodiment, a workflow can be implemented utilizing synchronized servers and systems such as the self-contained pods described herein to provide coordinate information. In an example embodiment, sensors 170 described herein can include a radar device (e.g., a Doppler radar device). A self-contained pod with such sensors may be located, for example, behind home plate (in a baseball game scenario), sampling the ball position at, for example 2000 times a second.

Another self-contained pod may be configured with sensors 170 that include, for example, stereoscopic imaging devices. This other self-contained pod may be positioned, for example, above the third-base line, and the stereoscopic imaging devices employed to sample positions of players on the field at, for example, 30 times a second. Data from these systems can be augmented by brief written descriptions of each play entered by personnel on the field after the action is over. Then, then to 15 seconds after a play is completed, the data can be transmitted over, for example, wireless network 952, and processed and analyzed via, for example, an anomaly detection module, such as, for example, the anomaly detection module 159 discussed herein with respect to FIG. 48. Such player tracking data can be provided along with streaming video data to hand held devices as discussed herein.

The wireless gateway 974 and server 900 can be associated with a wireless network implemented in association with, for example, a venue such as venue 155 and other venues discussed herein. Such a wireless network can be geographically located in, for example, venue 155 or the immediate surrounding area. It should be appreciated that a server such as server 900 can operate across country and still operate as taught herein to register user, retrieve, store, and provide video and data to users via their hand held devices or other client devices. Capacity and transmission bandwidth are the only constraints for a multimedia delivery system. These limitations continue to be overcome with faster servers, optical data networks, and high bandwidth wireless data communication networks such as 3G, 4G, 5G cellular and WiMAX and other wireless network communication protocols.

Aspects of the describe embodiments can take the form of an entire hardware embodiment or an embodiment containing both hardware and software elements. In one embodiment, aspects of the disclosure are implemented in software, which includes, but is not limited to, firmware, resident software, microcode, etc., that is executed on or by a processor device or data processing system to perform the various functions described herein.

The disclosure can take the form of a computer program product accessible from a computer-usable or computer-readable medium providing program code for use by or in connection with a computer or any instruction execution system. For the purposes of this description, a computer usable or computer readable medium can be any apparatus that can contain or store the program for use by or in connection with the instruction execution system, apparatus or device, such as a data processing system.

The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read only memory (ROM), a rigid magnetic disk, and an optical disk. Current examples of optical disks include compact disk read only memory (CD-ROM), compact disk read/write (CD-R/W), and DVD.

Improvements and modifications can be made to the foregoing without departing from the scope of the present disclosure.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A system that delivers video and data to wireless client devices through a packet based wireless network, said system comprising:
at least one self-contained pod deployable at a venue, wherein said at least one self-contained pod includes wireless communications electronics and at least one camera for capturing digital video of at least one event taking place at said venue and/or associated with said venue, wherein said wireless communications electronics transforms said digital video into a format suitable for transmission through a bidirectional packet based wireless network and facilitates said transmission of said digital video to said bidirectional packet based wireless network for transmission through said bidirectional packet based wireless network.

2. The system of claim 1 wherein said at least one self-contained pod further includes a telescoping mast wherein said at least one camera is mounted on said mast.

3. The system of claim 1 wherein said at least one self-contained pod provides extended data communications for mobile device users at and/or remote from said venue, and capture video from the perspective of said at least one self-contained pod.

4. The system of claim 1 wherein said at least one self-contained pod is associated and electronically communicates with a synchronized data server that assures data is synchronized with a control server and/or with other self-contained pods containing synchronized servers at said venue.

5. The system of claim 2 wherein said at least one telescoping mast includes an antenna and lifts said at least one camera to variable heights so that said at least one camera provides different perspectives to spectators based on a location of said at least one self-contained pod and a height of said at least one telescoping mast, wherein said different perspectives are provided as wireless video as streaming data to said viewers through at least one hand held device that wirelessly receives said wireless video as streaming data.

6. The system of claim 1 wherein said at least one self-contained pod includes a rechargeable power source that is rechargeable by a solar panel.

7. A method for receiving venue-based data at a client device through at least one packet based wireless network, said method comprising:
wirelessly receiving data at a client device wherein said data includes video streaming simultaneously from more than one visual perspective within a venue and wherein said data is transmitted from at least one venue-based data source at the venue, wherein said at least one venue-based data source comprises at least one high definition video camera associated with said at least one self-contained pod;
processing said data for electronic display on a display screen associated with said client device, wherein said processing said data includes image processing said data to transform said data into a format suitable for electronic display on said display screen; and
displaying video of only one visual perspective within said venue selected from more than one visual perspective simultaneously streaming as video on said display screen in response to a user selection of said only one visual perspective from the more than one visual perspective a user input at a user interface associated with said client device, wherein said at least one video camera is adapted to provide high-resolution wide-angle video data.

8. The method of claim 7 wherein said at least one self-contained pod is associated with a synchronized data server, which assures that data is synchronized with a control server and/or with other self-contained pods containing synchronized servers at said venue.

9. The method of claim 7 wherein said at least one client device is located geographically remote from said venue.

10. A client device for simultaneously receiving more than one video perspective captured by more than one high definition video camera located within a venue, comprising:
at least one receiver adapted for simultaneously receiving more than one high definition video perspective of a venue-based activity provided by at least one video camera associated with at least one self-contained pod;
a processor adapted for processing said more than one high definition video perspective for simultaneous display of at least two high definition video perspectives on a display screen associated with said client device; and
a display screen adapted for simultaneously displaying the at least two high definition video perspectives, wherein said at least one video camera is adapted to provide high-resolution wide-angle video data.

11. The client device of claim 10 wherein said at least one video camera comprises a wireless video camera.

12. The client device of claim 10 wherein said at least one video camera is mounted on said at least one self-contained pod.

13. The client device of claim 10 wherein video is configured to be displayable on said display screen in response to user input through a graphical user interface associated with said client device.

14. The client device of claim 10 further comprising a display routine adapted for displaying a particular perspective among said at least two high definition video perspectives of said venue-based activity on said display screen in response to a user selection of said particular perspective of said venue-based activity.

15. The client device of claim 10 further comprising a processor adapted for processing said at least two video perspectives for simultaneous display on said display screen associated with said client device utilizing at least one image-processing module.

16. The client device of claim 10 wherein said client device is further adapted to receive promotional information.

17. The client device of claim 10 wherein said client device is further adapted to receive advertising information.

18. The client device of claim 10 wherein said client device is located in at least one of in the venue and out of the venue.

19. The client device of claim 10 further comprising:
a display routine adapted for displaying a particular perspective among said at least two high definition video perspectives of said venue-based activity on said display screen in response to a user selection of said particular perspective of said venue-based activity; and
a processor adapted for processing said at least two video perspectives for simultaneous display on said display screen associated with said client device utilizing at least one image-processing module.

20. The client device of claim 10 wherein said client device is located in at least one of in the venue and out of the venue, said out of the venue comprising a location that is geographically remote from the venue.
